(19) United States
(12) Patent Application Publication
(10) Pub. No.: US 2014/0097797 A1
(43) Pub. Date: Apr. 10, 2014

(54) ENERGY STORAGE SYSTEM

(71) Applicant: Enerdel, Inc., Greenfield, IN (US)

(72) Inventors: Anthony Sean Hendrix, Carmel, IN (US); Phillip Andrew Stewart, Knightstown, IN (US); Chad Hartzog, Kokomo, IN (US); David Heady, Mooresville, IN (US); Timothy Hans, Noblesville, IN (US)

(73) Assignee: ENERDEL, INC., Greenfield, IN (US)

(21) Appl. No.: 14/077,734

(22) Filed: Nov. 12, 2013

Related U.S. Application Data
(63) Continuation of application No. PCT/US11/52169, filed on Sep. 19, 2011.
(60) Provisional application No. 61/486,151, filed on May 13, 2011.

(51) Int. Cl. H02J 7/00

(52) U.S. Cl. CPC H02J 7/0063; H02J 7/0047; H02J 7/0031
USPC 320/118

(57) ABSTRACT

An energy storage system is disclosed. The energy storage system may include a power control module coupled to a plurality of energy modules each including a plurality of batteries. The plurality of batteries may be placed in a plurality of containers and arranged in a plurality of parallel strings.

### RELATED APPLICATIONS

This application is a continuation of PCT Application No. PCT/US11/52169, filed Sep. 19, 2011, titled ENERGY STORAGE SYSTEM, which claims the benefit of U.S. Provisional Application No. 61/486,151, filed May 13, 2011, titled ENERGY STORAGE SYSTEM, the disclosures of which are expressly incorporated by reference.

### FIELD

The disclosure relates in general to methods and systems for storing and providing energy with a plurality of batteries and, more particularly, to methods and systems for storing and providing energy to an electrical grid with a plurality of batteries.

### BACKGROUND AND SUMMARY

Battery systems for providing power to the electrical grid are known.

In an exemplary embodiment of the present disclosure, an energy module includes a plurality of electrically conductive buses coupled to an output of the energy module. The plurality of electrically conductive buses include a positive bus, a negative bus and a ground bus. The energy module also includes a plurality of supports coupled to the electrically conductive buses in parallel. Each support includes a positive contactor coupled to the positive bus, a negative contactor coupled to the negative bus, and a ground coupled to the ground bus. The positive and negative contactors each have a closed position to couple the support to the positive and negative buses, respectively, and an open position to disconnect the support from the positive and negative buses. The energy module further includes a plurality of battery strings supported by each support, the plurality of battery strings each having a plurality of batteries coupled together in series to provide a string output voltage, and at least one string contactor coupled to each battery string. Each string contactor has a closed position to couple its associated battery string to the positive and negative contactors of the support in parallel with other battery strings of the support. Each string contactor also has an open position to disconnect disconnect the associated battery string from the positive and negative contactors of the support independently from the other battery strings of the support. The energy module still further includes an energy module controller configured to selectively and independently open and close each of the positive contactors, the negative contactors, and the string contactors of the energy module to control the combination of supports and battery strings coupled to the output of the energy module through the plurality of electrically conductive buses.

In one illustrated example, each support includes at least three battery strings coupled in parallel to the positive and negative contactors of the support. Each battery string includes a plurality of separate battery modules together coupled in series, and each battery module has a battery module controller in communication with the energy module controller. In one illustrated embodiment, each battery string has a voltage of about 1200 V and each battery module has a voltage of about 50 V.

In an illustrated example, each support includes a plurality of vertically arranged or stacked battery containers. Each battery container includes a plurality of battery modules coupled together in series, and a plurality of the battery containers of the support are electrically coupled together in series to form each battery string. In an illustrated embodiment, a maximum voltage of each battery container is 200V.

In another illustrated example, each support of the energy module also includes a high voltage container supporting the positive contactor, the negative contactor, and the string contactors of each support. The high voltage container further includes a separate fuse coupled to each battery string. A first terminal of each string contactor is coupled to one of the fuses, and a second terminal of each string contactor is coupled to a current sensor for the battery string. Each current sensor is coupled in parallel to the positive contactor of the support.

In yet another illustrated example, each support also includes a low voltage container. The low voltage container supports a plurality of relays for controlling the positive and negative support contactors and the string contactors located in the high voltage container.

In an illustrated embodiment of the energy module, the plurality of electrically conductive buses, the plurality of supports, and the energy module controller are located in a single container. A DC distribution box is also located within the container. The plurality of supports are coupled in parallel to the DC distribution box by the positive, negative and ground buses.

In an illustrated example, the energy module controller monitors a plurality of parameters related to each of the plurality of battery strings. The energy module controller selectively opens a string contactor of a faulty battery string in which a fault is detected to disconnect the faulty battery string from its support without shutting down the entire energy module.

In still another illustrated example, the positive and negative buses are coupled through at least one fuse to a first terminal a first energy module contactor. The first energy module contactor has a closed position and an open position to connect and disconnect the energy module, respectively. A second terminal of the first energy module contactor is coupled through a second fuse to a first terminal of a manually operated knife switch. A second terminal of the knife switch is coupled to a first terminal of a second energy module contactor, and a second terminal of the second contactor provides the output for the energy module.

In an illustrated embodiment, the energy module includes a first volt meter coupled to the first terminal first of the energy module contactor to provide a first voltage reading, a second volt meter coupled to the first terminal of the knife switch to provide a second voltage reading, and a third volt meter coupled between the second terminal of the knife switch and the first terminal of second energy module contactor to provide a third voltage reading. A display panel is located adjacent an access door of a container housing the energy module. The display panel displays voltage readings from the first, second and third volt meters so that an operator can review the three voltage readings displayed on the display panel before entering the container.

In another illustrated example, the energy module controller includes a primary programmable logic controller (PLC) and a secondary, backup PLC. Both the primary and backup PLCs receiving data from the plurality of supports and the plurality of battery strings. The primary PLC is configured to normally control operation of the energy module, and the backup PLC is configured to control operation of the energy module upon failure of the primary PLC. In an exemplary embodiment, the primary and backup PLCs are both coupled to a unit central controller (UCC). The UCC is also coupled to a remote computer through a communication network to provide remote access to the UCC and the primary and backup PLCs for at least one of diagnostic purposes, control, data analysis, review and maintenance of the energy module.

In a further illustrated example, the energy module controller monitors voltages and temperatures of the plurality of battery strings within each of the plurality of supports. The energy module controller selectively opens and closes string contactors to selectively remove certain battery strings from the energy module based on the monitored voltages and temperatures. In an illustrated embodiment, the controller determines whether a voltage imbalance exists between the plurality of battery strings, and selectively disconnects out of balance battery strings to minimize the voltage imbalance between the battery strings of the energy module.

In another exemplary embodiment, the energy module controller monitors each of the battery strings for a fault condition. Upon detecting a fault condition for a particular string the controller: opens both the positive and negative contactors a particular support in which the battery string having the fault condition is located to break current flow; opens the at least one string contactor for the battery string having the fault condition; and closes the positive and negative support contactors of the particular support to reconnect the support to the positive and negative buses.

In yet another exemplary embodiment, each support of the energy module includes at least three parallel battery strings. A battery string is illustratively disconnected from the energy module when a voltage of the particular battery string differs from voltages of other battery strings by more than a predetermined amount. In an illustrated embodiment, the energy module controller monitors voltages for the plurality of battery strings in the plurality of supports, calculates a median voltage for the plurality of battery strings, compares the median battery string voltage to individual battery string voltages, determines if a battery string voltage for a particular battery string is outside a predetermined acceptable voltage range from the median battery string voltage, sets a string voltage difference fault for the particular string that is outside the predetermined acceptable voltage range, and opens the string contactor for the string having the string voltage difference fault.

In another illustrated embodiment, the energy module controller compares each battery string voltage to voltages of other battery strings within the same support, determines whether the battery string voltage for the particular battery string is within a predetermined voltage range of the other battery strings within the same support, and sets a string voltage difference fault for the particular string if the battery string voltage for the particular battery string is not within the predetermined voltage range of the other battery strings within the same support. In one illustrated example, each battery string has a voltage of about 1200V, and the predetermined voltage difference range is within 50V of the median string voltage in order to be within the acceptable voltage range.

In another exemplary embodiment of the present disclosure, an energy module includes a plurality of electrically conductive buses coupled to an output of the energy module. The plurality of electrically conductive buses include a positive bus, a negative bus and a ground bus. The energy module also includes a plurality of battery supports coupled to the electrically conductive buses in parallel. Each support includes a plurality of battery modules, a positive contactor coupled to the positive bus, a negative contactor coupled to the negative bus, and a ground coupled to the ground bus. The positive and negative contactors each have a closed position to couple the plurality of battery modules of the support to the positive and negative buses, respectively, and an open position to disconnect the plurality of battery modules of the support from the positive and negative buses. At least two of the plurality of battery supports further include a pre-charge contactor and a pre-charge resistor coupled in series across terminals the support negative contactor. The energy module further includes an energy module controller configured to selectively and independently open and close each of the positive contactors, the negative contactors, and the pre-charge contactors. The energy module controller is programmed to selectively open the pre-charge contactor of one of the at least two supports so that current flows through the pre-charge resistor in order to pre-charge the plurality of battery modules of the selected one of the at least two supports as the energy module is brought online before the positive and negative contactors of the other supports are closed to coupled to the plurality of battery modules of the other supports to the positive and negative buses.

In an illustrated example, the plurality of battery supports include supports 1, 2, 3 . . . N, and at least supports 1 and 2 of the plurality of supports have a pre-charge contactor and a pre-charge resistor. The energy module controller initially closes the positive contactor and the pre-charge contactor of support 1 and monitors a voltage of the plurality of battery modules of support 1 to determine whether the plurality of battery modules of support 1 have been successfully pre-charged. Illustratively, a threshold voltage level for a successful pre-charge of the battery modules of support 1 is about 90% of a desired operating voltage of the battery modules of support 1.

In an illustrated example, if the plurality of battery modules of support 1 were successfully pre-charged, the energy module controller then closes the negative contactor of support 1, opens the pre-charge contactor of support 1, and sequentially closes the positive and negative contactors of each of support 2 through support N to bring the energy module online systematically. Illustratively, a predetermined time delay occurs between the steps of closing the positive and negative contactors of each of support 2 through support N.

In another illustrated example, if the plurality of battery modules of support 1 are not successfully pre-charged, the controller opens the positive contactor and the pre-charge contactor of support 1, closes the positive contactor and the pre-charge contactor of support 2, and monitors a voltage of the plurality of battery modules of support 2 to determine whether the plurality of battery modules of support 2 have been successfully pre-charged. If the plurality of battery modules of support 2 have been successfully pre-charged, the energy module controller then closes the negative contactor of support 2, opens the pre-charge contactor of support 2, closes the positive and negative contactors of support 1, and sequentially closes the positive and negative contactors of each of support 3 through support N to bring the energy module online systematically.

In a further exemplary embodiment of the present disclosure, an energy module includes a plurality of electrically conductive buses coupled to an output of the energy module. The plurality of electrically conductive buses include a positive bus, a negative bus and a ground bus. The energy module also includes a plurality of supports coupled to the electrically conductive buses in parallel. Each support includes a positive contactor coupled to the positive bus, a negative contactor coupled to the negative bus, and a ground coupled to the ground bus. The positive and negative contactors each have a closed position to couple the support to the positive and negative buses, respectively, and an open position to disconnect the support from the positive and negative buses. The energy module further includes a plurality of battery strings strings supported by each support, the plurality of battery strings each having a plurality of batteries coupled together in series to provide a string output voltage, and at least one string contactor coupled to each battery string. Each string contactor has a closed position to couple its its associated battery string to the positive and negative contactors of the support in parallel with other battery strings of the support and an open position to disconnect the associated battery string from the support independently from the other battery strings of the support. The energy module also includes a plurality of cables for electrically coupling the plurality of battery strings to the positive contactor, the negative contactor, and the string contactors of each support. The plurality of cables associated each battery string have substantially equal cumulative lengths to provide a generally equal cable resistance associated with each battery string of the support.

In a still further exemplary embodiment of the present disclosure, an energy module includes a plurality of electrically conductive buses coupled to an output of the energy module. The plurality of electrically conductive buses include a positive bus, a negative bus and a ground bus. The energy module also includes a plurality of supports coupled to the electrically electrically conductive buses in parallel, with each support supporting a plurality of battery strings thereon. The plurality of battery strings each have a plurality of batteries coupled together in series to provide a string output voltage. Each support also includes a positive contactor coupled to the positive bus, a negative contactor coupled to the negative bus, and a ground coupled to the ground bus. The positive and negative contactors each have a closed position to couple the plurality of battery strings of the support to the positive and negative buses, respectively, and an open position to disconnect the plurality of battery strings of the support from the positive and negative buses. One of the positive and negative contactors of each support is installed in a forward direction, and the other of the positive and negative contactors is installed in a backward direction so that the combination of the positive and negative contactors breaks current flow in either direction when the positive and negative contactors are opened. The energy module further includes at least one string contactor coupled to each battery string. Each string contactor has a closed position to couple its associated battery battery string to the positive and negative contactors of the support in parallel with other battery strings of the support and an open position to disconnect the associated battery string independently from the other battery strings of the support. The energy module still further includes an energy module controller configured to selectively and independently open and close each of the positive contactors, the negative contactors, and the string contactors of the energy module to control the combination of supports and battery strings coupled to the output of the energy module through the plurality of electrically conductive buses. In an illustrated example, the energy module controller senses a current flow direction and opens an appropriate one of the positive or negative contactor first depending on the direction of the current flow.

In another exemplary embodiment of the present disclosure, an energy module includes a container having an interior region, an entry door to provide access the interior region of the container, a sensor to detect entry of a person into the interior region of the container, a main energy module contactor to provide an output for the energy module, and a plurality of electrically conductive buses coupled to the main contactor. The plurality of electrically conductive buses include a positive bus, a negative bus and a ground bus. The energy module also includes a plurality of battery supports coupled to the electrically conductive buses in parallel. Each support includes a plurality of battery modules, a positive contactor coupled to the positive bus, a negative contactor coupled to the negative bus, and a ground coupled to the ground bus. The positive and negative contactors each have a closed position to couple the plurality of battery modules of the support to the positive and negative buses, respectively, and an open position to disconnect the plurality of battery modules of the support from the positive and negative buses. The energy module further includes an energy module controller configured to selectively and independently open and close each of the main energy module contactor, the positive contactors, and the negative contactors. The energy module controller is coupled to the sensor and programmed to open the main energy module contactor and the positive and negative contactors of each support automatically when the sensor detects a person entering the interior region of the container.

In one illustrated embodiment, the sensor detects whether the entry door of the container is open or closed. The sensor provides a signal to the controller when the entry door is opened to indicate that a person is entering the interior region of the container. In another illustrated embodiment, the sensor is a motion detector located in the interior region of the container to detect a person in the interior region of the container. The motion sensor provides a signal to the controller when motion is detected in the interior region of the container.

In yet another illustrated embodiment, each support also includes at least one circuit interrupter to disconnect a plurality of battery modules located on the support. In one example, the battery supports each include a plurality of vertically arranged or stacked battery containers and the at least one circuit interrupter includes a first portion coupled to a front portion of the battery container and electrically coupled to the battery modules located in the container and a second portion movable relative to the first portion to break an electrical connection between the battery modules located in the container. Illustratively, each of the plurality of battery containers has a circuit interrupter located on a front portion of the container.

In another illustrated embodiment, the energy module further includes at least one emergency stop switch coupled to the energy module controller. The energy module controller is programmed to open the main energy module contactor and the positive and negative contactors of each support when the at least one emergency stop switch is actuated. In one exemplary embodiment, the at least one emergency stop switch is coupled to the energy module controller in series with the sensor.

In yet another exemplary embodiment of the present disclosure, an energy system is configured to be operatively connected to a power grid through a switch gear. The energy system includes a power control module including at least one inverter to convert DC power to AC power for communication to the power grid through the switch gear and a ground fault detection circuit. The energy system also includes a plurality of energy modules, each energy module including a container housing a plurality of batteries therein, a high voltage DC bus coupled to the plurality of batteries, a main contactor coupled to the high voltage DC bus and configured to couple the energy module to the power control module, a ground fault detection circuit, and a controller programmed to enable the ground fault detection circuit to monitor the high voltage DC bus for a ground fault condition when the main energy module contactor is open. The energy module controller disables the ground fault detection circuit of the energy module before closing the main energy module contactor to connect the energy module to the power control module. Ground fault detection for each of the plurality of energy modules is provided by the ground fault detection circuit of the power control module after the associated main contactor of each energy module is closed.

In one illustrated embodiment, each energy module includes a relay coupled to the controller and the ground fault detection circuit. The relay is opened and closed by the energy module controller to selectively disable and enable the ground fault detection circuit of the energy module. In another illustrated embodiment, each energy module controller communicates with the ground fault detection circuit of the energy module through a communication link to selectively enable and disable the ground fault detection circuit.

In still another exemplary embodiment of the present disclosure, an energy storage system is provided. The energy storage system comprising a plurality of containers each including a plurality of batteries and a container interface including at least one electrical interface module coupled to the plurality of batteries; and a battery support including openings to receive the plurality of containers, the battery support including a plurality of battery support interfaces each including at least one electrical interface module. The plurality of containers are moveably coupled to the battery support. The container interface of each container is positioned rearward of a front face of the respective container.

In one illustrated embodiment, a first electrical interface module of a first container engages a first electrical interface module of the battery support when the first container is translated relative to the battery support. In one example, the container is held in place relative to the battery support with a securing member.

In another illustrated embodiment, the first container includes a cold plate and the container interface of the first container includes a fluid interface module in fluid communication with a fluid conduit of the cold plate and wherein the battery support interface includes a fluid interface module which engages the fluid interface module of the first container when the first container is translated relative to the battery support.

In yet another illustrated embodiment, each of the containers is a drawer and the battery support is a rack, the plurality of drawers being translatable relative to the rack.

In still another illustrated embodiment, the plurality of batteries in each container are coupled together in series and each container includes a positive electrical interface which is coupled to a respective positive electrical interface of the battery support and a negative electrical interface which is coupled to a respective negative interface of the battery support. In one example, the battery support connects the batteries in a first set of containers in series and the batteries in a second set of containers in series and the first set of containers and the second set of containers together in parallel.

In still another exemplary embodiment of the present disclosure, an energy storage system having an output is provided. The energy storage system comprising a positive bus coupled to the output; a negative bus coupled to the output; a plurality of batteries arranged in a plurality of strings, the plurality of batteries being electrically connected to the positive bus and the negative bus through a plurality of string contactors; a controller configured to selectively and independently open and close each of the string contactors to control the combination of batteries coupled to the output of the energy module through the positive bus and the negative bus; and a plurality of containers arranged in a vertical column. A first group of the plurality of batteries are a first string and are provided in a first group of the plurality of containers. A second group of the plurality of batteries are a second string and are provided in a second group of the plurality of containers. The first group of batteries is electrically coupled in series to a first string contactor and the second group of batteries is electrically coupled in series to a second string contactor. The first string contactor and the second string contactor are electrically coupled in parallel.

In one illustrated embodiment, the plurality of containers are drawers which are received within a rack.

In still yet another exemplary embodiment of the present disclosure, a method of electrically coupling a plurality of batteries to an output of an energy storage system is provided. The method comprising the steps of providing a positive bus and a negative bus electrically coupled to the output of the energy storage system and arranging the plurality of batteries into a plurality of strings electrically coupled to the positive bus and the negative bus through a plurality of electrically paralleled string contactors. The method further comprising, for a first string of the plurality of strings, positioning a first portion of the plurality of batteries in a first container; positioning a second portion of the plurality of batteries in a second container; electrically coupling the first portion of the plurality of batteries, the second portion of the plurality of batteries, and a first string contactor together in series; and arranging the first container and the second container in a first vertical column. The method further comprising for a second string of the plurality of strings, positioning a third portion of the plurality of batteries in a third container; positioning a fourth portion of the plurality of batteries in a fourth container; electrically coupling the third portion of the plurality of batteries, the fourth portion of the plurality of batteries, and a second string contactor together in series; and arranging the third container and the fourth container in a second vertical column. The method further comprising the steps of arranging the second vertical column above the first vertical column; arranging the first string contactor and the second string contactor above the first vertical column; and controlling a first connection of the first string to the positive and negative bus with the first string contactor and a second connection of the second string to the positive and negative bus with a second string contactor, the second connection being controlled independent of the first connection.

In still a further exemplary embodiment of the present disclosure, a method of electrically coupling a plurality of batteries to an output of an energy storage system is provided. The method comprising the steps of providing a battery support having a first battery support interface and a second battery support interface electrically connected to the first battery support interface; supporting a first battery in a first container having a first container interface, the first container being moveably coupled to the battery support; supporting a second battery in a second container having a second container interface, the second container being moveably coupled to the battery support; engaging the first container interface with the first battery support interface by moving the first container relative to the battery support; and engaging the second container interface with the second battery support interface by moving the second container relative to the battery support.

In still yet a further exemplary embodiment of the present disclosure, an energy storage system having an output is provided. The energy storage system comprising a container including a front and a rear and a bottom positioned between the front and the rear; a plurality of batteries supported by the container and positioned between the front and the rear, the plurality of batteries being electrically connected together; and a circuit interrupter accessible from an exterior of the front of the battery support. The circuit interrupter has a closed state wherein a first battery supported by the container is electrically coupled to a second battery supported by the container and an open state wherein the first battery is electrically uncoupled from the second battery.

In one illustrated embodiment, the plurality of batteries are coupled to the output of the energy storage system through a container interface accessible along the rear of the container. In one example, the container is a drawer which is moveably coupled to a rack. The rack including a rack interface which cooperates with the container interface.

In another illustrated embodiment, the circuit interrupter includes a first portion coupled to front of the container and a second portion, when the second portion is in a first position relative to the first portion a plurality of terminals of the second portion are in contact with a plurality of terminals of the first portion to connect the first battery and the second battery in series and when the second portion is in a second position relative to the first portion the plurality of terminals of the second portion are spaced apart from the plurality of terminals of the first portion to uncouple the first battery and the second battery.

In still another illustrated embodiment, the circuit interrupter provides a visual indication of whether the first battery and the second battery are coupled in series.

In yet still another illustrated embodiment, the container provides a visual indication of whether the first battery and the second battery are coupled in series.

In a further exemplary embodiment of the present disclosure, an energy storage system is provided. The energy storage system comprising a first container including a first side and a second side and a bottom positioned between the first side and the second side; a first plurality of batteries supported by the first container and positioned between the first side and the second side, the first plurality of batteries being electrically connected together; a second container arranged in a vertical column with the first container; a second plurality of batteries supported by the second container and being electrically connected together and electrically coupled to the first plurality of batteries; and a circuit interrupter accessible from an exterior of the first side of the first container. The circuit interrupter having a closed state wherein a first battery of the first plurality of batteries supported by the first container is electrically coupled to the second plurality of batteries supported by the second container and an open state wherein the first battery of the first plurality of batteries supported by the first container is electrically uncoupled from the second plurality of batteries supported by the second container.

In one illustrated embodiment, the first container is a first drawer which is moveably coupled to a rack and the second container is a second drawer which is moveably coupled to the rack. In one example the first container includes a first electrical interface along a rear of the first container, the second container includes a second electrical interface along a rear of the second container, the rack including a rack interface which engages the first electrical interface of the first container and the second electrical interface of the second container, the second side of the first container corresponding to the rear of the first container. In a variation thereof, the first side of the first container is opposite of the second side of the first container.

In another illustrated embodiment, in the closed state of the circuit interrupter the first battery of the first plurality of batteries supported by the first container is electrically coupled to a second battery of the first plurality of batteries supported by the first container and in the open state of the circuit interrupter the first battery of the first plurality of batteries supported by the first container is electrically uncoupled to a second battery of the first plurality of batteries supported by the first container. In one example, the first battery of the first plurality of batteries supported by the first container is electrically coupled to a second battery of the first plurality of batteries supported by the first container in series when the circuit interrupter is in the closed state.

In a further exemplary embodiment of the present disclosure, an energy storage system is provided. The energy storage system comprising a plurality of containers including a first energy module container including a first plurality of batteries electrically coupled together, a second energy module container including a second plurality of batteries electrically coupled together, and a power control container including at least one inverter; a first set of power lines electrically coupling the first plurality of batteries of the first energy module container to the at least one inverter of the power control container, the first set of power lines carrying DC power between the first energy module container and the power control container; and a second set of power lines electrically coupling the second plurality of batteries of the second energy module container to the at least one inverter of the power control container, the second set of power lines carrying DC power between the second energy module container and the power control container, wherein the first set of power lines and the second set of power lines have generally equal resistance.

In one illustrated embodiment, the first energy module container is spaced apart from the second energy module container and the power module container.

In another illustrated embodiment, the first energy module container is supported on top of one of the second energy module container and the power module container.

In still another illustrated embodiment, the first energy module container, the second energy module container, and the power module container are each shipping containers.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 illustrates an exemplary system configuration;

FIG. 2 illustrates a perspective view of an exemplary site installation of the system of FIG. 1;

FIG. 3 illustrates another perspective view of the exemplary site installation of FIG. 2;

FIGS. 4, 4A and 4B illustrate a top view of the exemplary site installation of FIG. 2;

FIG. 5 illustrates a perspective view of another exemplary site installation of the system of FIG. 1;

FIG. 6 illustrates another perspective view of the exemplary site installation of FIG. 5;

FIG. 7 illustrates the exemplary site installation of FIG. 6 with the mezzanine and upper energy module containers removed;

FIG. 8 illustrates an end view of the exemplary site installation of FIG. 5;

FIG. 9 illustrates an exemplary interior of a container of an energy module;

FIG. 10 illustrates an exemplary cooling system for the batteries of the energy module of FIG. 9;

FIG. 11 illustrates an exemplary cooling system for the energy module of FIG. 9;

FIG. 12 illustrates a left side view of an exemplary container of the energy module of FIG. 9;

FIGS. 13A and 13B illustrate the left side of the container of FIG. 12;

FIGS. 14A and 14B illustrate the right side of the container of FIG. 12;

FIG. 15 illustrates the rear side of the container of FIG. 12;

FIG. 16 illustrates a representative top view of an interior of the container of FIG. 12 along lines 16-16 in FIG. 12;

FIG. 17 illustrates a sectional view of an interior of the container of FIG. 12 along lines 17-17 in FIG. 12;

FIG. 18 illustrates a sectional view of an interior of the container of FIG. 12 along lines 18-18 in FIG. 12;

FIG. 19 illustrates a sectional view of an interior of the container of FIG. 12 along lines 19-19 in FIG. 12;

FIG. 20 illustrates a front, perspective view of an exemplary energy module drawer of the energy module of FIG. 9 including a plurality of battery modules;

FIG. 20A illustrates a representative view of an exemplary battery element of a batter module of FIG. 20;

FIG. 20B illustrates a representative view of the battery module of FIG. 20;

FIG. 20C illustrates a representative view of a drawer interface and corresponding rack interface of the energy module of FIG. 9, the drawer interface being disengaged relative to the rack interface;

FIG. 20D illustrates the drawer interface and rack interface of FIG. 20 engaged;

FIG. 21 illustrates a rear, perspective view of the exemplary energy module drawer of FIG. 20;

FIG. 21A illustrates an exemplary tensioning member of the exemplary energy module drawer of FIG. 20;

FIG. 22 illustrates an exploded view of a portion of the exemplary energy module drawer of FIG. 20;

FIG. 23 illustrates the portions of FIG. 22 unexploded;

FIG. 24 illustrates a sectional view of the assembly of FIG. 23 along lines 24-24 in FIG. 23;

FIG. 25 illustrates a top view of the exemplary energy module drawer of FIG. 20;

FIG. 25A illustrates a bottom view of the exemplary energy module drawer of FIG. 20;

FIG. 26 illustrates an exemplary series electrical power circuit of the energy module drawer of FIG. 20 including a circuit interrupter accessible from an exterior of the drawer;

FIG. 27 illustrates the exemplary series electrical power circuit of FIG. 26 with the circuit interrupter in an open position;

FIG. 28 illustrates a side view of the exemplary energy module drawer of FIG. 20;

FIG. 29 illustrates a front, perspective view of an exemplary rack frame of the energy module of FIG. 9;

FIG. 30 illustrates an exemplary drawer slide assembled to the rack frame of FIG. 29 and exemplary frame for a battery cooling system;

FIG. 31 illustrates the exemplary assembly of FIG. 23 aligned with an opening in the exemplary rack frame of FIG. 29;

FIG. 32 illustrates an exemplary front view of a rack of energy module drawers assembled into a plurality of sub-groups;

FIG. 32A illustrates a front view of the rack frame of FIG. 29 including a plurality of the energy module drawers of FIG. 20 being assembled thereto;

FIG. 33 illustrates an exemplary installation of an energy module drawer into a rack structure;

FIG. 34 illustrates an exemplary electrical connection interface module of a drawer interface disengaged from an exemplary electrical connection interface module of a rack interface;

FIG. 35 illustrates the exemplary electrical connection interface module of the drawer interface engaged with the exemplary electrical connection interface module of the rack interface;

FIG. 36 illustrates an exemplary fluid connection interface module of a drawer interface disengaged from an exemplary fluid connection interface module of a rack interface;

FIG. 37 illustrates the exemplary fluid connection interface module of the drawer interface engaged with the exemplary fluid connection interface module of the rack interface;

FIG. 38 illustrates portions of an exemplary battery cooling system;

FIG. 39 illustrates an exemplary fluid pump assembly of the battery cooling system of FIG. 38;

FIG. 40 illustrates another exemplary electrical connection interface module of the rack interface including a communication interface;

FIG. 41 illustrates another exemplary electrical connection interface module of the drawer interface including a communication interface;

FIG. 42 is a block diagram illustrating electrical connections between a plurality of racks containing a plurality of battery sub-groups or strings to positive, negative and ground buses connected to a DC distribution box within an energy module container;

FIG. 43 is a diagrammatical view illustrating a plurality of drawers containing a plurality of battery modules connected together in series to form a battery sub-group or string of one of the racks;

FIG. 44 is a perspective view illustrating a plurality of electrical cables and contact bars for coupling drawers of each rack to each other and to the positive, negative and ground buses;

FIG. 45 is an enlarged view of a portion of FIG. 44 showing additional details of electrical cables, contact bars, and positive, negative and ground buses;

FIG. 46 is a rear view of one of the racks showing electrical connections between adjacent drawers of battery modules and to a high voltage drawer of the rack;

FIG. 47 is a schematic drawing of electrical circuitry in the DC distribution box and the external disconnect unit located adjacent one of the containers housing an energy module;

FIG. 48 is a diagrammatical view of a display panel located adjacent an access opening into the container, the display panel showing readings from three volt meters connected to the circuitry of the DC distribution box and the external disconnect unit;

FIG. 49 is a diagrammatical view of components within the high voltage drawer of one of the racks;

FIG. 50 is a flow chart illustrating steps performed by the control system of the present disclosure for selectively disconnecting a battery string from a rack, such as when a fault condition occurs for the particular string;

FIG. 51 is a block diagram illustrating a controller for selectively opening and closing contactors of each of the plurality of racks to connect and disconnect the racks from the positive and negative buses within the container;

FIG. 52 is a flow chart illustrating steps performed by the control system to control the contactors in a plurality of racks of the energy module within the container when the energy module is brought on line, including a redundant pre-charge performed by either rack one or rack two;

FIG. 53 is a flow chart of the steps performed by the control system to pre-charge either rack one or rack two of the energy module;

FIG. 54 is a block diagram illustrating primary and secondary (back-up) programmable logic controllers (PLCs) for monitoring and controlling operation of system components, and illustrating communication between battery module controllers, a unit central controller, a remote computer and the PLCs;

FIG. 55 is a diagrammatical view of the low voltage drawer;

FIG. 56 is a flow chart illustrating steps performed by the central system for monitoring a string voltage to detect string voltage difference faults;

FIG. 57 is a block diagram illustrating components to control an emergency stop function when a person enters an interior region of an energy module container; and

FIG. 58 is a block diagram illustrating a ground fault detection circuit in each of a plurality of energy modules and in a power control module coupled to the plurality of energy modules.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings. While the present disclosure primarily involves storing and providing energy to a power grid, it should be understood, that the invention may have application to other devices which receive power from batteries. In one embodiment, the systems and methods disclosed herein may be implemented to provide an uninterrupted power supply for computing devices and other equipment in data centers. A controller of the data center may switch from a main power source to an energy storage system of the present disclosure based on one or more characteristics of the power being received from the main power source or a lack of sufficient power from the main power source.

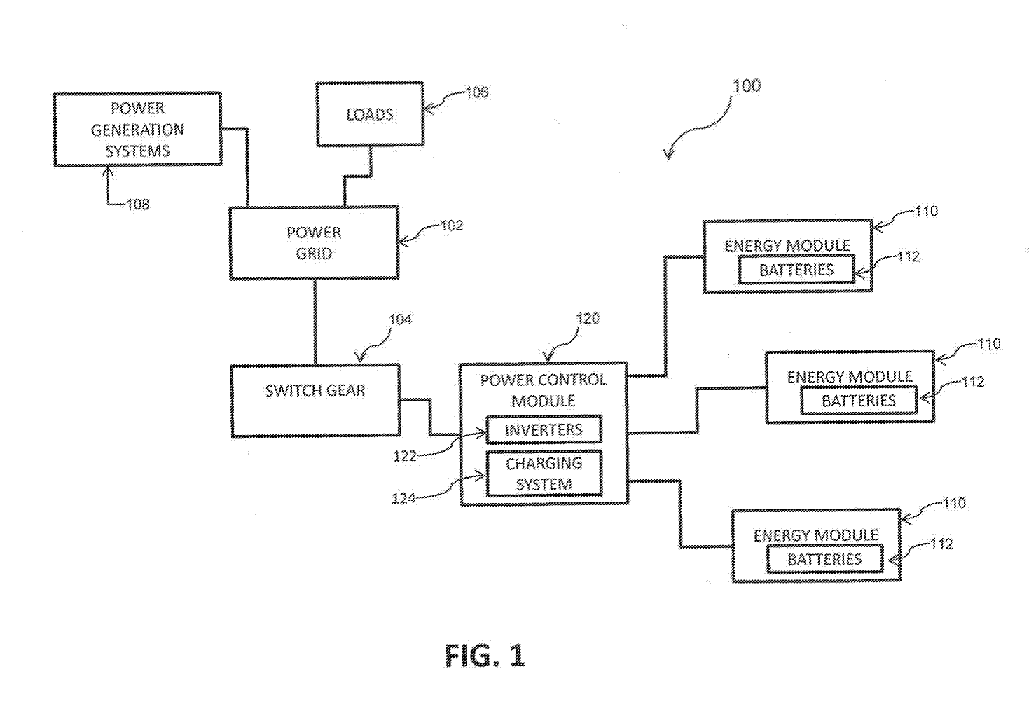

Referring to FIG. 1, an exemplary energy system 100 is shown. Energy system 100 is operatively connected to a power grid 102 through a switch gear 104. Switch gear 104 connects and disconnects energy system 100 relative to power grid 102. Energy system 100 includes one or more energy modules 110, each including a plurality of batteries 112. Batteries 112 store energy. Energy system 100 further includes a power control module 120. Power control module 120 includes one or more inverters 122 which convert DC power produced by batteries 112 into AC power for communication to power grid 102 through switch gear 104. Power control module 120 further includes a charging system 124 which receives power from power grid 102 and uses that power to charge batteries 112.

Energy system 100 may provide energy to the power grid 102 to power one or more loads 106. Further, energy system 100 may receive power from power grid 102 to charge batteries 112 of energy modules 110. Power grid 102 may receive power from one or more power generation systems 108. Exemplary power generation systems 108 include hydroelectric based power plants, coal based power plants, nuclear based power plants, wind based power plants, solar based power plants, and other suitable systems for generating electrical energy. In one embodiment, when excess power is available on power grid 102, energy is provided to energy system 100 to charge batteries 112 and thereby store the energy for future use. The stored energy may be used to provide power during peak times of energy demand by loads 106 or during times of interrupted service from other power generation systems 108.

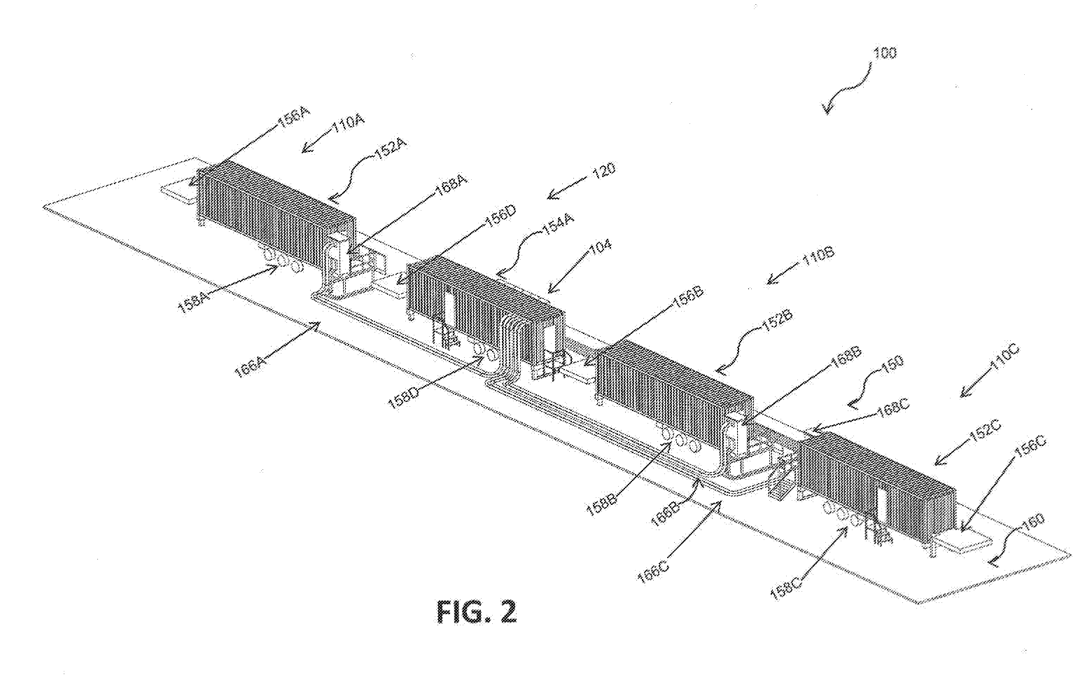

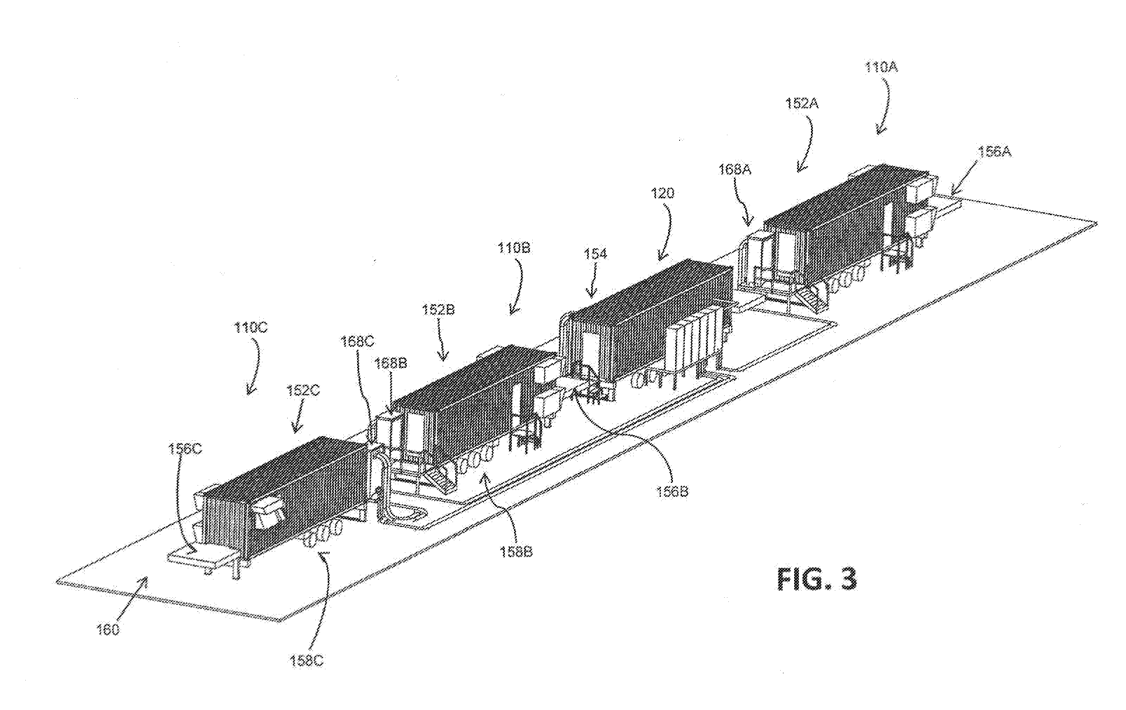

Referring to FIGS. 2-4B, an exemplary site installation 150 of an embodiment of energy system 100 is shown. In the illustrated embodiment, each energy modules 110 is housed within a container 152 and power control module 120 is housed within a container 154. In one embodiment, containers 152 and 154 are supported by trailers 156 which support containers 152 and 154 above the ground 160 by wheels 158 or other suitable ground engaging devices. Trailers 156 may be towed by a semi-tractor (not shown) to the site location. In one embodiment, a concrete or other type of pad at the site location is provided to support the trailers 156 thereon. In one embodiment, containers 152 and 154 are shipping containers which may be vertically removed from trailers 156 via a crane.

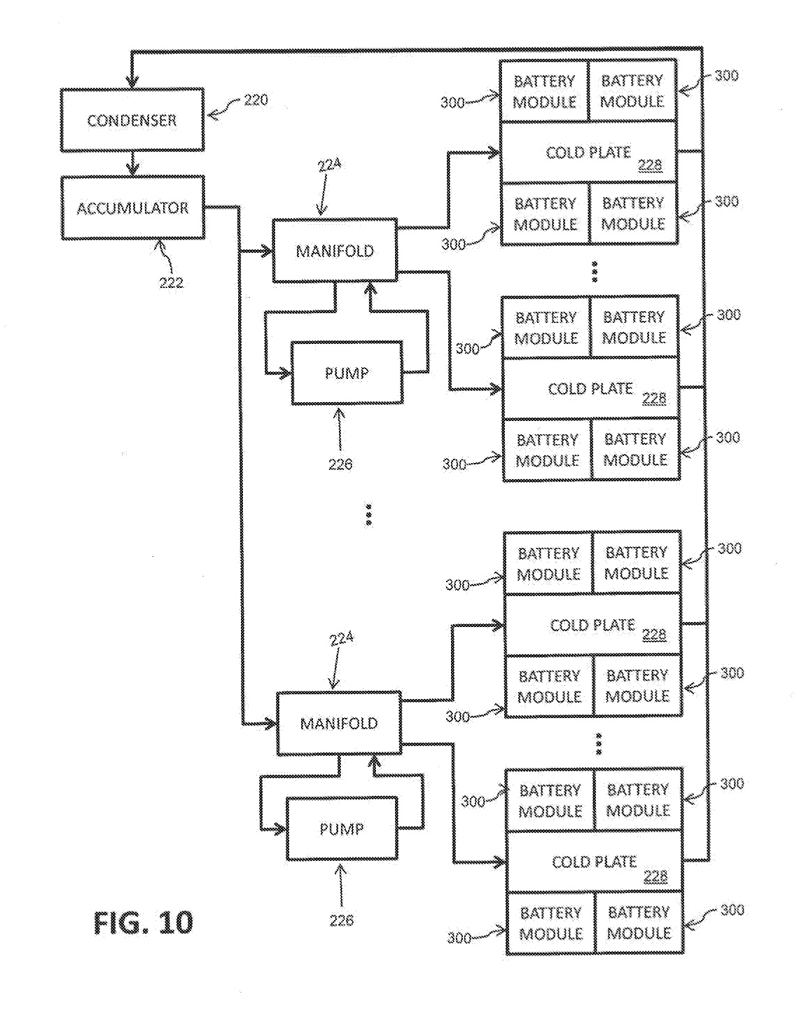

As described herein, a plurality of battery modules 300 are provided within each of container 152. Power from the active battery modules 300 are provided to the inverters 122 housed in container 154 through the respective power lines 166. In the illustrated embodiment, power lines 166 are coupled to an external disconnect unit 168 which is coupled to a DC distribution box 170 (see FIG. 10) located within container 152. DC distribution box 170 receives power from the active battery modules 300 or provides power to the active battery modules. The external disconnect unit 168 includes switches which connect or disconnect DC distribution box 170 relative to power control module 120. In this manner, an operator by opening the switches of external disconnect unit 168 may uncouple container 152 from container 154. In the illustrated embodiment, the external disconnect unit 168 is positioned external to container 152. In one embodiment, the external disconnect unit 168 is accessible from an exterior of container 152 and positioned within a periphery of container 152. In one embodiment, the external disconnect unit is positioned in an interior of the container 152.

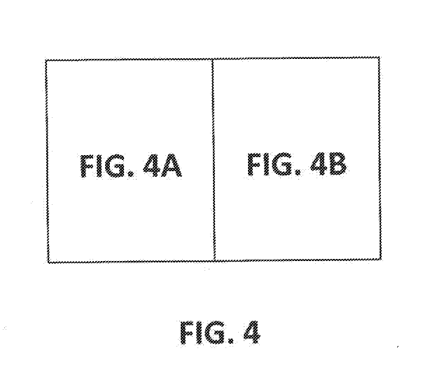

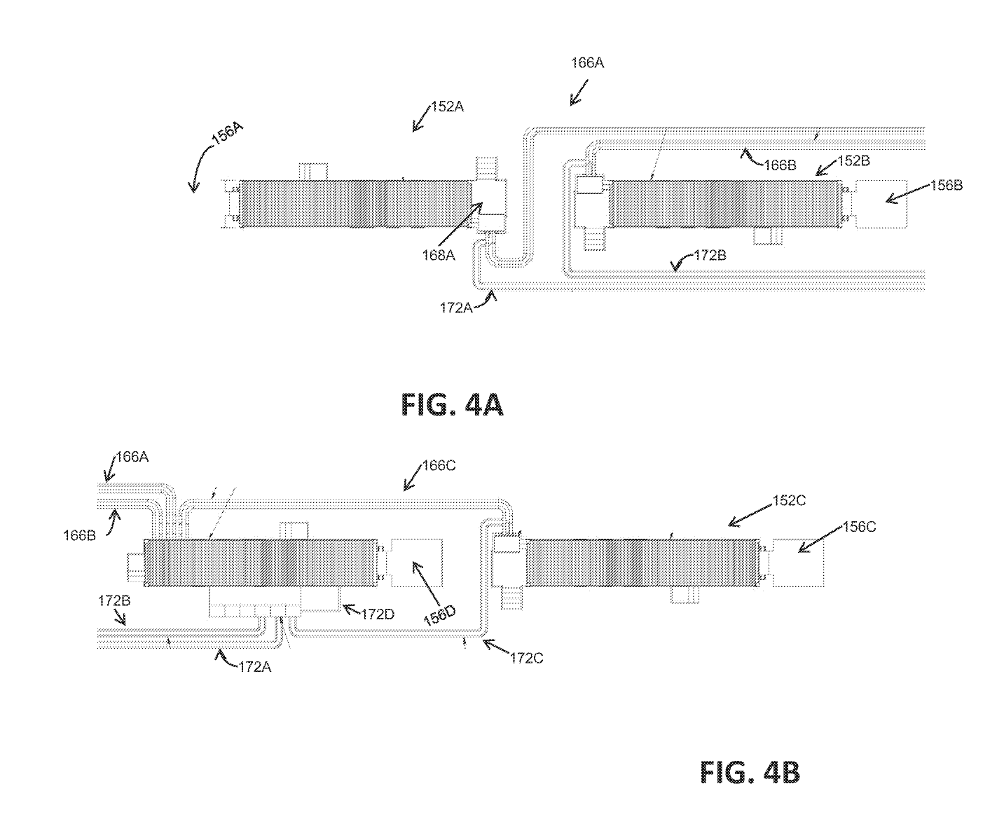

As described herein, container 152 and container 154 include components using AC electrical power to operate. Exemplary components include HVAC components and other suitable devices. In the illustrated embodiment, the AC electrical power is provided from switch switch gear 104 to each of container 152 and container 154 through power lines 172 which couple to external disconnect unit 168 for container 152 (see FIGS. 4A and 4B). In addition, in one embodiment, the switch gear 104, energy modules 110, and the power control module 112 communicate over fiber optic cables. The fiber optic cables provide electrical isolation between the various modules. In this manner, if one of the modules happens to be at a higher potential than one of the remaining modules it is connected to, the fiber optic will not serve as a conduction path. In one example, a module may be at a higher potential due to a lightning strike. strike.

As shown in FIGS. 4A and 4B, container 152A-C are arranged so that the length of the respective power lines 166 is generally about equal. This keeps the resistance associated with each of energy modules 110 (due to power lines 166) generally equal. Since energy modules 110 are coupled to power control module 120 in parallel, this keeps energy system 100 generally balanced. Although three energy modules 110 are illustrated, more or fewer energy modules 110 may be included. Further, although each energy module 110 is shown positioned within a single container 152, one or more energy modules 110 may span multiple containers 152. Alternatively, more than one energy module may be positioned within a single container 152. Container 152 may have any shape or size. In one embodiment, container 152 is sized to be transportable by a semi-tractor and trailer. Container 152 may be a permanent structure or a moveable structure.

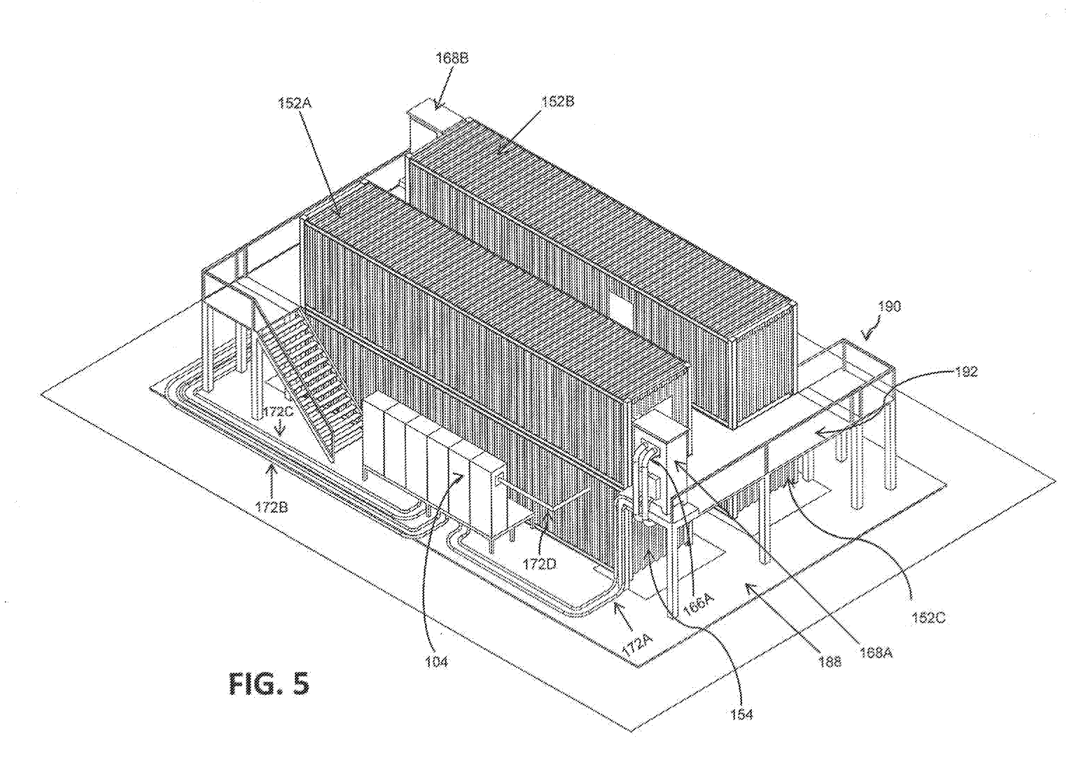

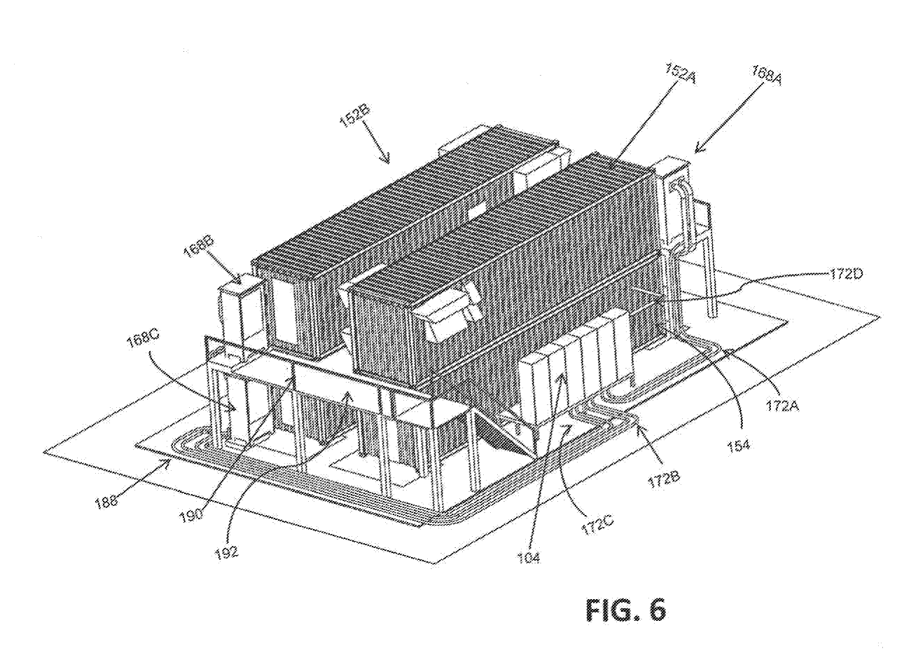

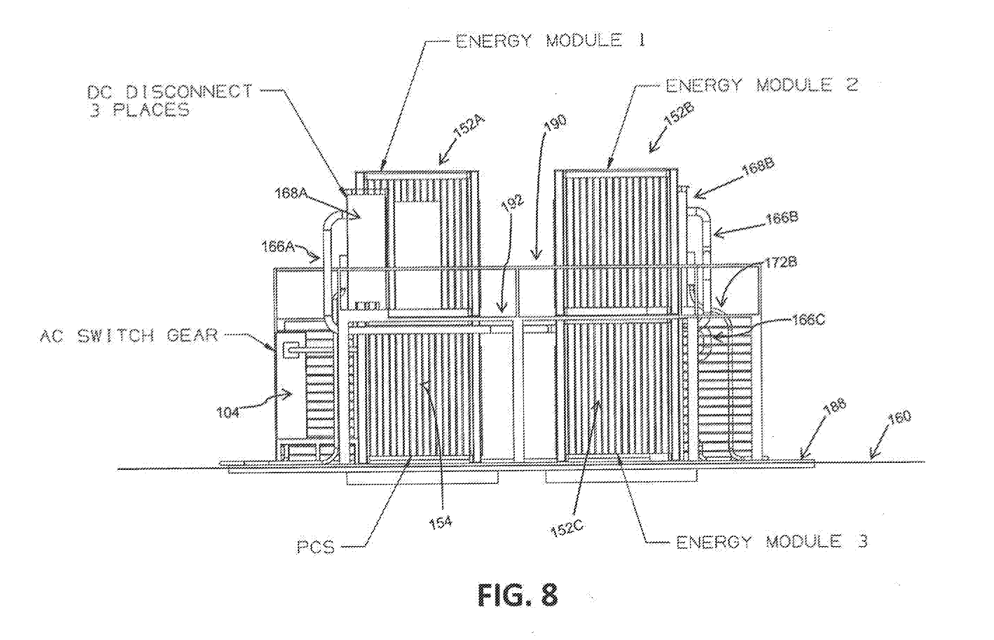

Referring to FIGS. 5-8, an exemplary site installation 180 of an embodiment of energy system 100 is shown. Site installation 180, like site installation 150, includes three energy modules 110, each housed in a respective container 152, and a power control module 120, housed in a container 154. Unlike site installation 150, containers 152 and container 154 are not supported on trailers 156. Rather, container 152A is supported on top of container 154 and container 152B is supported on top of container 152C. In one embodiment, container 152A and container 152B are coupled to the respective container 154 and container 152C through double cone couplers available from Tandemloc Inc. located at 824 Highway 101 in Havelock, N.C. Similar couplers may be anchored in a concrete pad 188 to couple container 154 and container 152C to the concrete pad 188.

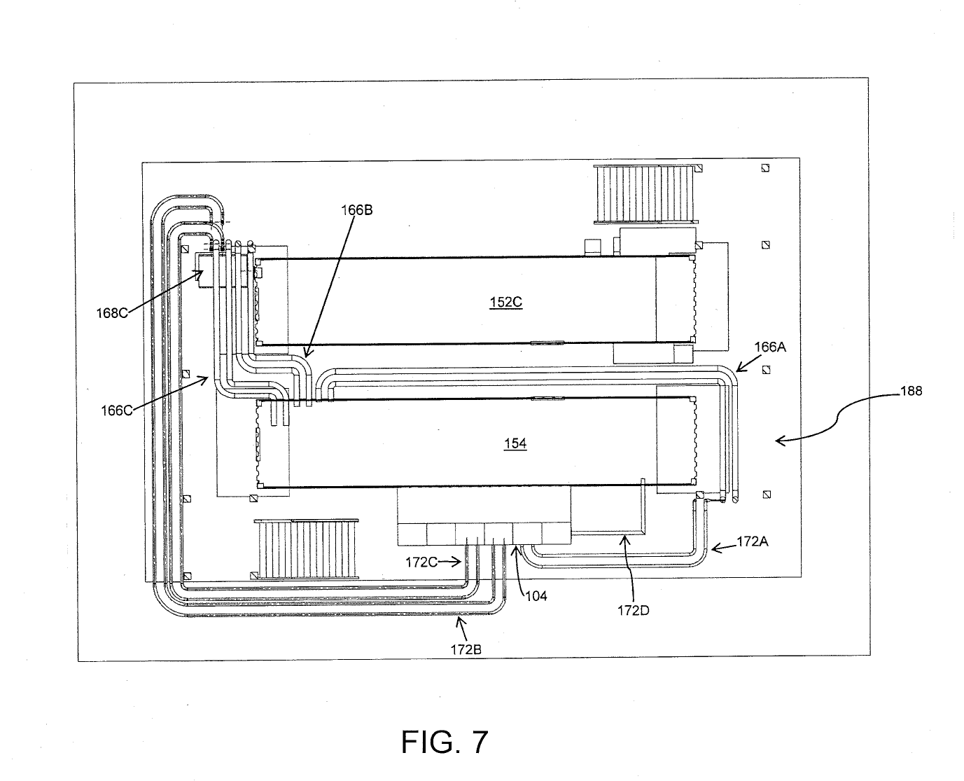

A platform 190 is provided proximate to the containers. Platform 190 includes a walkway 192 on which operators may walk. Platform 190 also supports the external disconnect units 168 for container 152A and container 152B. Platform 190 is supported by concrete pad 188. In one embodiment, platform 190 is coupled to one or more of container 152 and container 154. Platform 190 may be coupled to one or more of container 152 and container 154 through fasteners, welding, and other suitable couplers. Platform 190 assists in maintaining the position of container 152A and container 152B. As shown in FIG. 7, power lines 166 are suspended from platform 190 and are elevated above concrete pad 188.

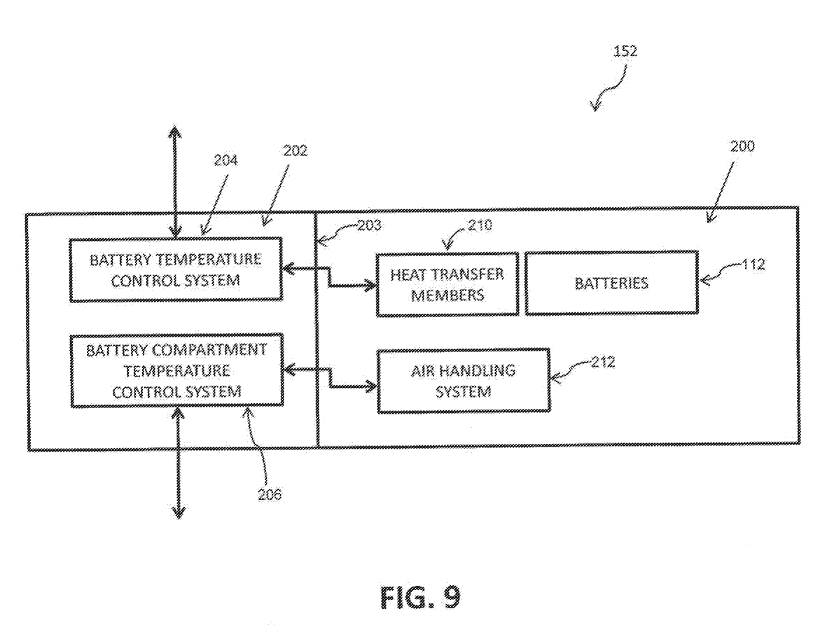

Referring to FIG. 9, a representation of an interior of container 152 is shown. Container 152 is divided into two compartments which are in fluid communication with each other. A first compartment 200 houses batteries 112. The first compartment 200 is insulated. A second compartment 202 houses at least a portion of a battery temperature control system 204 and a battery compartment temperature control system 206. The portion of battery temperature control system 204 housed within second compartment 202 is in fluid communication with the air surrounding container 152 to alter a temperature of a heat transfer fluid which is circulated to heat transfer members 210 in first compartment 200. In one embodiment, the heat transfer fluid receives heat from batteries 112 to cool batteries 112.

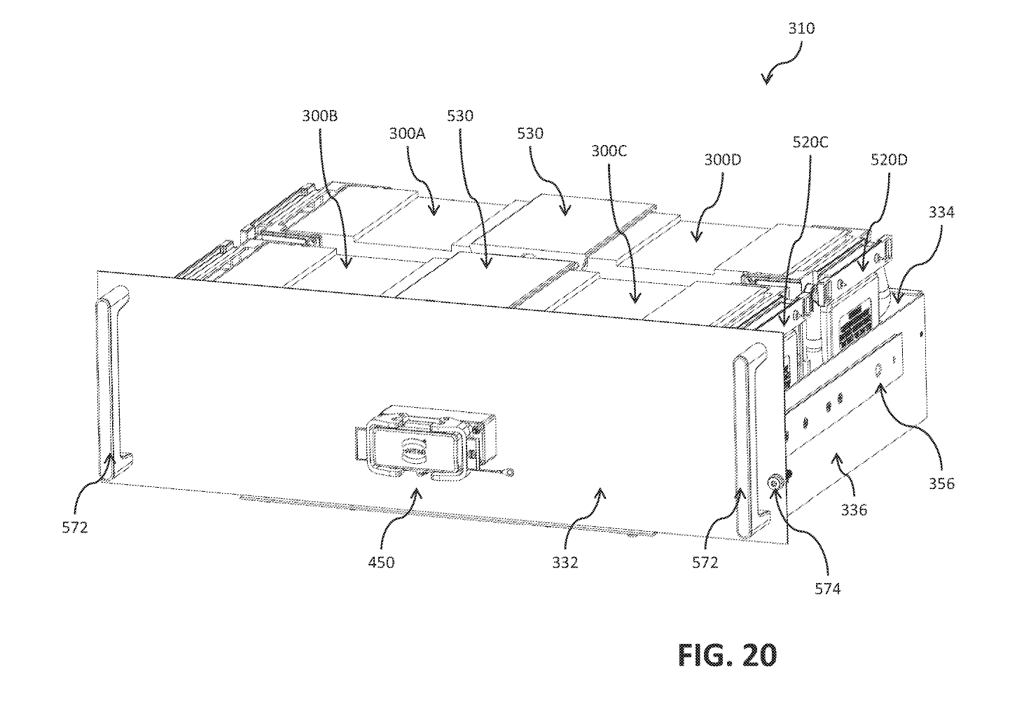

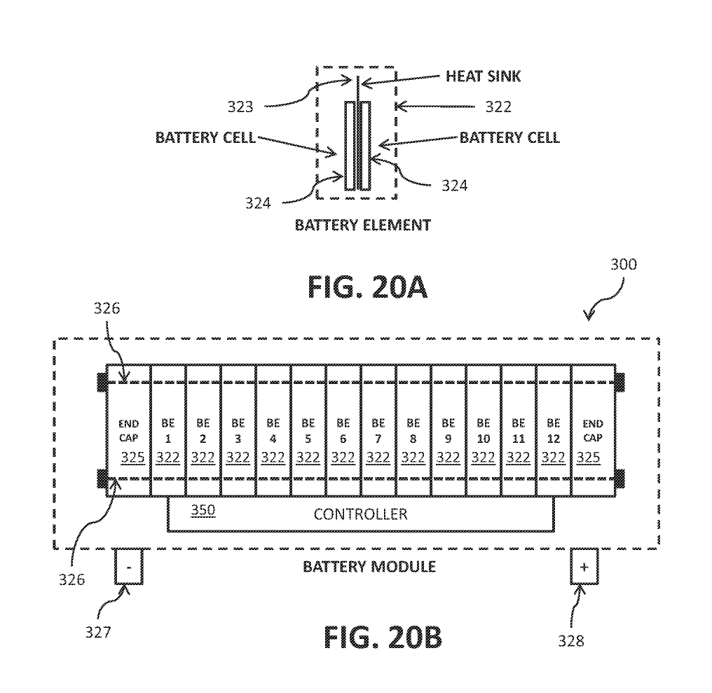

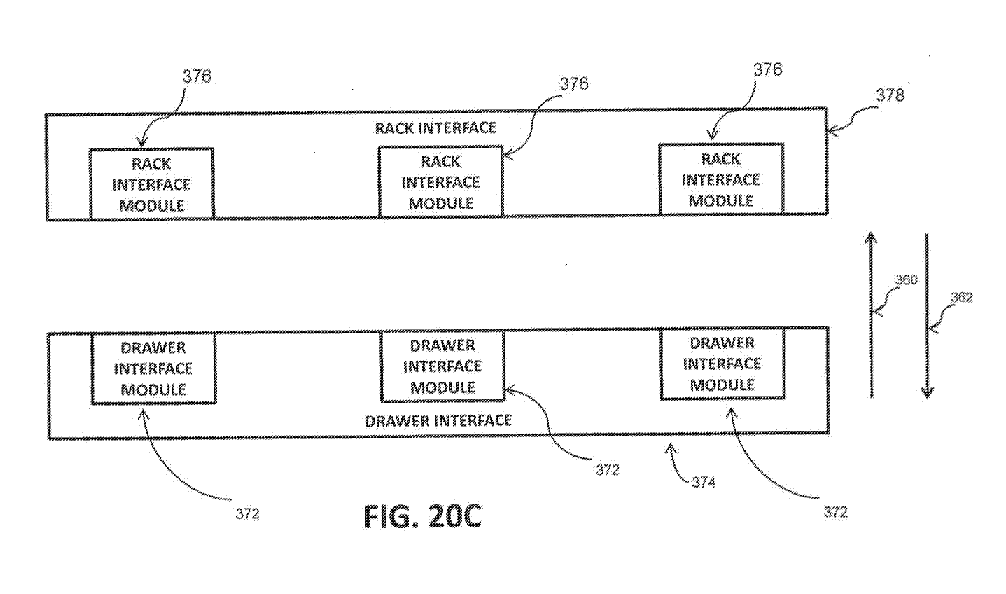

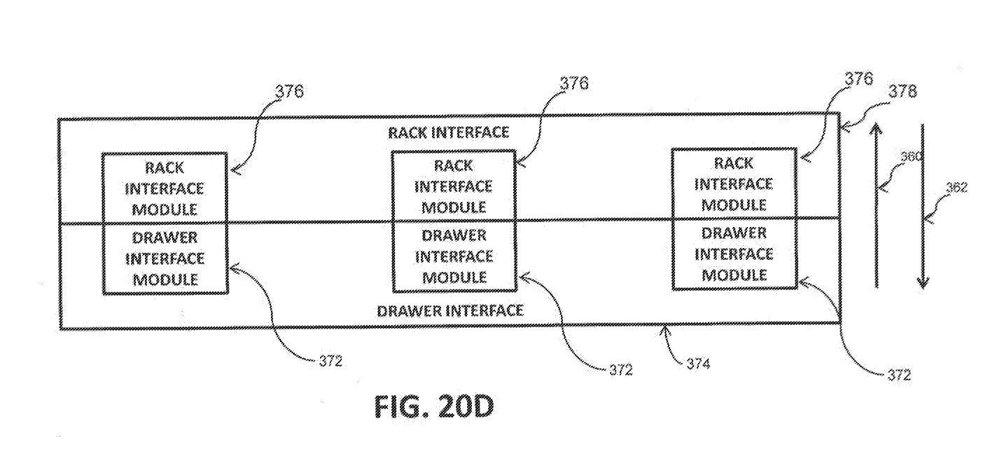

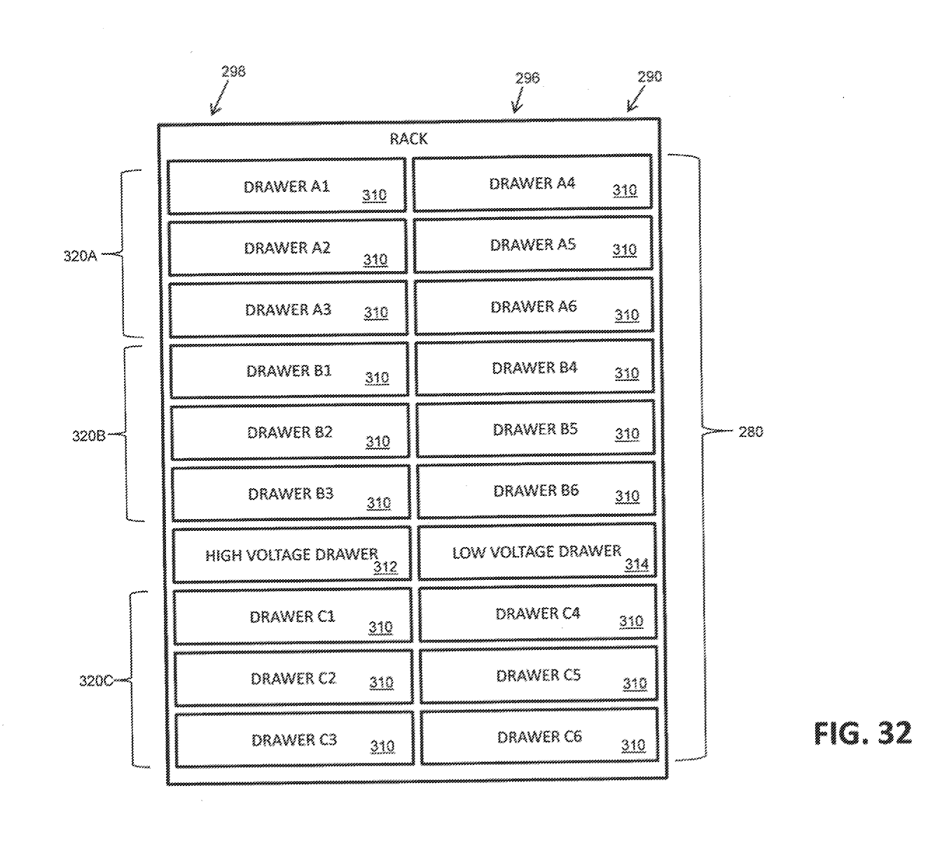

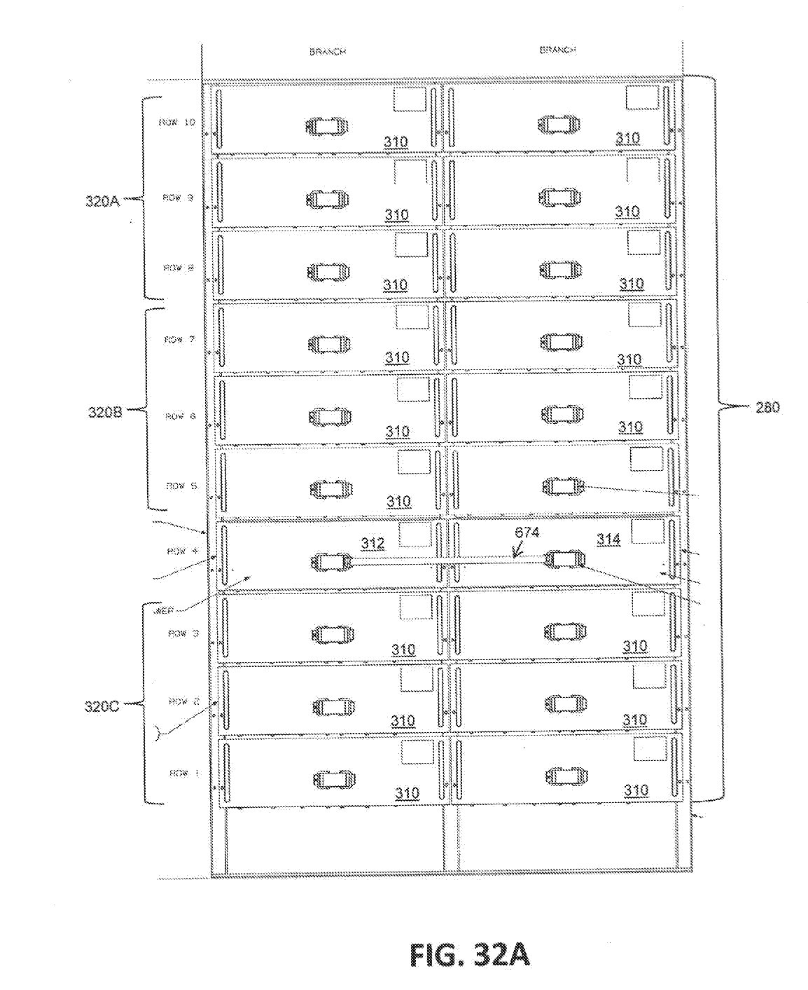

Referring to FIG. 10, an exemplary battery temperature control system 204 with heat transfer members 210 (cold plates 228) positioned in first compartment 200 is shown. A condenser unit 220 is provided in second compartment 202. Condenser unit 220 cools a heat transfer fluid of battery temperature control system 204. The cooled heat transfer fluid is stored in an accumulator 222 positioned in first compartment 200. The heat transfer fluid is communicated to a plurality of manifolds 224. Each manifold has an associated pump 226 which pumps the heat transfer fluid to one or more cold plates 228. The cold plates receive heat from the battery modules 300 associated with the respective cold plates. The heated heat transfer transfer fluid exits the cold plates 228 and is returned to condenser unit 220. As explained herein, the battery modules 300 are positioned within drawers 310 (see FIG. 20) which are assembled to rack frames 290 (see FIG. 32). In one embodiment, a pump 226 pumps fluid to all of the cold plates 228 of a respective rack. The heat transfer fluid flows from the pump along a rear portion of the rack frame 290 into the respective drawers 310, receives heat from the battery modules 300 within the respective drawers 310, and flows back out of the respective drawers 310 along the rear portion of the rack frame and back to the condenser unit 220.

In one embodiment, the heat transfer fluid of battery temperature control system 204 is a Vaporizable Dielectric Fluid (VDF). The heat transfer fluid enters cold plates 228 as a liquid and generally exits cold plates 228 as a liquid/vapor mixture. The liquid/vapor mixture is returned back to a liquid due to the cooling performed by condenser unit 220.

Returning to FIG. 9, the portion of battery compartment temperature control system 206 housed within second compartment 202 is in fluid communication with the air surrounding container 152 to alter a temperature of a heat transfer fluid which is circulated through an air handling system 212 into first compartment 200. The air returned to second compartment 202 has received heat from the batteries 112 and other components in first compartment 200. In one embodiment, the heated air returns to the second compartment through an air return in a partition wall 203 of container 152. In one embodiment, battery compartment temperature control system 206 maintains first compartment 200 at a positive pressure, maintains a temperature of first compartment 200 within a given temperature range, and maintains a humidity of first compartment 200. In one example, battery compartment temperature control system 206 maintains a positive pressure of at least about 5 Pa and to keep the humidity up to about 50%. When first compartment 200 requires cooling, battery compartment temperature control system 206 maintains the temperature of battery compartment temperature control system 206 within a range of about 15° C. to about 30° C. and generally about 20° C. When first compartment 200 requires heating, battery compartment temperature control system 206 maintains the temperature of battery compartment temperature control system 206 at at least 12° C.

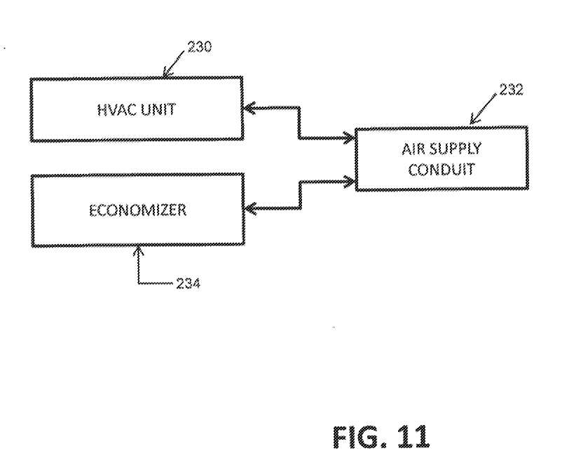

Referring to FIG. 11, in one embodiment battery compartment temperature control system 206 includes a HVAC unit 230 which cools air received from 200 and returns the cooled air to first compartment 200 through an air supply conduit 232 to cool first compartment 200. Battery compartment temperature control system 206 further includes an economizer 234 which receives air from an exterior of container 152 and circulates that air through first compartment 200 to cool first compartment 200. Based on the temperature of first compartment 200 and the conditions, such as temperature and humidity, of the air surrounding container 152 economizer 234 may provide all of the cooling of battery compartment temperature control system 206, a part of the cooling of battery compartment temperature control system 206, or none of the cooling of battery compartment temperature control system 206. In one embodiment, the economizer 234 provides cooling to first compartment 200 when the air surrounding container 152 is less than about 0° C. In cold conditions, second compartment 202 may include a space heater to warm the components within second compartment 202.

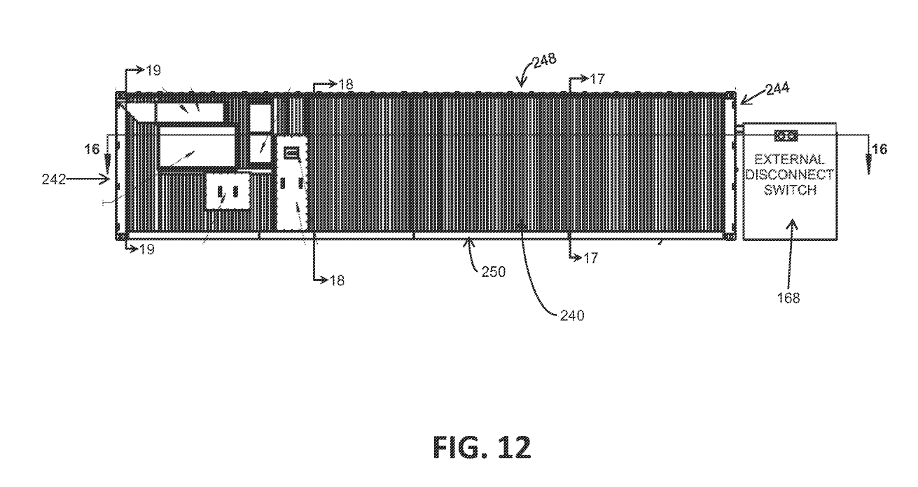

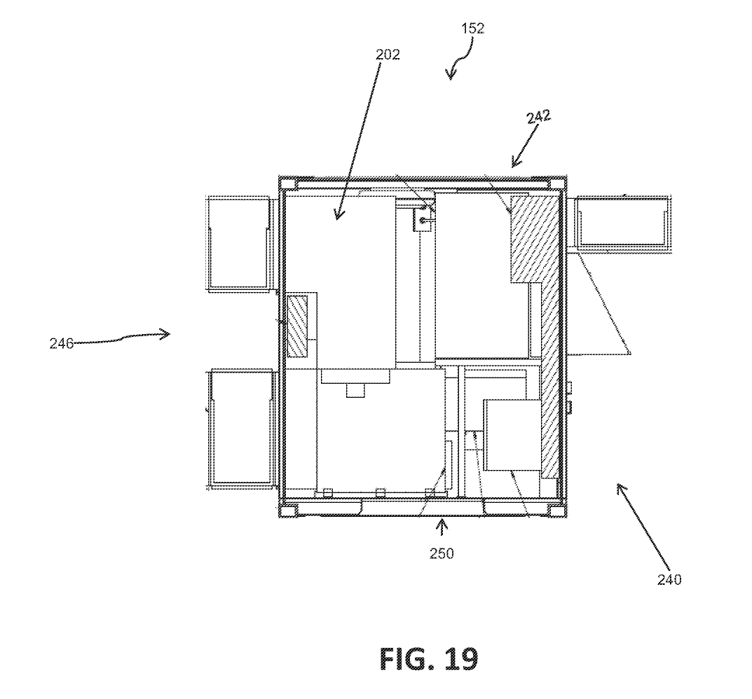

Referring to FIGS. 12-19, an exemplary container 152 is illustrated. Referring to FIG. 12, a first side 240 is shown. First side wall 240 is bounded by a front side 242, a rear side 244, a top side 248, and a bottom side 250. A second side 246 (see FIG. 14A) is also provided. In one embodiment, container 152 is a parallelepiped. Container 152 may have any shape or size. In one embodiment, container 152 is sized to be transportable by a semi-tractor and trailer. Container 152 may be a permanent structure or a moveable structure.

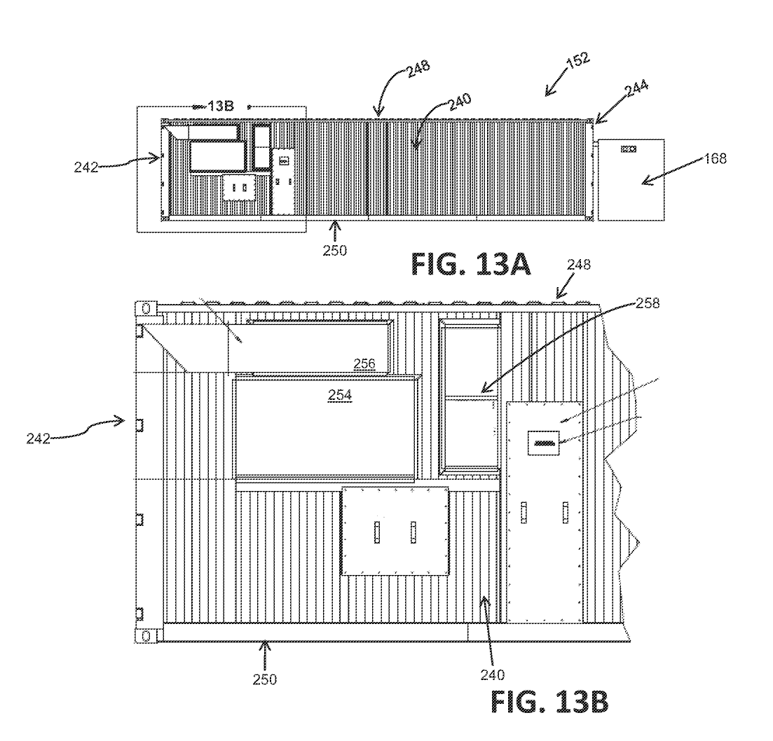

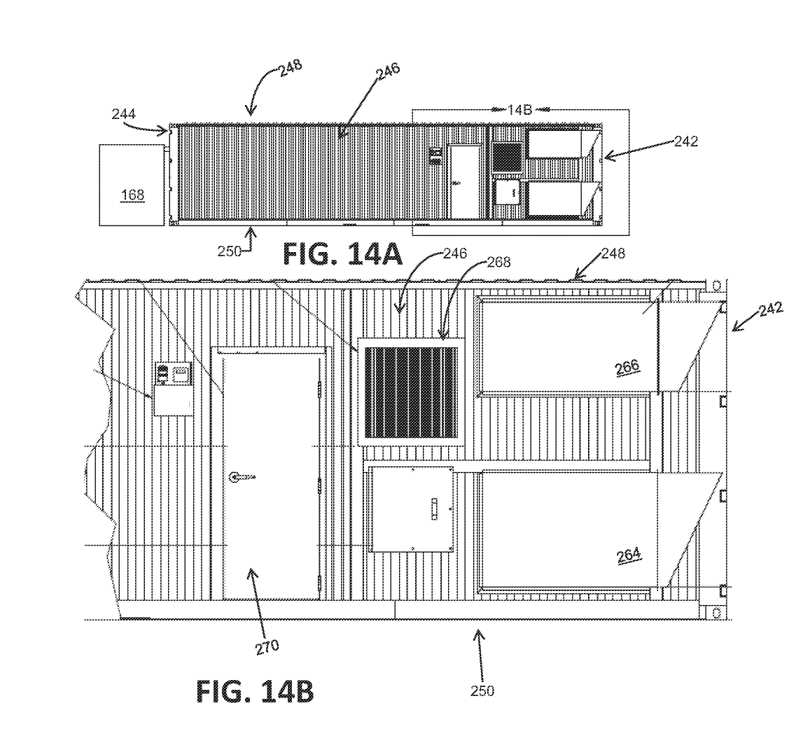

Referring to FIG. 13B, first side wall 240 includes an intake hood 254 for condenser unit 220 of battery temperature control system 204 and an exhaust hood for condenser unit 220 of battery temperature control system 204. First side wall 240 also includes intake hood 258 for economizer 234 of battery compartment temperature control system 206. An access panel 260 is also provided in first side wall 240 to access compressed gas tanks 262. In one embodiment, compressed gas tanks 262 include a mixture of argon and nitrogen gas. In one embodiment, compressed gas tanks 262 include carbon dioxide gas. In one embodiment, compressed gas tanks 262 include FM-200 or other suitable fire suppression gases. Compressed gas tanks 262 are part of a fire suppression system which monitors first compartment 200 for signs of a potential fire. In one embodiment, the fire suppression system monitors the first compartment 200 for smoke, heat, temperature, and/or other characteristics which may indicate a fire or a potential fire. In the event of the detection of a fire or potential fire, the gas stored within compressed gas tanks 262 is released to assist in suppressing any fire.

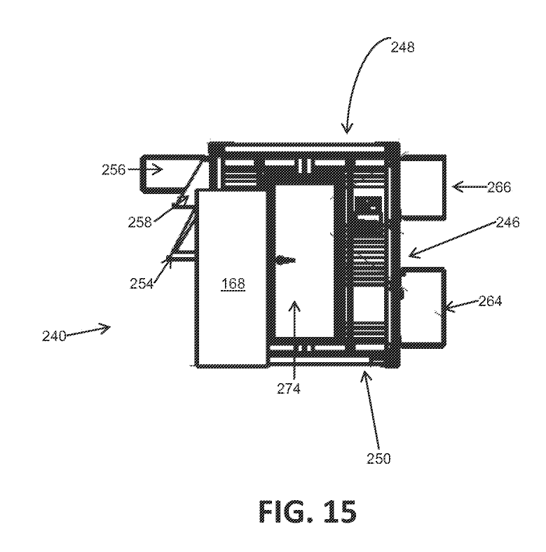

Referring to FIG. 14B, second side wall 246 includes an intake hood 264 for HVAC unit 230 of battery compartment temperature control system 206 and an exhaust hood for HVAC unit 230 of battery compartment temperature control system 206. Air inlet 268 is also provided for a secondary condensing coil of battery temperature control system 204. A door 270 270 is also provided. Access door 270 provides access to an interior of first compartment 200 of of container 152. Referring to FIG. 15, a second access door 272 is provided on the back side of container 152. Second access door 272 also provides access to an interior of first compartment 200 of container 152. In one embodiment, the interior of first compartment 200 has an insulating insulating material positioned against all sides of container 152 and a wood panel or other wall structure positioned over the insulation material and secured to the sides of container 152. In one one embodiment, front wall 242 is hinged relative to one of first side wall 240 and second side wall 246 and may be rotated to provide access to an interior of second compartment 202.

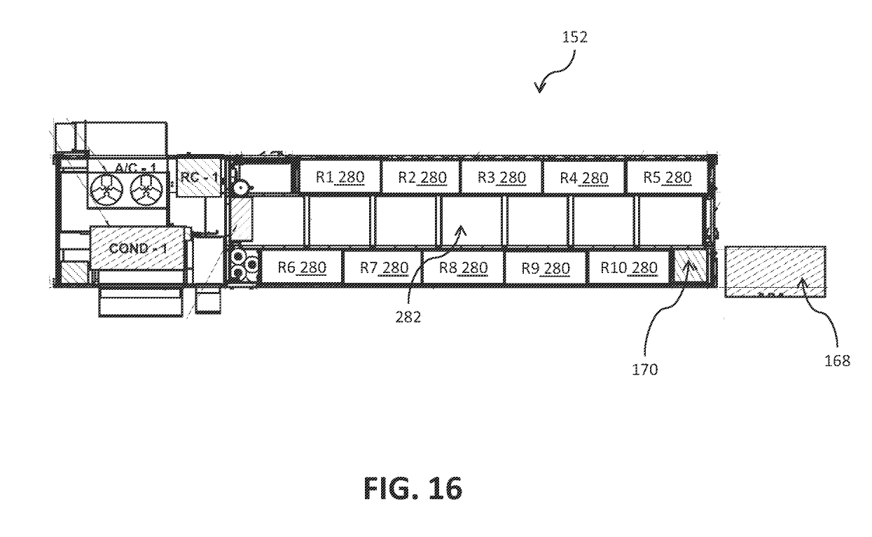

Referring to FIG. 16, a top sectional view of container 152 is shown. As represented in FIG. 16, a plurality of battery groups 280 are provided in first compartment 200. Each battery group 280 is connected in parallel to DC distribution box 170. In one embodiment, each battery group 280 provides about 1200 volts and about 1 Megawatt of power. In one embodiment, each battery group 280 provides at least about 720 volts. In one embodiment, each battery group 280 provides up to about 1180 volts. In one embodiment, each battery group 280 provides between about 720 volts and 1180 volts.

As explained in more detail herein, each battery groups 280 includes a plurality of battery sub-groups or strings. In one embodiment, each battery group 280 includes three battery strings which are connected in parallel. Each string includes a plurality of batteries 112 connected together in series.

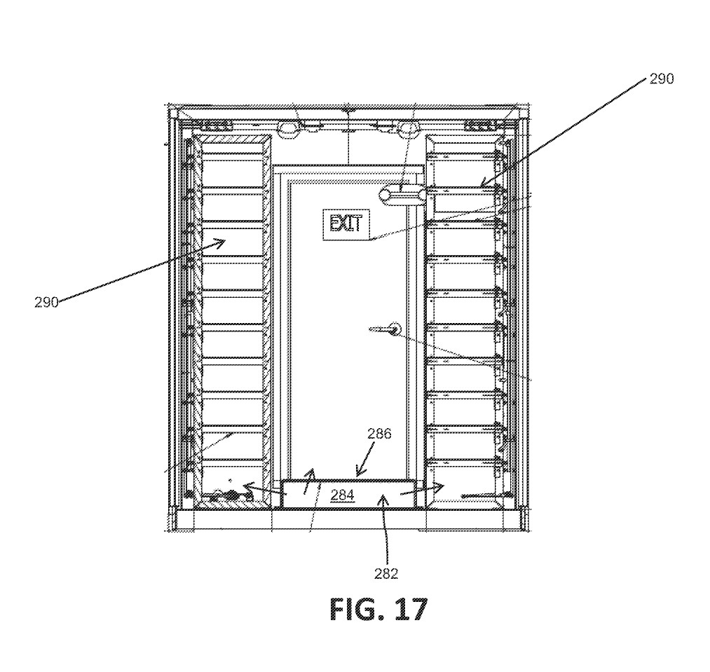

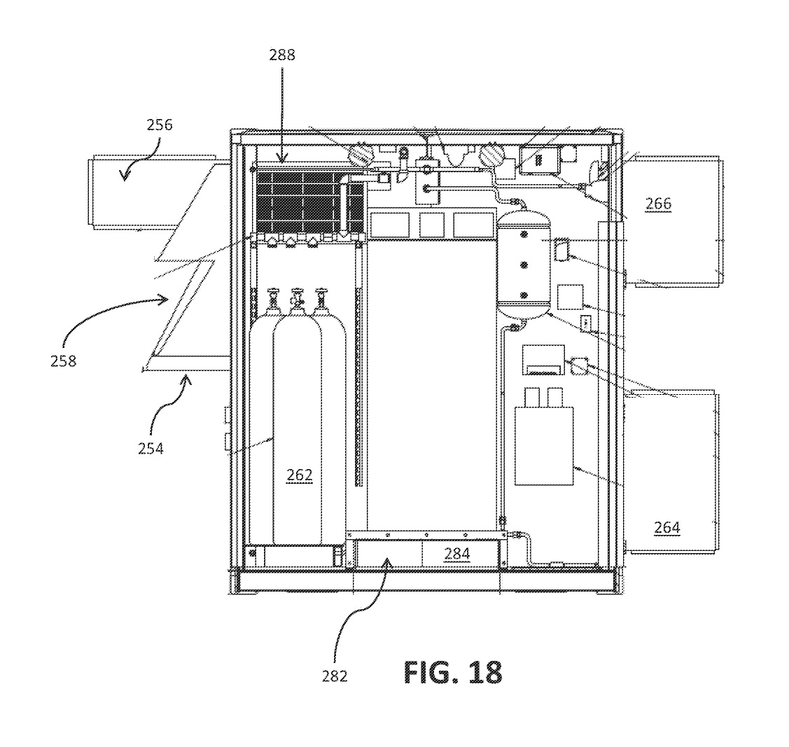

As shown in FIG. 16, in the illustrated embodiment, container 152 includes ten battery groups 280, five on each side of a walkway 282. An operator may walk up and down walkway 282 on an upper surface 286 (see FIG. 17) of walkway 282 between battery groups 280. Referring to FIG. 17, an interior 284 of walkway 282 defines a plenum of air supply conduit 232. Air is forced through interior 284 of walkway 282 and exits through openings in the sides of walkway 282 and the top of walkway 282. The air is returned to second compartment 202 through an air return 288 (see FIG. 18).

Returning to FIG. 17, a pair of rack frames 290 is shown. As explained herein, racks 290 hold the batteries which make up the various battery groups 280. Racks 290 are coupled to bottom wall 250 and one of first side wall 240 and second side wall 246, respectively.

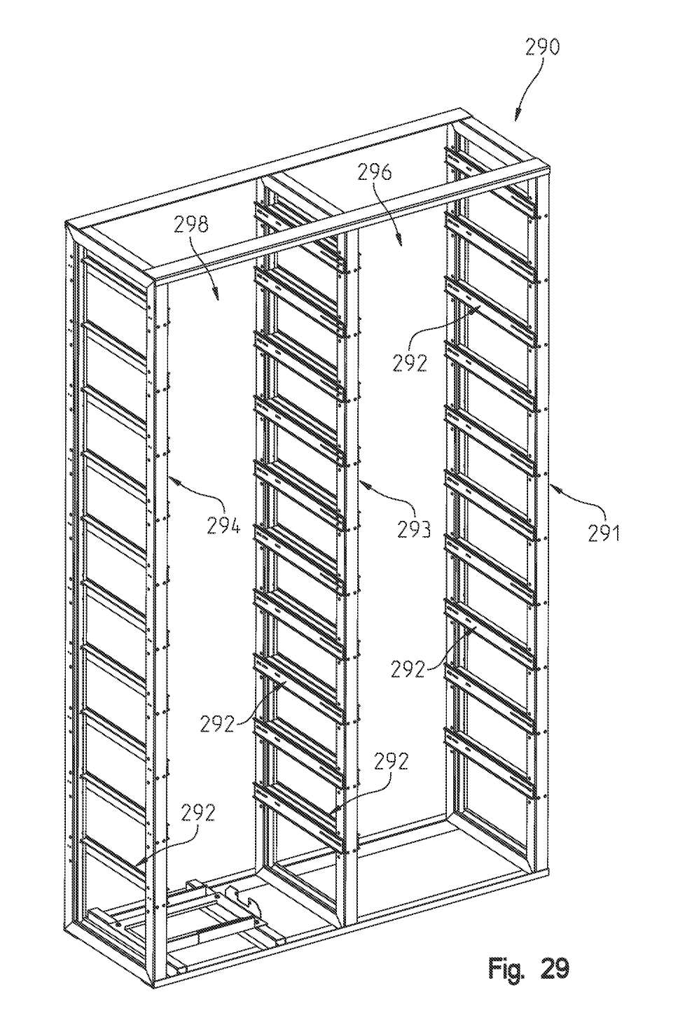

Referring to FIG. 29, an exemplary rack 290 is shown. Rack 290 includes three vertical supports 291, 293, and 294 which are coupled together at their top and bottom. Each of vertical supports 291, 293, and 294 support drawer slides 292. As explained herein, the batteries batteries 112 are supported in energy module drawers 310 which may be inserted into rack 290. The batteries may be arranged in battery modules 300. The illustrated rack 290 includes a first vertical bank 296 for receiving nine energy module drawers 310 and a low voltage drawer 314 and a second vertical bank for receiving nine energy module drawers 310 and a high voltage drawer 312.

Referring to FIG. 32, a representation of a battery groups 280 provided in a rack 290 is shown. Battery groups 280 includes three strings or battery sub-groups 320: sub-group 320A including the batteries supported in drawers A1-A6, sub-group 320B including the batteries supported in drawers B1-B6, and sub-group 320C including the batteries supported in drawers C1-C6. Although three strings are illustrated for a battery group 280, more or fewer number of strings may be included.

As explained in more detail herein battery strings 320A-C are connected in parallel to the contactors provided in a high voltage drawer 312 also supported by rack 290. The high voltage drawer 312, as discussed in more detail herein, receives electrical power from the batteries 112 of the battery sub-groups 320 and provides that electrical power to DC distribution box 170. A low voltage drawer 314 is also supported by rack 290. The operation of the components in the low voltage drawer 314 and the high voltage drawer 312 are discussed herein. As explained herein, a controller of energy system 100 communicates with controllers 350 associated with the battery modules 300 in energy module drawers 310 over a wired network. An exemplary network is a CAN network. In one embodiment, the controllers communicate over a wireless network.

As mentioned herein, the batteries 112 of the battery groups 280 are supported within drawers 310 which are received in rack 290. Referring to FIG. 20, an exemplary drawer 310 is shown. In the illustrated embodiment, the batteries 112 are provided in four battery modules 300. In one embodiment, more or fewer battery modules 300 may be included in drawer 310.

Referring to FIG. 20B, an exemplary battery module 300 is shown. Battery module 300 includes a plurality of battery elements 322. Each battery element 322 includes a heat sink member 323 and a plurality of battery cells 324 (see FIG. 20A). Each battery cell includes one or more cathode and anode pairs. In one embodiment, each battery cell includes a plurality of cathode and anode pairs positioned in a sealed pouch with an electrolyte solution provided therein. Terminals for each battery cell 324 are accessible from an exterior of the sealed pouch.

A plurality of battery elements 322 are positioned between a pair of end cap members 325. A plurality of tie rods 326 extend from a first one of the end caps 325 through frames of the battery elements 322 to the other end cap 325. The tie rods 326 may be tightened to increase a compressive force on the battery cells 324. Although tie rods 326 are disclosed other suitable couplers may be used to hold battery elements 322 together.

The battery cells 324 of battery module 300 are electrically coupled together in series. Battery module 300 includes a negative terminal 327 and a positive terminal 328 through which external components may be electrically coupled to the battery cells 324 of battery module 300. Exemplary batteries and battery assemblies are provided in US Published Patent Application No. US20080193830A1, filed Apr. 16, 2008, titled BATTERY ASSEMBLY WITH TEMPERATURE CONTROL DEVICE; US Published Patent Application No. US20080226969A1, filed Mar. 13, 2008, titled BATTERY PACK ASSEMBLY WITH INTEGRATED HEATER; US Published Patent Application No. US20080299448A1, filed Nov. 2, 2007, titled BATTERY UNIT WITH TEMPERATURE CONTROL DEVICE; and US Published Patent Application No. US20100273042A1, filed Mar. 13, 2008, titled BATTERY ASSEMBLY WITH TEMPERATURE CONTROL DEVICE, the disclosures of which are expressly incorporated by reference herein in their entirety.

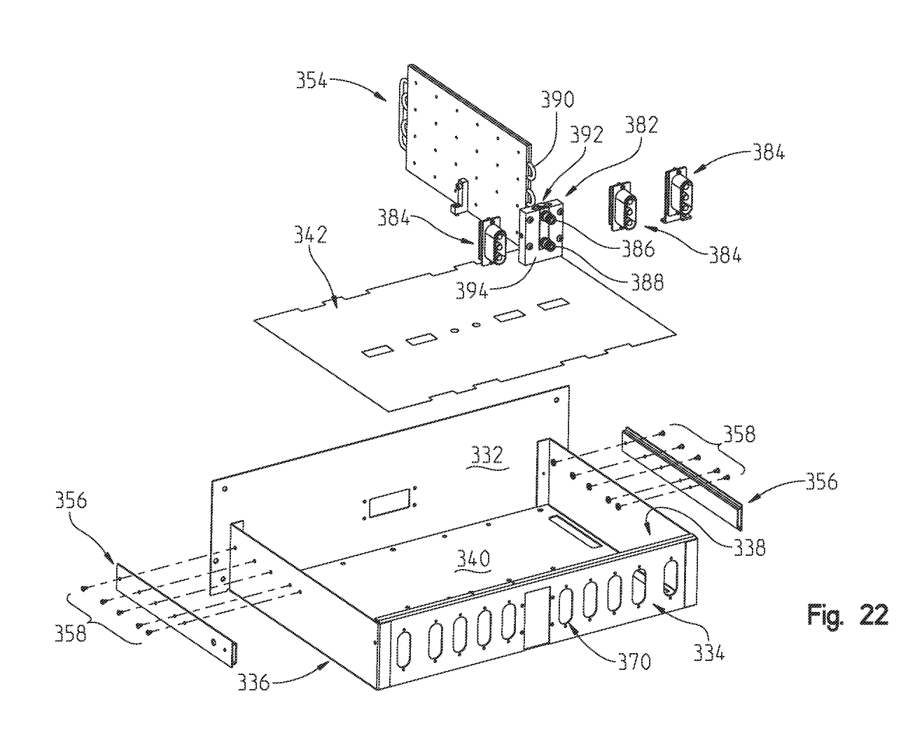

Referring to FIG. 22, drawer 310 includes a drawer base 330 having a front wall 332, a back wall 334, a first side wall 336, a second side wall 338, and a bottom wall 340. Drawer base 330 is coated in an insulating material. In one embodiment, the insulating material is the PLASCOT brand material available from Blinex Filter Coat PVT LTD located in Mumbai, India. Other suitable insulating materials may be used. Further, an insulating sheet 342 is disposed on top of bottom wall 340. Insulating sheet 342 provides a second layer of insulation between the battery modules 300 and bottom wall 340 of drawer base 330. In one embodiment, insulating sheet 342 is made of a different insulating material than the insulating material used to coat drawer base 330. In one example, insulating sheet 342 is made of a polypropylene sheet, such as FORMEX brand material available from ITW Formex located at 1701 W. Armitage Court in Addison, Ill. 60101.

Insulating sheet 342 includes a plurality of cutouts and recesses which accommodate fasteners to pass through insulating sheet 342 and couple battery modules 300 or a cold plate 354 to bottom wall 340 of drawer base 330. Cold plate 354 corresponds to the cold plate 228 of battery temperature control system 204.

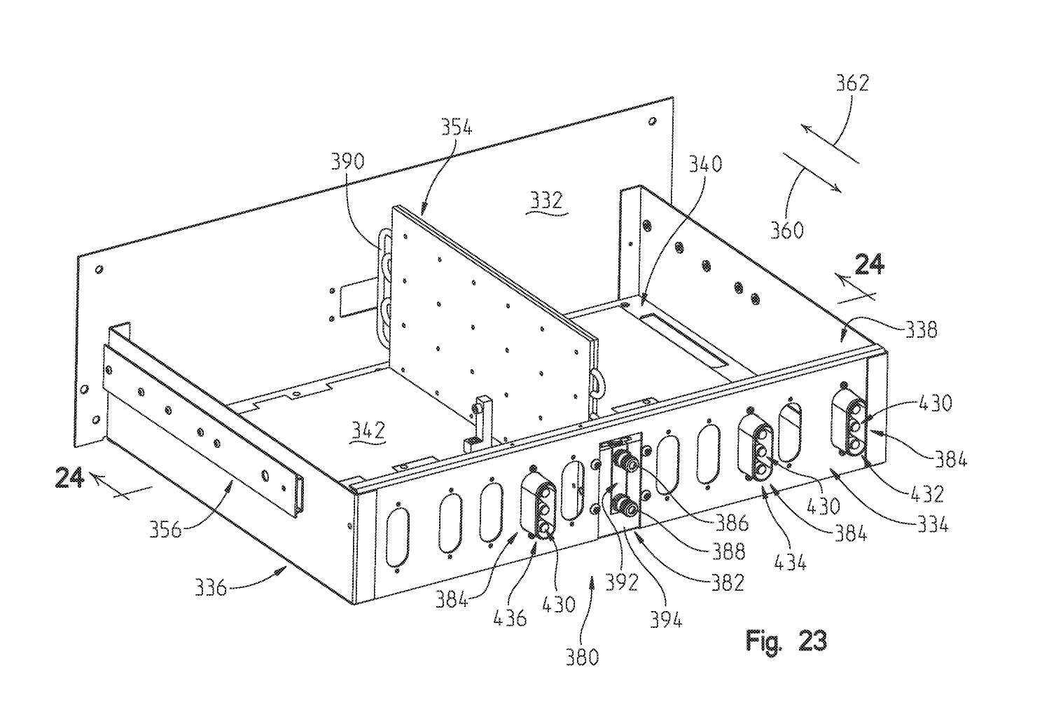

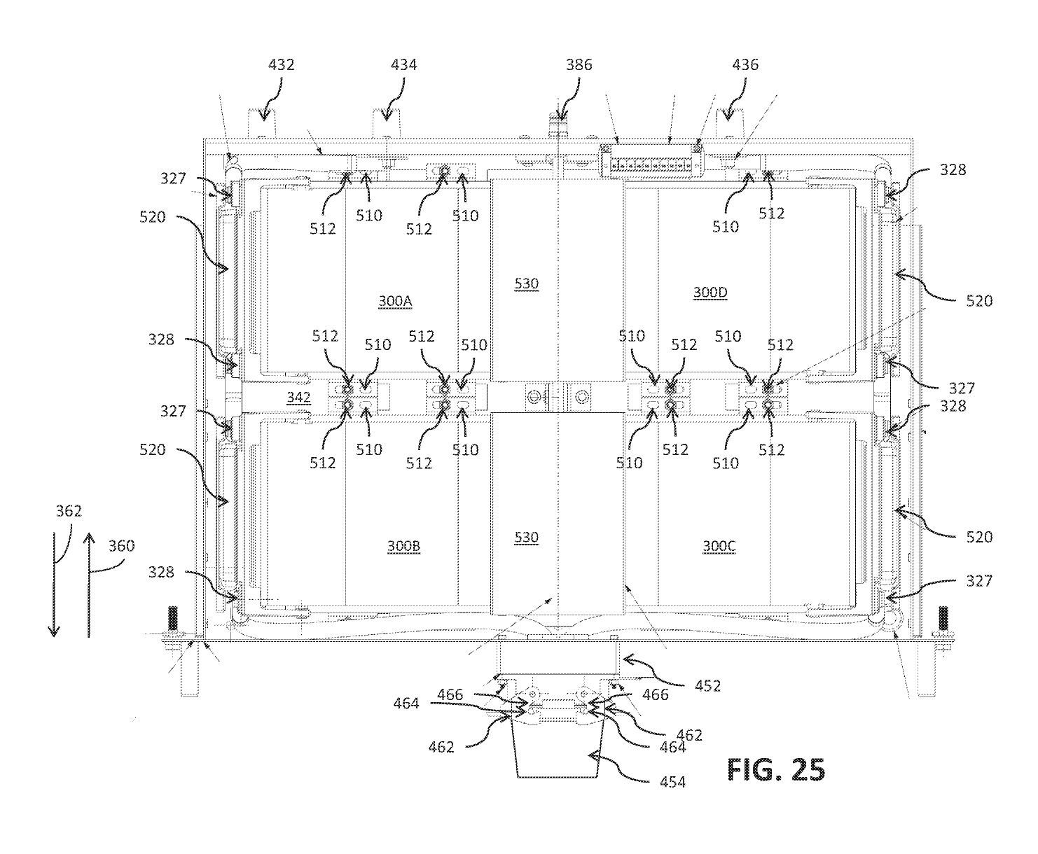

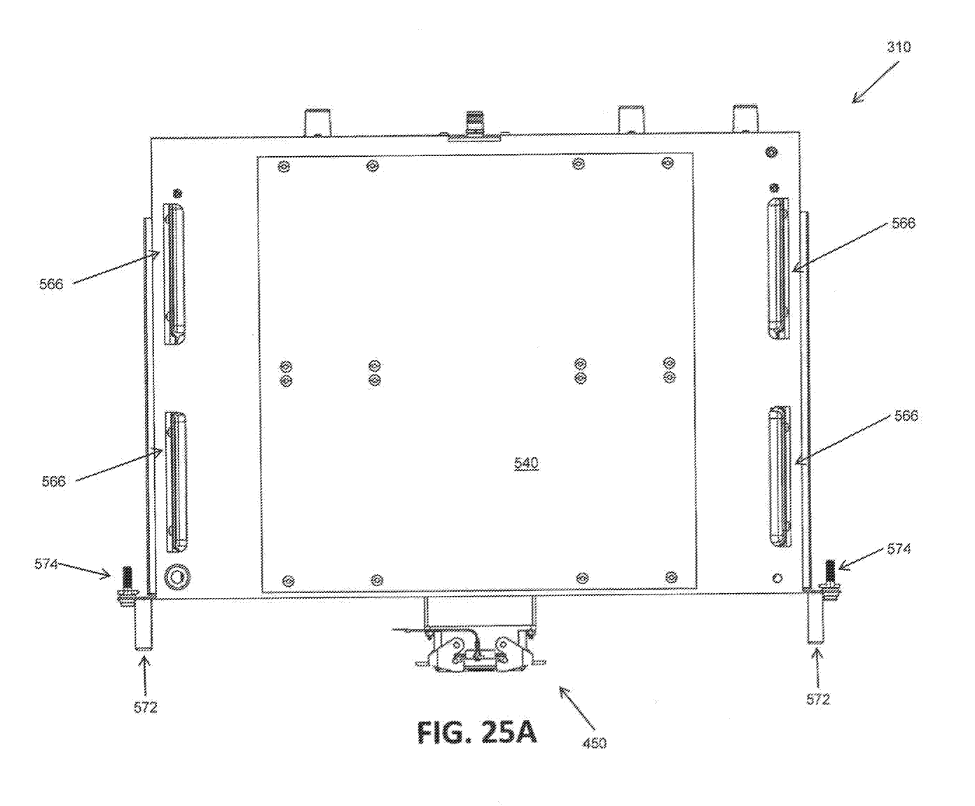

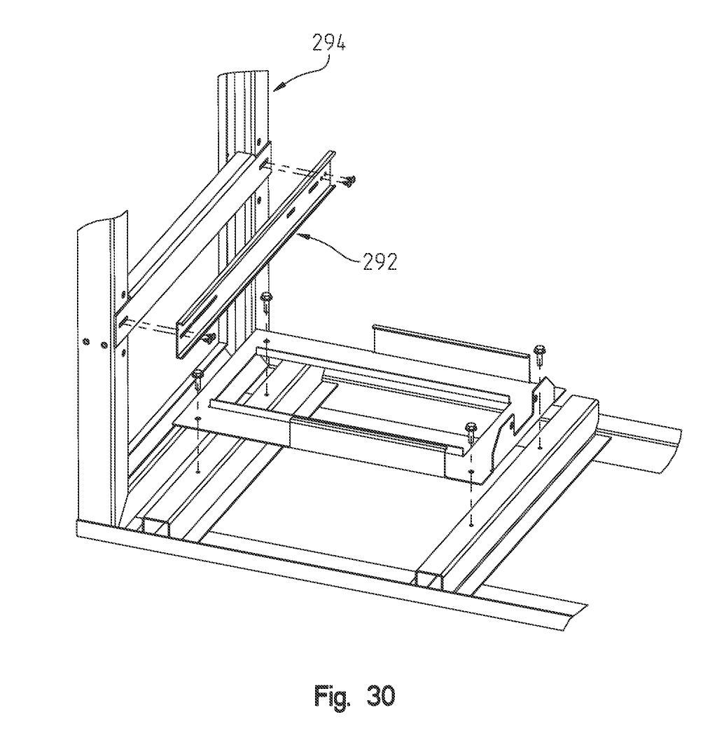

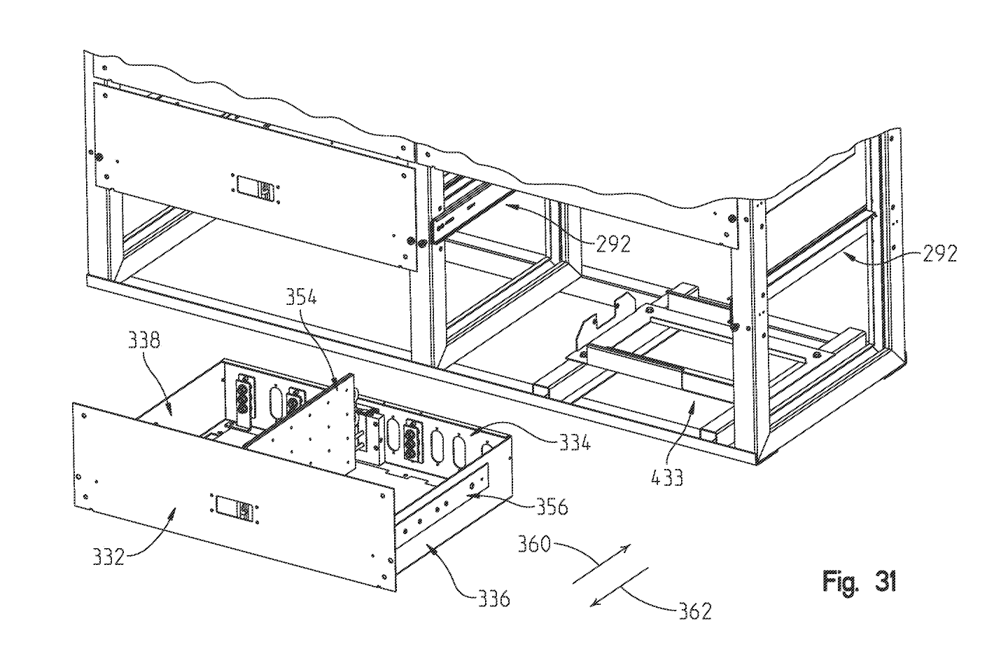

Each of first side wall 336 and second side wall 338 includes apertures to mount a respective drawer rail 356 thereto with fasteners 358 as illustrated in FIGS. 23 and 25. The drawer rails 356 cooperate with corresponding rails 292 (see FIGS. 29 and 30) on rack 290 to couple drawer 310 relative to rack 290. As illustrated in FIG. 31, drawer rail 356 of drawer 310 and drawer slides 292 of rack 290 cooperate to slidably couple drawer 310 relative to rack 290. Drawer 310 is movable in direction 360 and direction 362 relative to rack 290. Drawer rail 356 and drawer slides 292 are selected to support the weight of drawer 310. In one embodiment, drawer 310 with battery modules 300 included weighs about 170 pounds. In one embodiment, drawer rail 356 and drawer slides 292 are steel bearing slides available from General Devices located at 1410 S. Post Rd. in Indianapolis, Ind. 46239. Other suitable couplers may be used to slidably couple drawer 310 to rack 290.

Returning to FIG. 22, back wall 334 includes a plurality of openings 370. Each opening 370 is positioned to accommodate an interface module 372 of a drawer interface 374 of drawer 310 (see FIG. 20C). Interface modules 372 cooperate with rack interface modules 376 of a rack interface 378 of rack 290 to couple one or more components of drawer 310 with one or more components of rack 290 or other components of energy system 100 (see FIG. 20D). As drawer 310 is being slide in direction 360, interface modules 372 of drawer interface 374 couple with corresponding rack interface modules 376 of rack interface 378 to operatively couple drawer 310 with one or more components of rack 290 or other components of energy system 100. Exemplary interface modules 372 and interface modules 376 include electrical connectors, fluid connectors, communication connectors, and other suitable types of connectors. As drawer 310 is being slid in direction 362, interface modules 372 of drawer interface 374 uncouple from corresponding rack interface modules 376 of rack interface 378 to operatively uncouple drawer 310 from one or more components of rack 290 or other components of energy system 100.

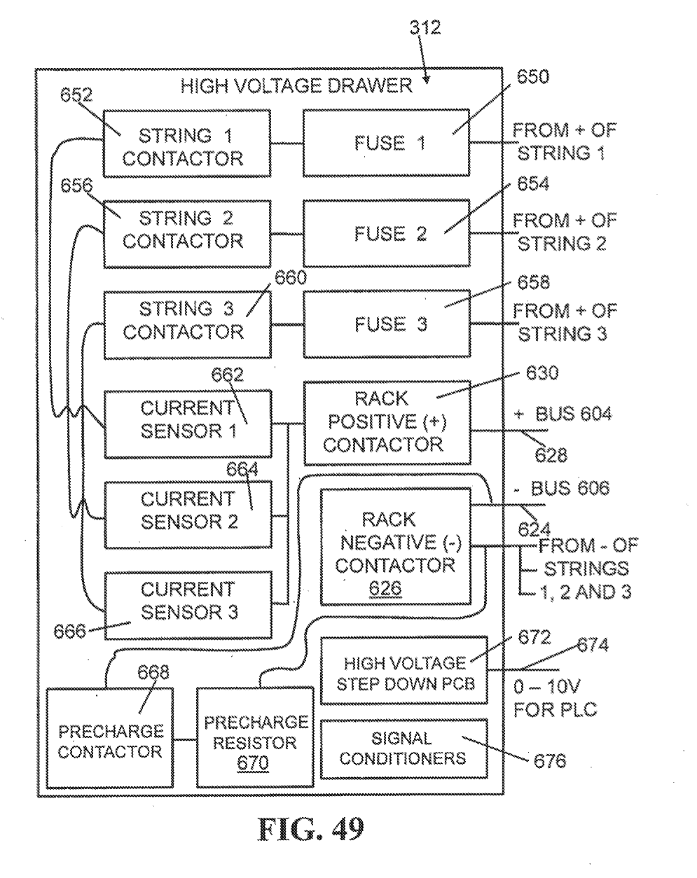

A general drawer interface 374 and rack interface 378 are represented in FIGS. 20C and 20D. Referring to FIGS. 22 and 23, an exemplary drawer interface 380 is shown for drawer 310. An exemplary drawer interface is shown for drawer 312 in FIG. 49. Drawer base 330 is used as the base drawer for each of drawer 310, high voltage drawer 312, and low voltage drawer 314. As such, additional openings 370 may be provided in drawer base 330 that are not utilized by each of drawer 310, high voltage drawer 312, and low voltage drawer 314. Referring to FIG. 23, seven openings 370 are left unused for drawer 310.

Referring to FIGS. 22 and 23, drawer interface 380 of drawer 310 includes four interface modules, a fluid connection interface module 382 and a plurality of electrical connection interface modules 384. In one embodiment, a communication interface module is also included.

By locating the interface modules of drawer interface 380 rearward of the front wall 332 of drawer 310, an operator will not contact the interface modules of drawer interface 380 as drawer interface 380 is being brought into engagement with rack interface 400. The operator will be grasping handles 572 to move drawer 310 in direction 360. In a like manner, the operator will not contact the interface modules of drawer interface 380 as drawer interface 380 is being disengaged from rack interface 400. The operator will be grasping handles 572 to move drawer 310 in direction 362.

Fluid connection interface module 382 includes a first fluid port 386 and a second fluid port 388 which are in fluid communication with opposite ends of a fluid conduit 390 which is passing through cold plate 354. The relative position of first fluid port 386 and second fluid port 388 is maintained by a base member 392. Base member 392 is received in a holder 394 which positions first fluid port 386 and second fluid port 388 relative to back wall 334 of drawer 310. Base member 392 is received in a recess of a holder 394. Base member 392 and holder 394 including cooperating features to restrict the movement of base member 392 relative to holder 394 in direction 360 and direction 362. Holder 394 is coupled to back wall 334 with a plurality of fasteners. In one embodiment, holder 394 is made of an insulating material to separate base member 392 and the drawer base 330.

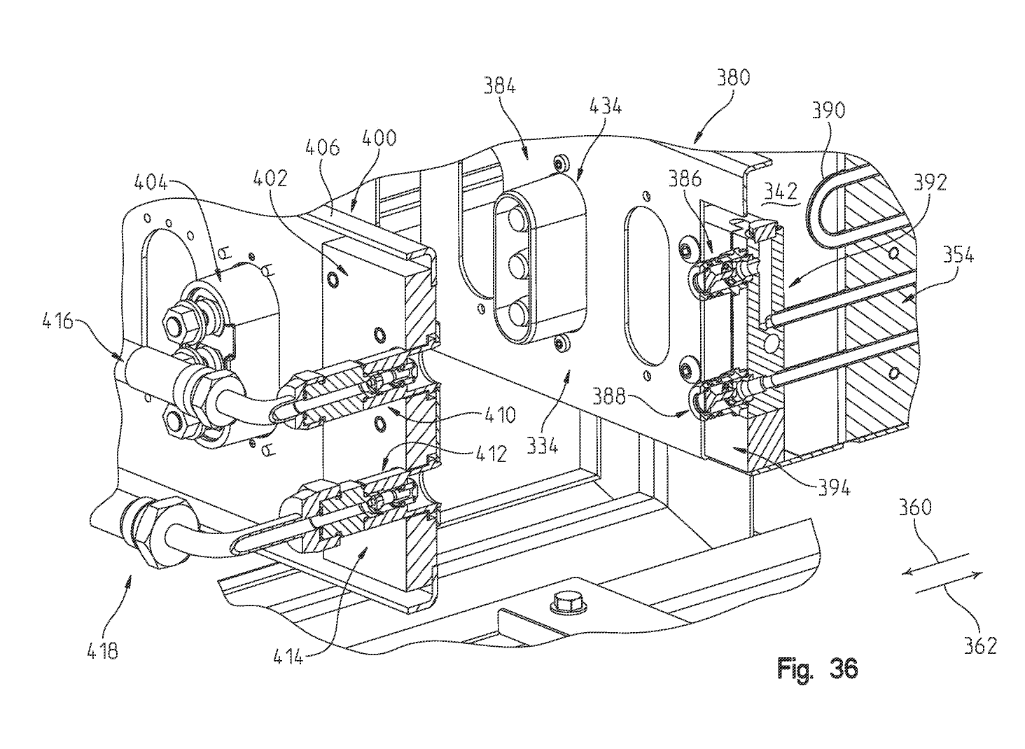

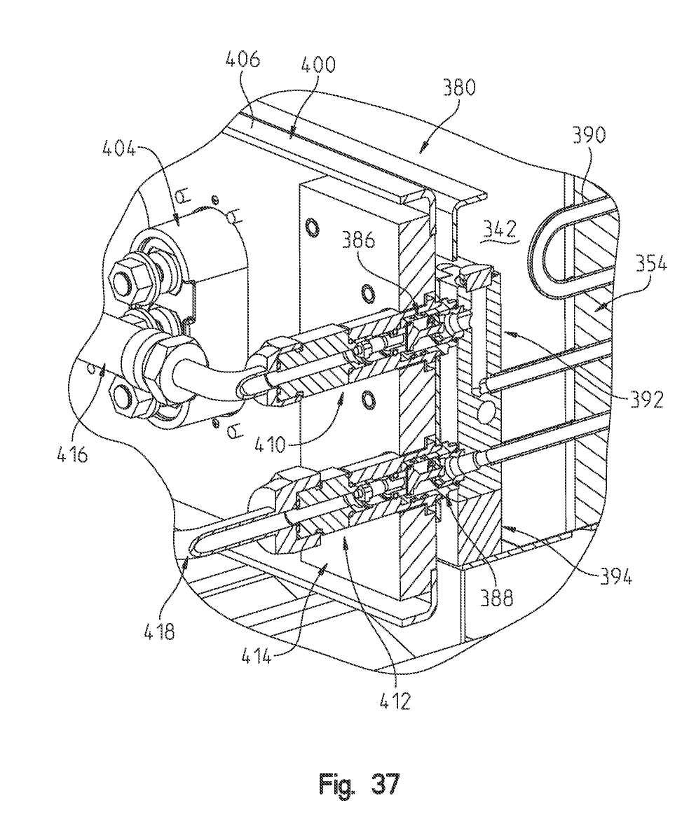

Referring to FIG. 36, rack 290 includes a rack interface 400 which also includes four interface modules, a fluid connection interface module 402 and three electrical connection interface modules 404 (one shown). In one embodiment, the rack interface 400 includes a communication interface to interact with a communication interface provided as part of drawer interface 380. The fluid connection interface module 402 and electrical connection interface modules 404 are supported by a bracket 406 which spans between adjacent vertical support 291 and vertical support 293 or vertical support 293 and vertical support 294. Bracket 406, like back back wall 334 of drawer base 330, includes a plurality of openings to which fluid connection interface module 402 and electrical connection interface modules 404 may be positioned relative thereto. Regarding fluid connection interface module 402, a first fluid port 410 and a second fluid port 412 are provided. Fluid ports 410 and 412 are positioned by a holder 414 to align with with first fluid port 386 and second fluid port 388, respectively, when drawer 310 is moved in direction 360 relative to rack 290. Each of first fluid port 386, second fluid port 388, first fluid port 410, and second fluid port 412 include a valve unit which is in a closed configuration when drawer interface 380 is spaced apart from rack interface 400 and in an open configuration when drawer 310 has been moved in direction 360 to engage drawer interface 380 with rack interface 400. When the valves are in an open configuration fluid may flow between fluid lines 416 and 418 connected to first fluid port 410 and second fluid port 412, respectively, through fluid conduit 390 connected to first fluid port 386 and second fluid port 388.

In one embodiment, fluid connection interface module 402 and fluid connection interface module 382 are moved closer to a side of the respective rack interface 400 and drawer interface 380. Fluid lines are run from this non-centered location of the fluid connection interface module 382 to cold plate 354.

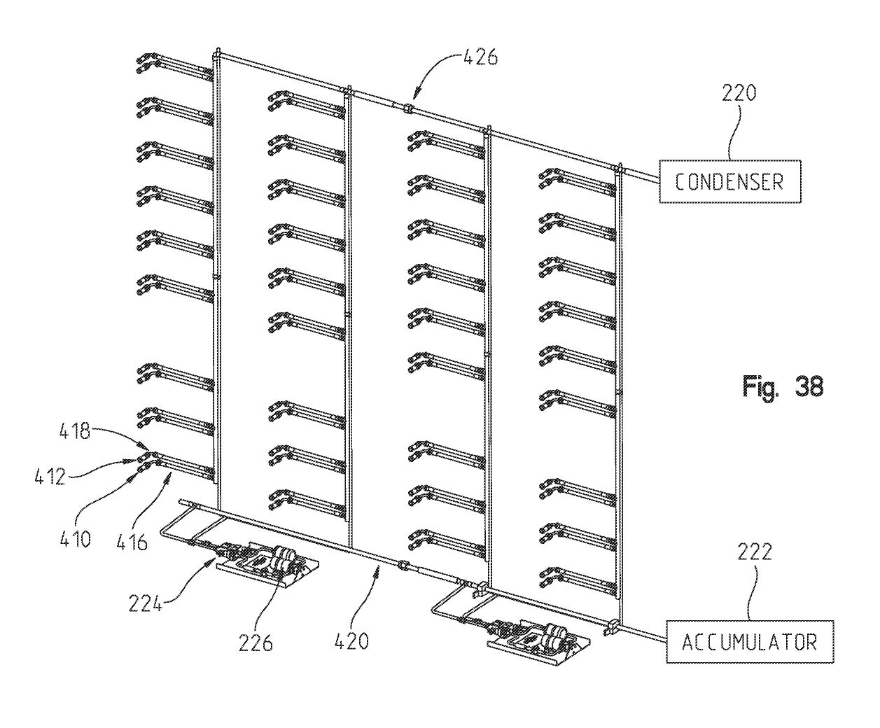

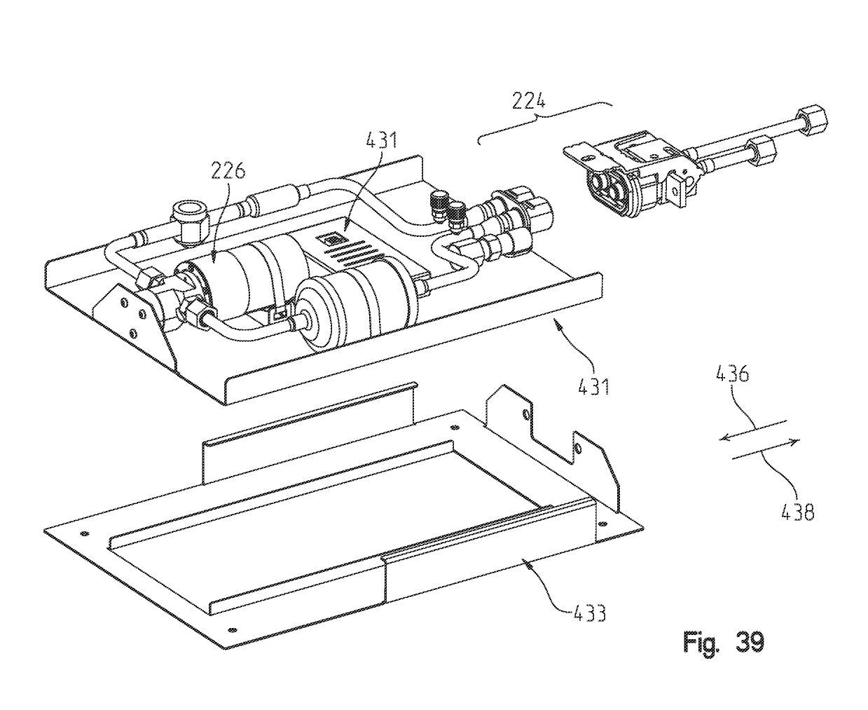

Referring to FIG. 38, fluid line 416 and fluid line 418 for a given drawer location are marked. Fluid line 416 and fluid line 418 are in fluid communication with condenser unit 220 and accumulator 222 respectively. As shown in FIG. 38, accumulator 222 is in fluid communication with a feed line 420 which spans multiple racks 290. In one embodiment, accumulator 222 is coupled to feed lines 420 provided on both sides of walkway 282 and feeds cooling fluid to all ten racks 290 provided in energy module 110. Each rack 290 includes a pump 226 which receives the cooling fluid through a manifold 224 which is in fluid communication with feed line 420. Pump 226 pumps the cooling fluid up through a feed line 422 to line 418. The cooling fluid passes through holder 414 and into fluid conduit 390 of cold plate 354. The fluid within cold plate 354 takes on heat from battery modules 300 and exits rack rack 290 and passes through first fluid port 410 and fluid line 416. The heated fluid is returned to condenser unit 220 through return conduits 424 and 426. Referring to FIG. 39, the operation of pump 226 is controlled by a pump controller 431. In one embodiment, pump 226 is activated based on a measured temperature associated with one or more of the battery modules 300 and the interior of container 200.

Pump 226 is mounted on a sled 431. Sled 431 is coupled to a support 433 which holds sled 431, but permits sled 431 to slide relative to support 433 in direction 437 and direction 438. Each pump 226 provides cooling fluid to one rack 290 of battery modules 300.

Returning to FIGS. 22 and 23, electrical connection interface modules 384 are coupled to back wall 334 with fasteners. Each of electrical connection interface modules 384 includes a plurality of contacts 430 which are electrically coupled to one or more components of drawer 310. Further, each of the electrical connection interface modules are spaced apart from back wall 334 with an insulating material to electrically isolate the modules 384 from back wall 334. In one embodiment, a single contact 430 is provided for the electrical interface modules. In one embodiment, multiple contacts 430 are provided for the electrical interface modules.

A first electrical connection interface module 432 couples with a mating interface module of rack interface 378 which is in turn coupled to a ground bar. The ground bar is grounded. First electrical connection interface module 432 is coupled to the metallic drawer base 330 within drawer 310 through a wire connected to a screw which is screwed into drawer base 330 resulting in drawer 310 being grounded. Further, a second ground wire extends from first electrical connection interface module 432 to a circuit interrupter 450 coupled to the front 332 of drawer 310 to ground the circuit interrupter 450. This provides a grounded front face of drawers 310.

A second electrical connection interface module 434 couples with a mating interface module of rack interface 378 which is in turn coupled to the other rack interface components of the respective string to connect the drawers of the string together. In one embodiment, the drawers of the string are connected together in series. The string is coupled to the high voltage drawer which is connected to a negative buss bar of rack 290. As explained herein, the negative buss bar is coupled to DC distribution box 170. Second electrical connection interface module 432 is coupled to a negative terminal of the plurality of battery modules 300 within drawer 310.

A third electrical connection interface module 436 couples with a mating interface module of rack interface 378 which is in turn coupled to the other rack interface components of the respective string to connect the drawers of the string together. In one embodiment, the drawers of the string are connected together in series. The string is coupled to the high voltage drawer which is connected to a positive buss bar of rack 290. As explained herein, the positive buss bar is coupled to DC distribution box 170. Third electrical connection interface module 432 is coupled to a positive terminal of the plurality of battery modules 300 within drawer 310.

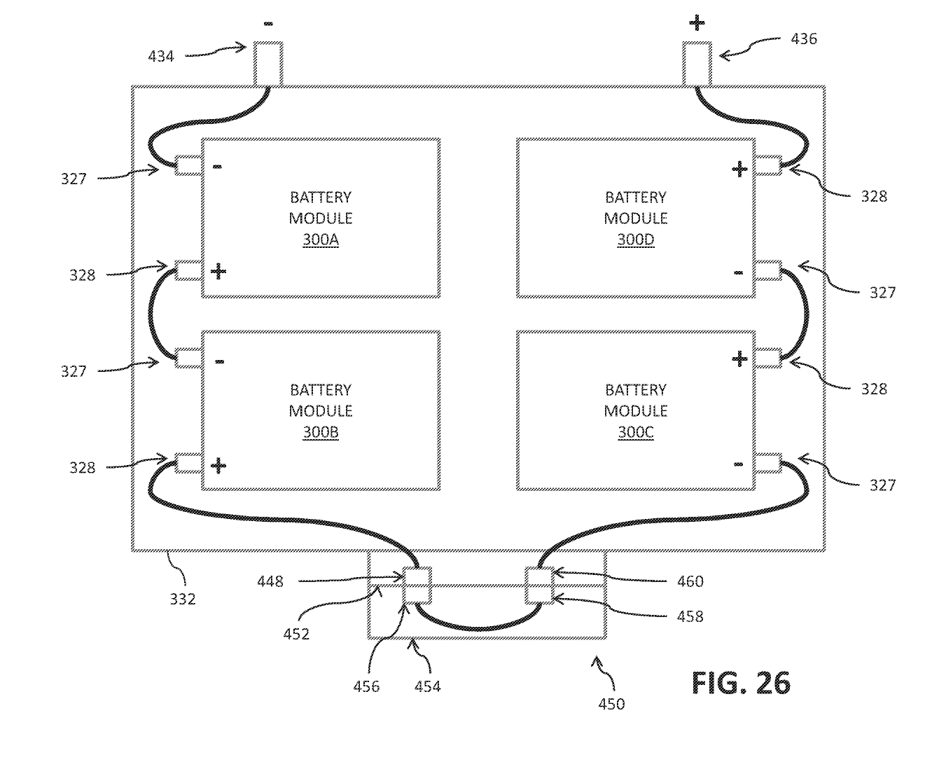

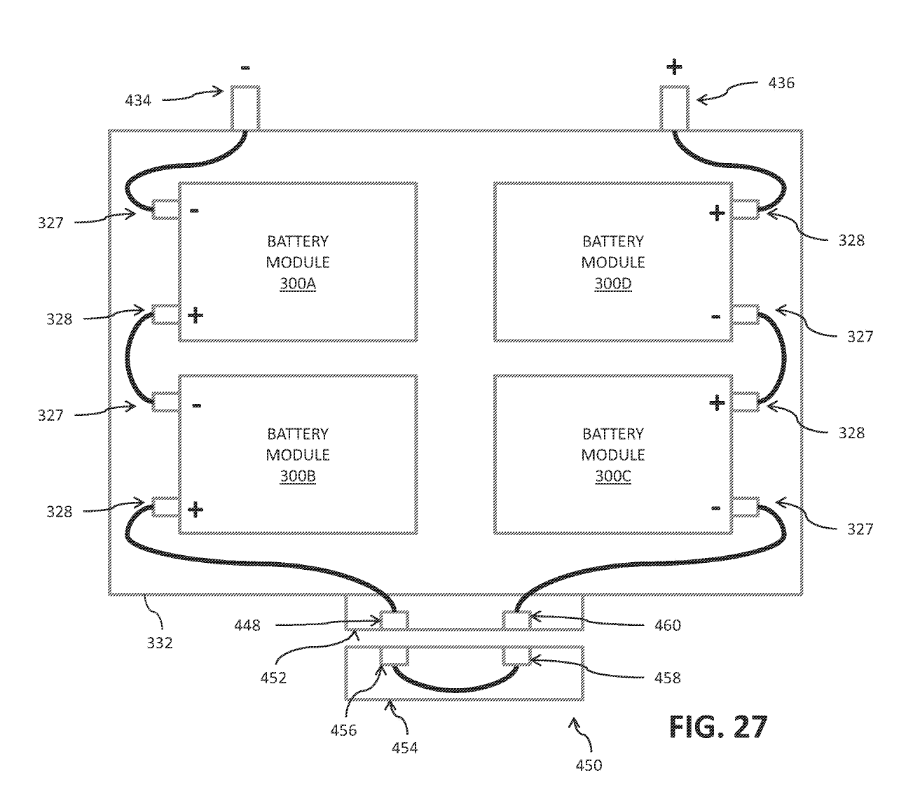

Referring to FIGS. 26 and 27, the plurality of battery modules 300 are coupled to second electrical connection interface module 432 and third electrical connection interface module 432 in series. Second electrical connection interface module 432 connects to a negative terminal 327 of battery module 300A. A positive terminal 328 of battery module 300A is coupled to a negative terminal 327 of battery module 300B. A positive terminal 328 of battery module 300B is coupled to a terminal 448 of a circuit interrupt 450. In a similar manner, third electrical connection interface module 432 couples to a positive terminal 328 of battery module 300D. Negative terminal 327 of battery module 300D is coupled to a positive terminal 328 of battery module 300C. Negative terminal 327 of battery module 300C is coupled to a terminal 460 of circuit interrupter 450.

Circuit interrupter 450 includes a first portion 452 which is coupled to front wall 332 of drawer 310 and a second portion 454. Second portion 454 is moveable relative to first portion 452. When second portion 454 is coupled to first portion 452, terminals 456 and 458 of second portion 454 are in contact with terminals 448 and 460 of first portion 452, respectively (see FIG. 26), and battery modules 300A-D are connected together in series. When second portion 454 is uncoupled from first portion 452, terminals 456 and 458 of second portion 454 are spaced apart from terminals 448 and 460 of first portion 452, respectively (see FIG. 27), and battery modules 300A-D are no longer connected in series. This provides a visual indication to the operator of whether the battery modules 300A-D are connected in series or not. Other exemplary visual indicators may be provided.

Referring to FIG. 25, an exemplary circuit interrupter 450 is illustrated. First portion 452 and second portion 454 are held coupled together by a pair of rotatable arms 462 which are rotatably coupled to first portion 452. Pins 464 on the top and bottom of second portion 454 are received by recesses 466 of rotatable arms 462 to couple second portion 454 to first portion 452. To uncouple second portion 454 from first portion 452, rotatable arms 462 are rotated outward so that second portion 454 may be moved in direction 362. An exemplary circuit interrupter 450 may be assembled from components from Harting Inc of North America located at 1370 Bowes Road in Elgin, Ill. 60123. An exemplary first portion 452 may include a HAN 200A module female (#09 14 001 2763) and a HAN 200A module male (#09 14 001 2663) which are coupled to battery modules 300B and 300C through cables. The male and female modules may be held in a frame member (#09 14 016 0303) which in turn is held in a bulkhead (#09 14 016 0801) which includes arms 462. An exemplary second portion 454 may include a HAN 200A module female (#09 14 001 2763) and a HAN 200A module male (#09 14 001 2663) which will mate with the modules of first portion 452. These modules may be held in a hood (#09 30 016 0801) which includes pins 464. Other exemplary circuit interrupter 450, include manually actuated switches, electrically actuated switches, and other suitable devices.

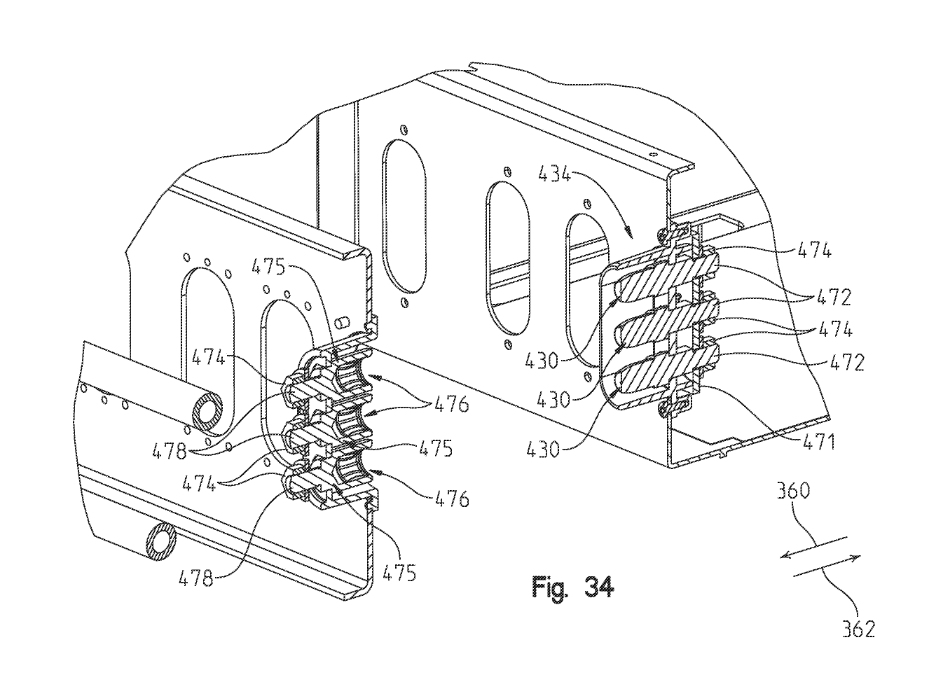

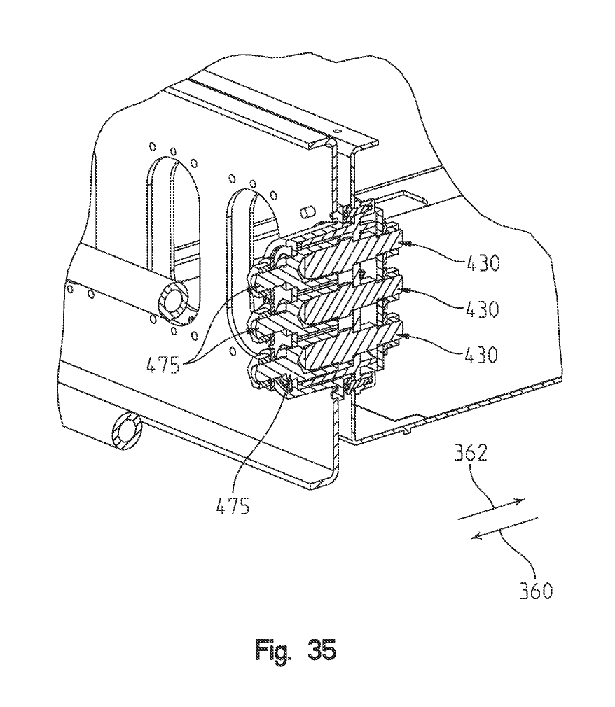

With second portion 454 coupled to first portion 452 and drawer 310 slid into rack 290 such that drawer interface 374 is interfacing with rack interface 378 of rack 290, battery modules 300A-D are coupled to the remaining drawers 310 in the respective string 320 and thereby to high voltage drawer 312. Referring to FIGS. 34 and 35, second electrical connection interface module 434 includes a shroud 470 in which connectors 430 are provided. Connectors 430 are coupled to battery module 300A by attaching a battery cable connector plate 471 to a first end portion 474 of connectors 430. The first end portion is threaded and includes nuts 474 to hold the battery cable relative to connectors 430.

Rack interface 400 includes an electrical connection interface modules 404 having connectors 475 with recesses 476 which receive and contact connectors 430 of second electrical connection interface module 434. A battery cable connector plate (not shown) is coupled to a second end portion 478 of connectors 475. The second end portion 478 is threaded and includes nuts 474 to hold the battery cable connector plate relative to connectors 475. Referring to FIG. 34, connectors 430 are shown spaced apart from connectors 475. Referring to FIG. 35, connectors 430 are shown engaged with connectors 475 due to drawer 310 being moved in direction 360.

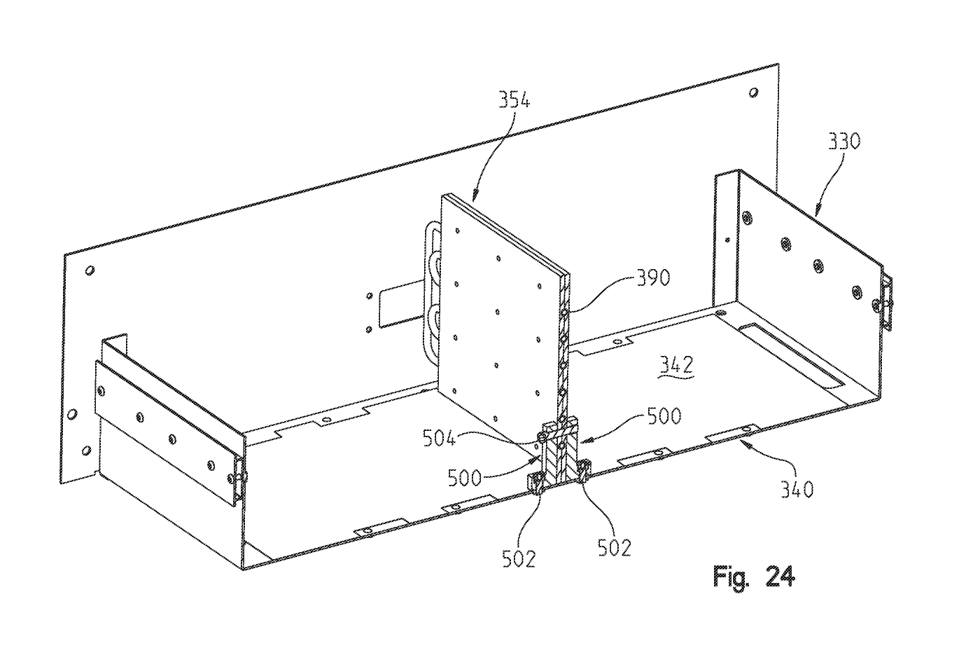

In one embodiment, drawer 310 is assembled as follows. Insulating sheet 342 is positioned in an empty drawer base 330. Cold plate 354 is coupled to bottom wall 340 of drawer base 330. Referring to FIG. 24, a pair of L-shaped brackets 500 are coupled to cold plate 354 and bottom wall 340. In one embodiment, the L-shaped brackets 500 are made of an insulating material. Fasteners 502 couple brackets 500 to bottom wall 340. A fastener 504 couples cold plate 354 to L-shaped brackets 500. In the illustrated embodiment, fastener 504 passes through an opening in cold plate 354. In one embodiment, cold plate 354 is not rigidity coupled to drawer base 330. Rather, cold plate 354 is held by compression between battery modules 300. If not already coupled to drawer base 330, fluid connection interface module 382, first electrical connection interface module 432, second electrical connection interface module 434, and third electrical connection interface module 436 are coupled to drawer base 330. Further, circuit interrupter 450 is coupled to drawer base 330 and drawer rails 356 are coupled to drawer base 330. A wire connects circuit interrupter 450 and first electrical connection interface module 432 to ground circuit interrupter 450 and provide a grounded front face of drawers 310. A second wire connects a metallic portion of drawer base 330 and first electrical connection interface module 432 to ground drawer base 330.

Battery modules 300 are secured to bottom wall 340 of drawer base 330 through a plurality of brackets 510 and associated fasteners 512. Fasteners 512 couple battery modules 300 to drawer base 330. In one embodiment, brackets 510 are made of an insulating material. Brackets 510 include elongated openings so that battery modules 300 may be assembled to drawer base 330, pressed against cold plate 354 to improve the contact surface between heat sink member 323 of battery modules 300 and cold plate 354, and then tightened into place. In one embodiment, a heat conductive flexible member (not shown) is positioned between heat sink member 323 of battery modules 300 and cold plate 354 to assist in improving heat transfer from heat sink member 323 to the fluid flowing through rack 290 of cold plate 354. In one embodiment, the heat conductive flexible member is an electrical insulator to prevent the conduction of electrical energy from heat sink members 323 to cold plate 354. An exemplary heat conductive flexible member is a thermally conductive acrylic material (5589H) available from 3M located at the 3M Center in St. Paul, Minn. In one embodiment, an external clamp is applied to the battery modules to hold them against cold plate 354. The clamp may be removed when the fasteners 512 are tightened.

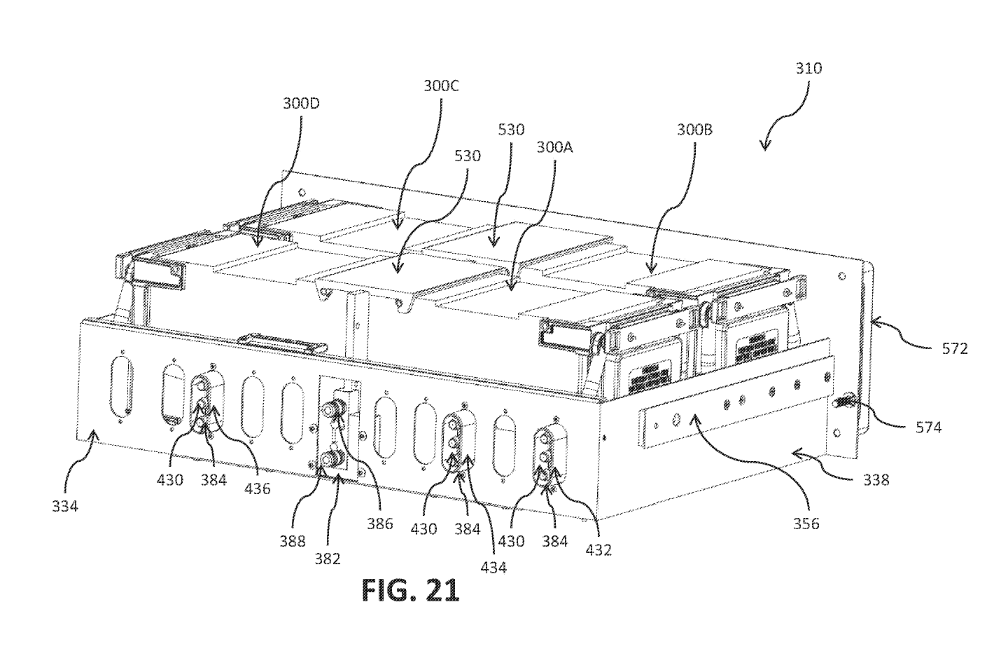

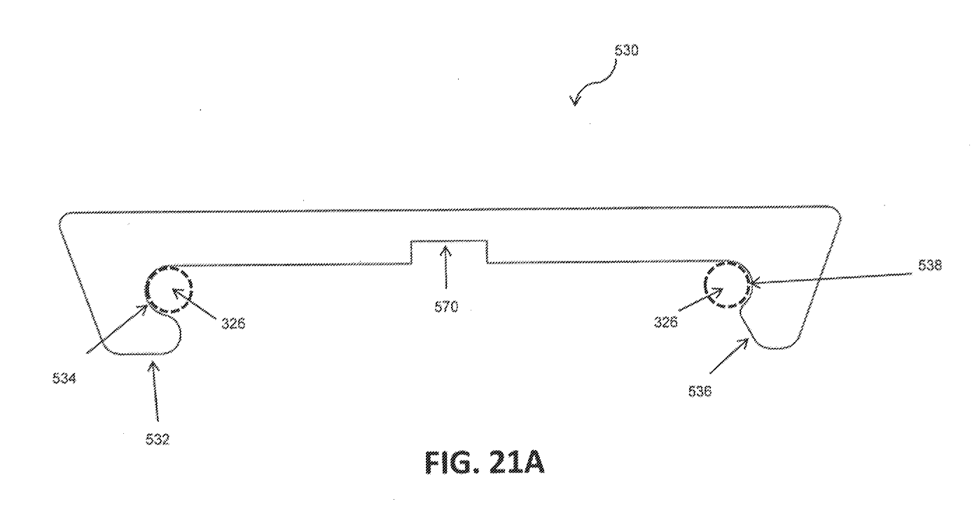

Referring to FIG. 21, a tensioning member 530 is placed over cold plate 354 and is coupled to battery module 300A and battery module 300D. The tensioning member 530 assists in holding an upper portion of the heat sink members 323 of battery module 300A and battery module 300D in contact with cold plate 354 to improve the cooling of battery module 300A and battery module 300D.

Referring to FIG. 21A, tensioning member 530 includes a first extension 532 having a recess 534 to receive a tie rods 326 of battery module 300A. Tensioning member 530 further includes a second extension 536 having a recess 538 receive a tie rods 326 of battery module 300D. Once assembled to tie rods 326 of battery module 300A and tie rods 326 of battery module 300D, tensioning member 530 holds heat sink members 323 of the respective battery module 300A and battery module 300D in thermal contact with cold plate 354. Tensioning member 530 includes first extension 532 and second extension 536 on both ends of tensioning member 530.

Returning to FIG. 21A, tensioning member 530 further includes a recess 570 which receives cold plate 354 relative to battery module 300A and battery module 300D. Recess 570 allows a taller cold plate 354 to be utilized. Further, in one embodiment, recess 570 locates cold plate 354 relative to battery module 300A and battery module 300D. Another tensioning member 530 couples battery module 300B and battery module 300C together. Tensioning member 530 further increases the structurally rigidity of drawer 310. In one embodiment, a stiffening plate is 540 is coupled to bottom wall 340 of drawer base 330 to increase the structural rigidity of drawer 310. In one embodiment, stiffening plate 540 is coupled to bottom wall 340 through the fasteners used to couple one or both of cold plate 354 and battery modules 300 to drawer base 330.

In one embodiment, more than one cold plate is provided to remove heat from the battery modules 300 in drawer 310. In one example, cold plate 354 is positioned as illustrated in in FIG. 21 between the battery modules 300 and at least one additional cold plate is positioned adjacent the terminals 327 and 328 of one or more of battery modules 300. In one example, cold cold plate 354 is positioned as illustrated in FIG. 21 between the battery modules 300 and a first additional cold plate is positioned adjacent the terminals 327 and 328 of battery modules 300A and 300B and a second additional cold plate is positioned adjacent the terminals 327 and 328 of battery modules 300C and 300D. In other examples, a cold plate may be positioned between the battery modules 300 and the front wall of drawer 310 or above one or more of the battery modules. In one embodiment, the multiple cold plates are in fluid communication within the boundary of drawer 310. In one embodiment, the multiple cold plates connect independently to the rack and are not in fluid communication within the boundary of drawer 310.

Battery cables are connected to form the series circuit shown in FIG. 27 having the circuit interrupter 450 in an open configuration. A first cable connects second electrical connection interface module 434 to negative terminal 327 of battery module 300A. A second cable connects positive terminal 328 of battery module 300A to negative terminal 327 of battery module 300B. A third cable connects positive terminal 328 of battery module 300B to terminal 448 of circuit interrupter 450. A fourth cable connects terminal 460 of circuit interrupter 450 to negative terminal 327 of battery module 300C. A fifth cable connects positive terminal 328 of battery module 300C to negative terminal 327 of battery module 300D. A sixth cable connects positive terminal 328 of battery module 300D with third electrical connection interface module 436. In one embodiment, the cables are press fit onto the posts of the respective terminals 327 and 328. In one embodiment, the cables are fastened to the posts of the respective terminals 327 and 328. In one example, the cables have clamps which fasten the cable to the respective terminal.

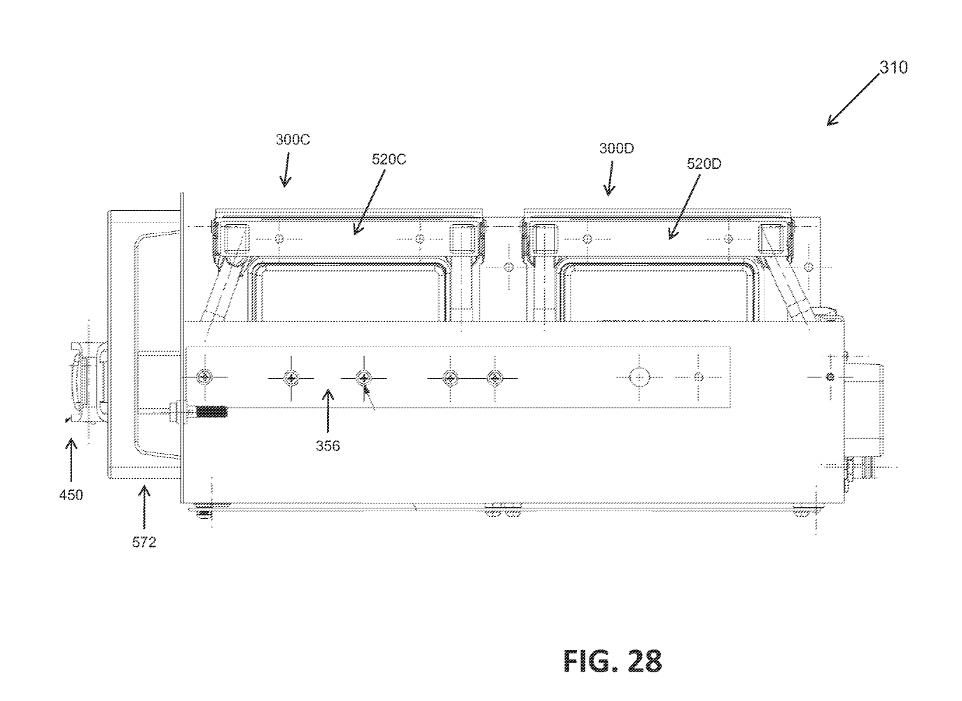

Referring to FIGS. 23 and 28, side walls 336 and 338 and back wall 334 are shorter than front wall 332 of drawer base 330. The reduced height provides additional clearance to attach the battery cables to the respective battery modules 300. In addition, the reduced height provides additional clearance between the battery terminals of battery modules 300 and drawer base 330.

Once the battery cables are attached, a retainer 520 (see FIG. 28) is coupled to the housing of each of battery modules 300 and generally covers the terminals 327 and 328 of the respective battery modules 300. The retainer 520 assists in keeping the respective battery cable from disengaging from the respective battery module terminal.

In one embodiment, the battery modules 300 of drawer 310 and other potentially electrically conductive components have at least about an 8 mm air gap therebetween and at least about a 16 mm offset along surfaces therebetween.

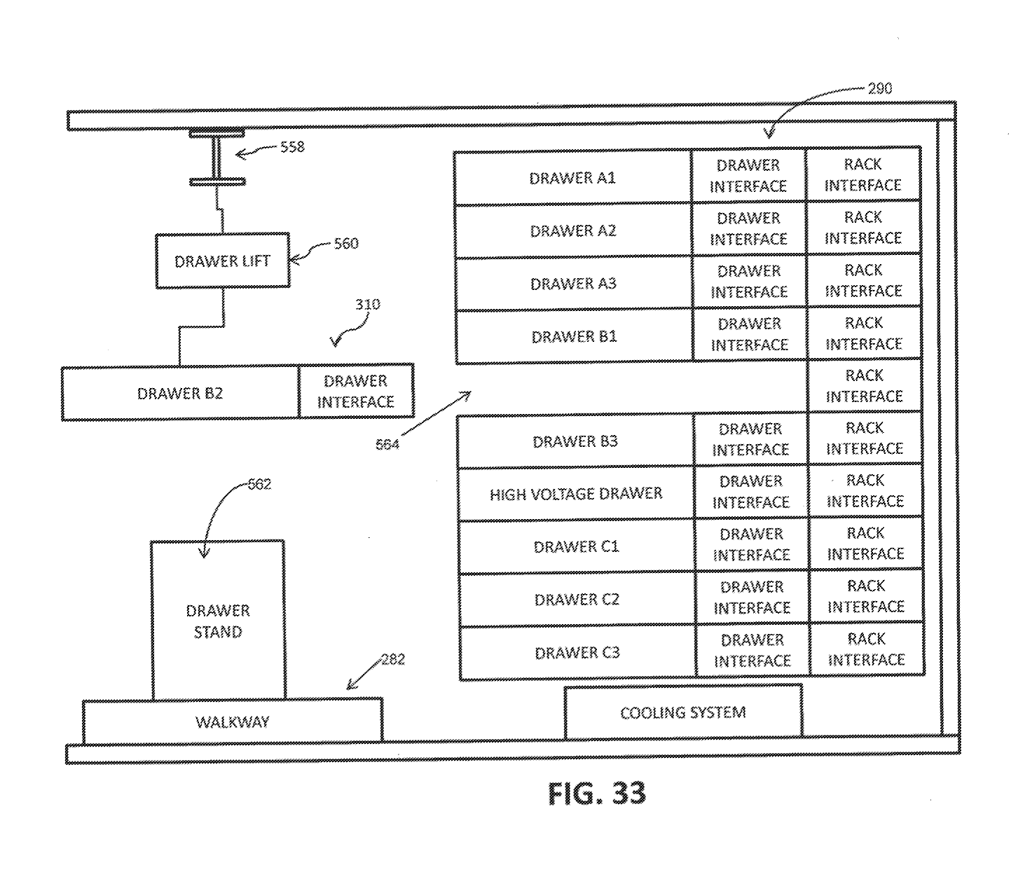

Referring to FIG. 33, an exemplary process for assembling a drawer 310 to rack 290 in energy modules 110 is shown. Drawer 310 is supported from an overhead beam 558 in energy modules 110 with a drawer lift 560. In one embodiment, drawer lift 560 is moveably coupled to overhead beam 558 so that drawer 310 may be easily transported down walkway 282 to the appropriate rack 290. The drawer lift 560 may also include the capability to raise and lower drawer 310 to an appropriate height. Openings 566 are provided in bottom wall 340 of drawer base 330 which may receive hooks associated with drawer lift 560 to couple drawers 310 to drawer lift 560.

In one embodiment, a drawer stand 562 is provided to provide a final alignment of drawer 310 relative to an opening 564 in rack 290. In one embodiment, drawer stand 562 includes a pneumatic or hydraulic system which allows it to raise or lower drawer 310. Once drawer 310 is at the appropriate height, the drawer slides 356 of drawer 310 are aligned with the drawer slides 292 of rack 290 and engaged. Drawer 310 is slid back into rack 290 until drawer interface 380 engages with rack interface 400. At this point, drawer 310 is generally coupled to rack 290 and the remainder of energy modules 110.

Drawer 310 includes handles 572 (see FIG. 20) to assist in moving drawer 310 in one of direction 360 and direction 362. Once drawers 310 has been slid back into rack 290 such that drawer interface 380 engages with rack interface 400, drawer 310 is secured to rack 290. In one embodiment, drawer 310 is secured with fasteners 574 which press front wall 332 of drawers 310 against the rack frame 290.

In one embodiment, second portion 454 of circuit interrupter 450 is uncoupled while drawer 310 is assembled to rack 290. Once assembled, second portion 454 may be coupled to first portion 452 thereby completing the series circuit of battery modules 300 of drawer 310. In one embodiment, a CAN network cable is coupled to the controllers 350 of battery modules 300 prior to drawer 310 being slid completely back into rack 290. The CAN network cable connects the controllers 350 of battery modules 300 with other controllers of energy system 100. In one embodiment, the connection to the CAN network is made through an interface module of drawer interface 380 and an interface module of rack interface 400.

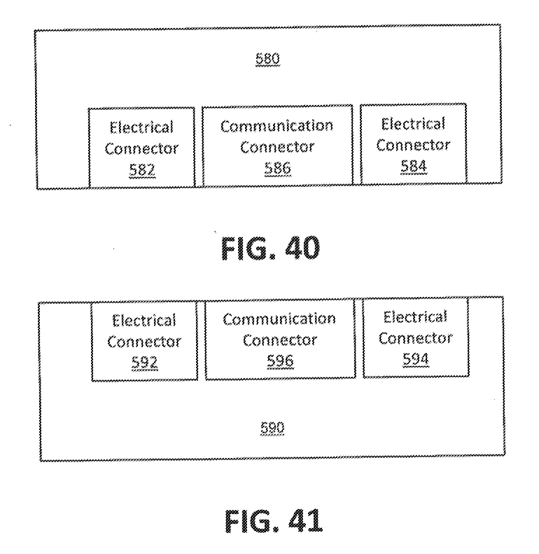

Referring to FIG. 40, an exemplary interface module 580 is shown. Interface module 580 includes a first electrical connector 582 and a second electrical connector 584. Interface module 580 may be part of rack interface 400. First electrical connector 582 and second electrical connector 584 may provide connections to the remaining members of the string that the coupled drawer 310 is a part of Interface module 580 further includes a communication interface connector 586 which couples to a mating communication interface on drawers 310. Communication interface connector 586 connects controllers 350 of battery modules 300 to other controllers of energy system 100. Referring to FIG. 41, an exemplary interface module 590 is shown which is for use with interface module 580. Interface module 590 includes a first electrical connector 592 and a second electrical connector 594 which include posts for reception in respective recesses of first electrical connector 582 and second electrical connector 584 of interface module 580. First electrical connector 592 and second electrical connector 594 are electrically coupled to the battery modules 300 in drawer 310. Interface module 590 further includes a communication interface connector 596 which couples to communication connector 586 of interface module 580.

In one embodiment, the four battery modules 300 in drawers 310 when connected in series provide a combined voltage output of up to about 200 volts. In one example, each battery module 300 provides up to about 50 volts.

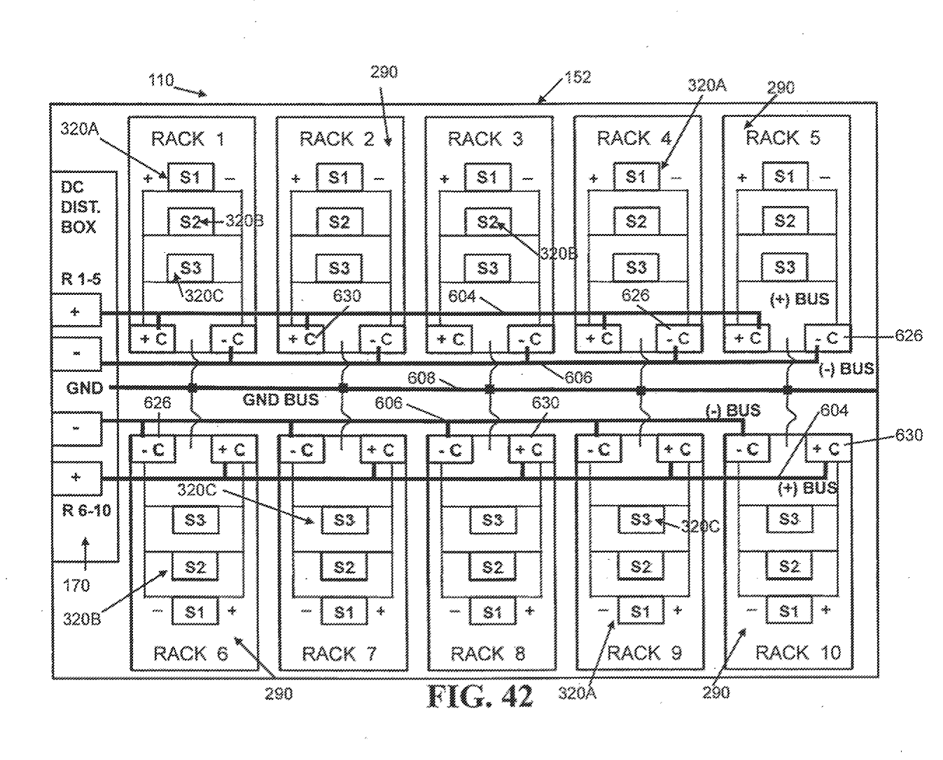

FIG. 42 illustrates additional details of an energy module 110 housed within one of the containers 152. In an illustrated embodiment, ten racks 290 are provided within the container 152 for holding batteries 112 which make up the battery groups 280. Illustratively, racks 1-5 extend along a first side of the container 152 while racks 6-10 extend along the opposite side of the container 152. Each rack 290 includes a positive (+) contactor 630 and a negative (−) contactor 626. As discussed above, three separate strings 320A, 320B, and 320C are illustratively connected in parallel to the positive and negative bank contactors 630, 626 as shown diagrammatically in FIG. 42.

Illustratively, the container 152 includes two positive (+) buses 604 and two negative (−) buses 606. Container 152 also includes a ground bus 608. The positive buses 604, negative buses 606, and ground bus 608 are coupled to the DC distribution box 170 within the container 152. The positive contactor 630 of each rack 290 is coupled to one of the positive buses 604, and the negative contactor 626 of each rack 290 is coupled to one of the negative buses 606. Therefore, the plurality of racks 290 are coupled in parallel to the DC distribution box through the positive and negative buses 604 and 606, respectively. As discussed in detail below, each of the strings 320A, 320B, and 320C of each rack 290 includes a string contactor 652, 656, 660, respectively, for selectively disconnecting or removing one of the strings 320 from the energy module 110. This is referred to as taking one of the strings 320 “offline”.

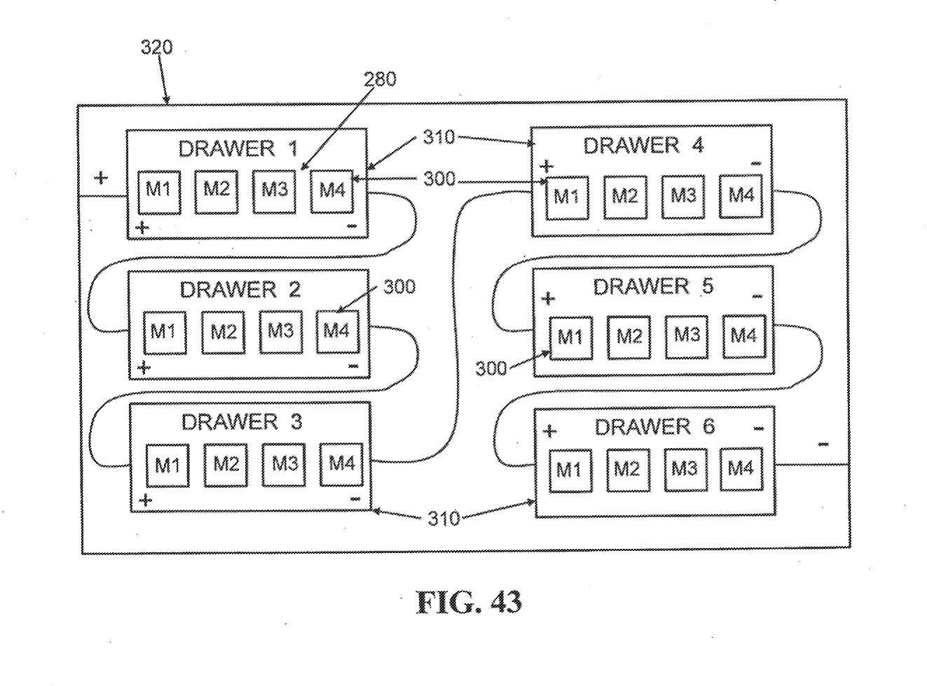

A diagrammatical view of one of the battery sub-groups or string 320 is illustrated in FIG. 43. As discussed above with reference to FIG. 27, each battery drawer 310 of each rack 290 illustratively includes four separate battery modules 300 connected in series within the drawer 310. The drawers 310 are also each connected in series to five other drawers 310 containing battery modules 300 to provide one of the battery sub-groups or strings 320. It is understood that a greater or lesser number of battery modules 300 or drawers 310 may be connected together in other embodiments, depending upon the particular voltages of each battery module 300 and the desired lower rating for the energy module 110.

In an illustrated embodiment, each of the battery modules 300 has a voltage of 50 volts, or slightly less, so that the voltage of each string 320 is about 1,200 volts. Preferably, modules have a voltage of 45-50V. Therefore, the maximum voltage of each battery drawer 310 is 200V. Since the strings 320A, 320B, and 320C are connected in parallel, the voltage of each rack 290 is also about 1,200 volts. As discussed below, a control system for the energy module 110 selectively removes defective strings 320 from the energy module 110 based on continuous monitoring of operating conditions and parameters of the strings 320 and/or battery modules 300. Due to the parallel and modular configuration of the plurality of strings 320 and the plurality of racks 290, selective strings 320 may be taken offline without shutting down the entire energy module 110. At an appropriate time, the defective battery modules 300 of strings 320 are replaced during servicing of the energy module 110.

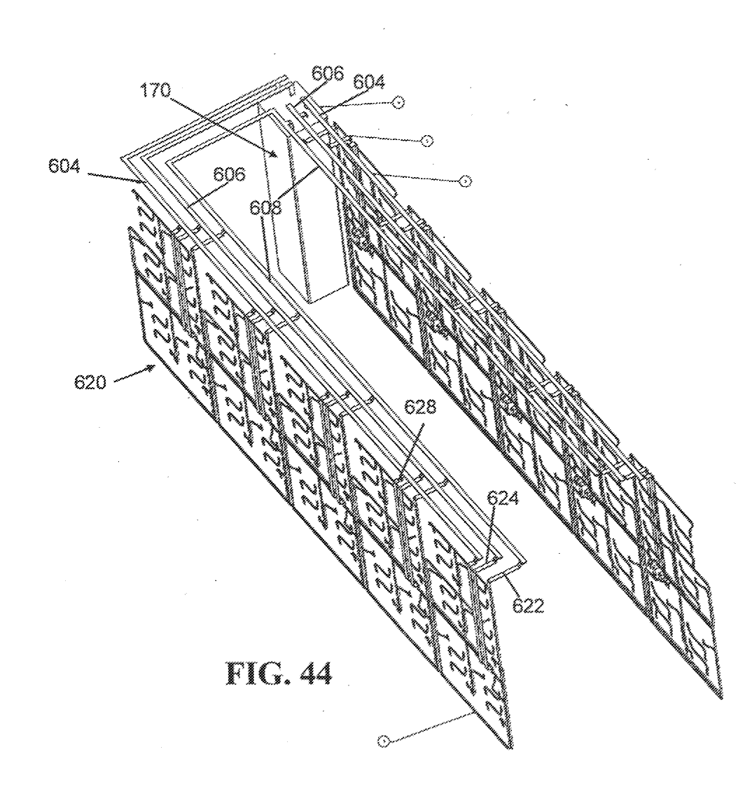

Additional details of the electrical connections between the plurality of drawers 310 within the racks 290 and the DC distribution box 170 are illustrated in FIGS. 44-46. FIG. 44 44 illustrates a plurality of electrical cables 620 which connect the plurality of drawers 310, 312, and 314 within each rack 290 together. A ground contact bar 622 connects ground strips 697 and and 698 of each rack 290 to the ground bus 608. A negative contact bar 624 of each rack 290 connects a negative contactor 626 of the rack (See FIG. 49) to the negative bus 606. A positive contact bar 628 connects a positive contactor 630 of the rack (See FIG. 49) to the positive bus 604.

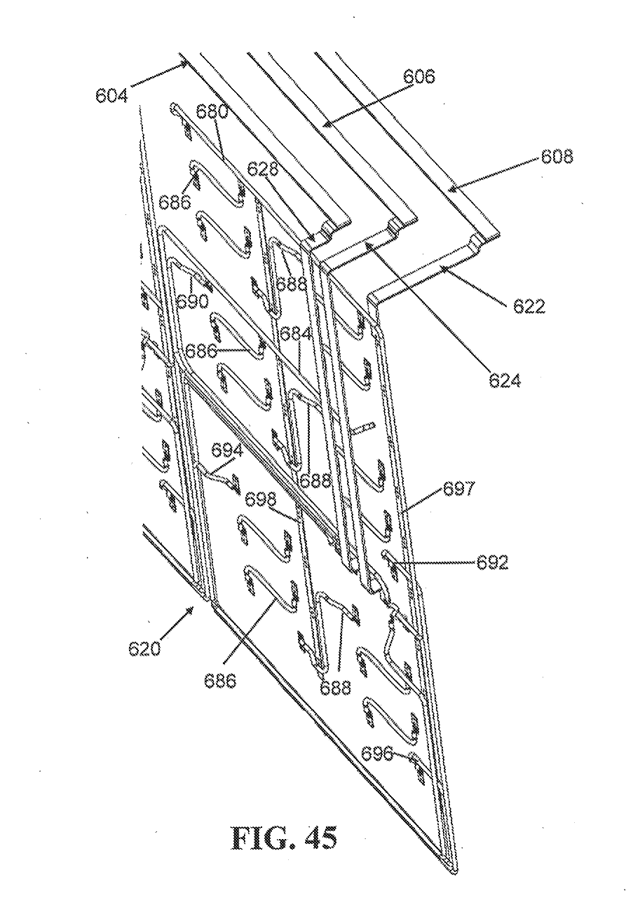

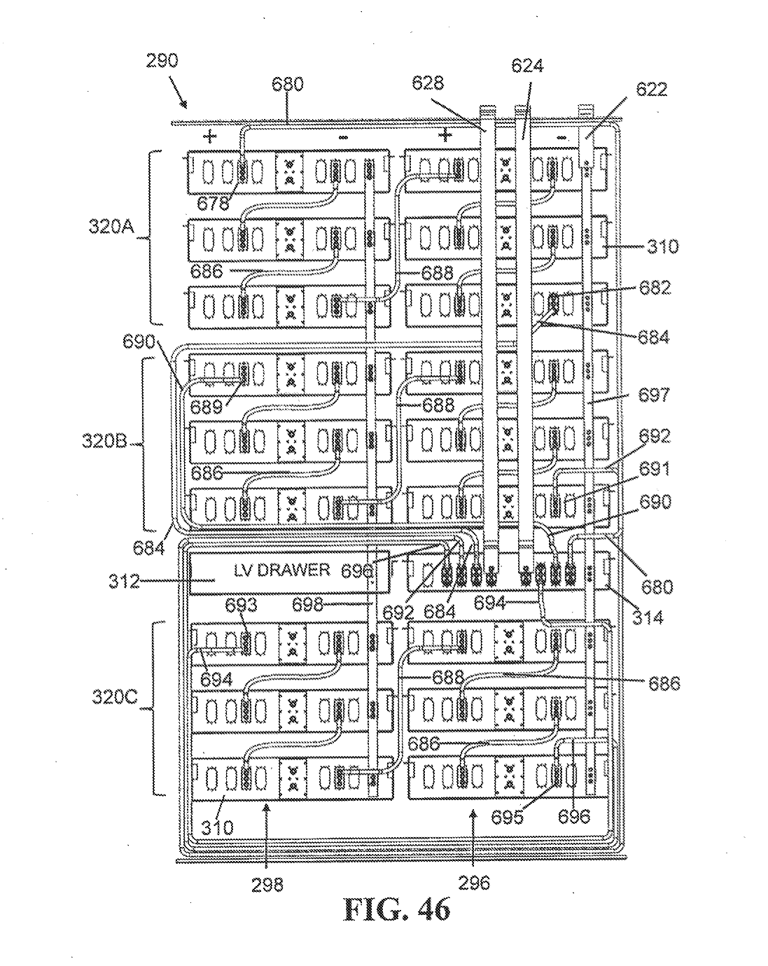

FIGS. 45 and 46 illustrate additional details of the electrical cabling 620 for connecting the plurality of drawers 310 together in series to form strings 320A, 320B and 320C. Cables 620 also connect the strings 320A, 320B and 320C to the high voltage drawer 312. A plurality of shorter cables 686 are shown in FIGS. 45 and 46. FIG. 45 is a rear view of the electrical cables 620 without the racks shown, while FIG. 46 is a rear view of one of the racks with the cabling also shown.

Additional components of the high voltage drawer 312 are shown diagrammatically in FIG. 49. The positive side connector from string 1 which is illustratively string 320A in FIGS. 32 and 46 is connected to a fuse 650 and a string 1 contactor 652. The positive output from string 2, which is illustratively string 320B in FIGS. 32 and 46, is connected to a fuse 654 and string 2 contactor 656. The positive output of string 3, which is string 320C, is connected to a fuse 658 and string 3 contactor 660. The output of string contactors 652, 656 and 660 are connected to current sensors 662, 664 and 666, respectively, for the first, second and third strings 320A, 320B and 320C. Current sensors 662, 664 and 666 are connected in parallel to the rack positive contactor 630. An output from positive contactor 630 is coupled to the positive bus 604 through contact bar 628.

The negative outputs from the first, second and third strings, illustratively strings 320A, 320B, and 320C, respectively, are coupled in parallel to an input of rack negative contactor 626 located in high voltage drawer 312. An output from rack negative contactor 626 is connected to the negative bus 606 by contact bar 624.

Rack positive and negative contactors 630 and 626, respectively, are illustratively normally open, high voltage, magnetic contactors available from Schaltbau GmbH, for example. Other suitable contactors may also be used. Illustratively, one of the contactors 630, 626 is installed in a forward direction and the other contactor 626, 630 is installed in a backward direction. Therefore, the combination of the two contactors 630, 626 is able to break current flow in either direction and extinguish or quench an arc of the magnetic contactor. The control system for the energy module 110 (such as PLC 750, 752 discussed below) senses the current flow direction and opens the appropriate contactor 630 or 626 first depending on the direction of the current flow to extinguish the arc and break current flow through the rack 290.

The high voltage drawers 312 for racks 1 and 2 further include a pre-charge contactor 668 and pre-charge resistor 670 coupled in series across the terminals of rack negative contactor 626. Pre-charge contactor 668 selectively opens and closes the pre-charge circuit in racks 1 and 2 as discussed below. In an illustrated embodiment, the high voltage drawers of racks 3-10 do not include the pre-charge contactor 668 and pre-charge resistor 670. However, more than two racks may include the pre-charge contactor 668 and pre-charge resistor 670, if desired.

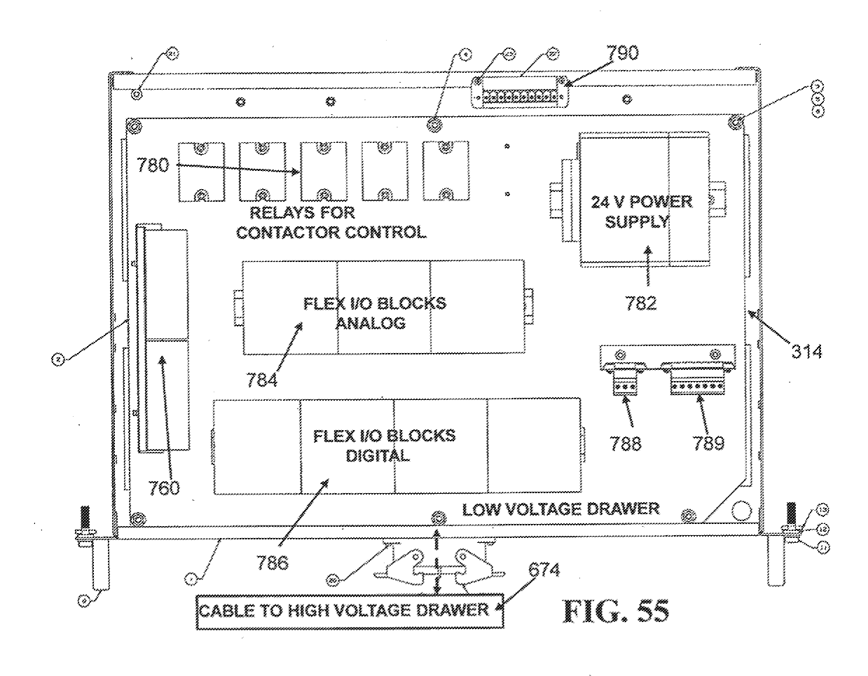

High voltage drawer 312 further includes a high voltage step down printed circuit board 672 which provides a 0-10 V output for the system controllers. The output from high voltage step down print circuit board 672 is coupled to the low voltage drawer by a suitable connector cable 674. Cable 674 extends across the front of rack 290 to connect low voltage drawer 312 as best shown in FIGS. 32A and 55.

The high voltage drawer 312 further includes signal conditioners 676. The signal conditioners 676 provide electrical isolation and signal conversion. The signal conditioners 676 provide proper voltage in/voltage out ratios.

Referring again to FIG. 46, a positive output from first string 320A at location 678 is coupled to fuse 650 of high voltage drawer by a cable 680. A negative output of first string 320A at location 682 is connected to the rack negative contactor 626 in high voltage drawer 312 by cable 684. Positive and negative contacts of other drawers 310 in string 320A are connected by cables 686 having the same size. The negative output from a lower drawer 310 of first string 320A is coupled to the positive output of an upper drawer 310 of string 320A by a longer cable 688.

A positive output from second string 320B at location 689 is coupled to fuse 654 of high voltage drawer by a cable 690. A negative output of second string 320B at location 691 is connected to the rack negative contactor 626 in high voltage drawer 312 by cable 692. Positive and negative contacts of other drawers 310 in string 320B are connected by cables 686 having the same size. The negative output from a lower drawer 310 of string 320B is coupled to the positive output of an upper drawer 310 of string 320B by a longer cable 688.

A positive output from third string 320C at location 693 is coupled to fuse 658 of high voltage drawer 312 by a cable 694. A negative output of third string 320C at location 695 is connected to the rack negative contactor 626 in high voltage drawer 312 by cable 696. Positive and negative contacts of other drawers 310 in string 320C are connected by cables 686 having the same size. The negative output from a lower drawer 310 of string 320C is coupled to the positive output of an upper drawer 310 of string 320C by a longer cable 688.

The length of each of the shorter connecting cables 686 connecting adjacent drawers 310 throughout the rack 290 are equal. The lengths of each of the longer connecting cables 688 connecting drawers 310 throughout the rack 290 are also substantially equal. Therefore, the cumulative lengths of the cables 686, 688 associated with strings 320A, 320B and 320C are substantially equal to provide a substantially equal resistance or impedance associated with each string 320A, 320B and 320C. This substantially equal resistance or impedance provides a balanced system.

Each rack 290 illustratively includes first and second banks 296 and 298 of drawers. Each bank 296, 298 include a conductive ground strip 697 and 698, respectively. Ground strip 697 is coupled to ground bus 608 by contact bar 622. Ground strip 697 is coupled to ground strip 698.

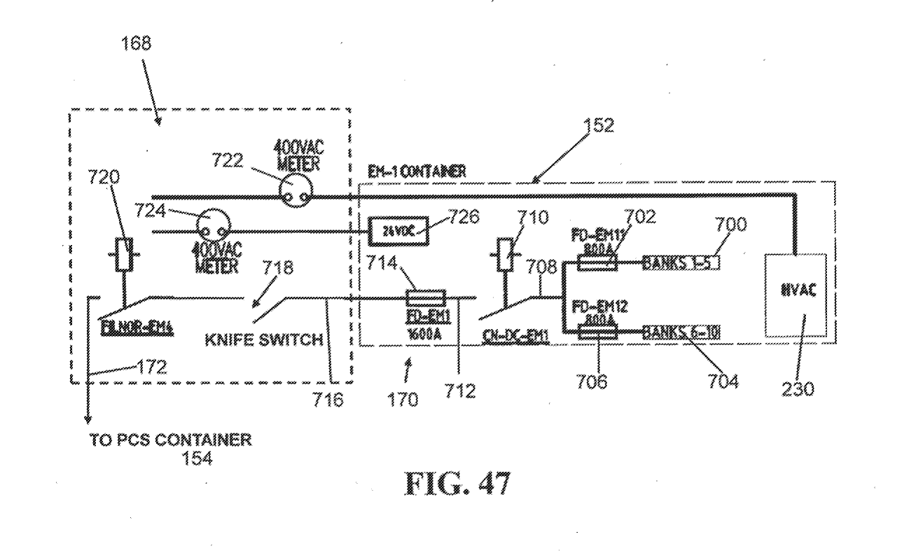

The positive and negative buses for 604 and 606 from racks 1-5 and the positive and negative buses 604 and 606 from racks 6-10 enter the distribution box as illustrated diagrammatically in FIG. 42 and also shown in FIG. 44. As illustrated in FIG. 47, racks 1-5 shown at location 700 are coupled to an 800 Amp fuse 702 within DC distribution box 170. Racks 6-10 shown diagrammatically at location 704 are coupled to another 800 Amp fuse 706 within the DC distribution box 170. Fuses 702 and 706 are coupled in parallel to a first terminal 708 of contactor 710. Contactor 710 is illustratively a high-power contactor available from Hubbel Industrial Controls, Inc. located in Archdale, N.C., although any suitable contactor may be used.

The second terminal 712 of contactor 710 is coupled to a 1600 Amp fuse 714 to provide an output from DC distribution box 170. The output from DC distribution box 170 is coupled to the external disconnect unit 168 via cable 716. Cable 716 is coupled to a first terminal of a manually operated knife switch 718 to permit an operator to disconnect the power to container 152 from outside the container 152. An opposite terminal of knife switch 718 is coupled to a first terminal of contactor 720. Contactor 720 is illustratively another high-power contactor available from Hubbell Industrial Controls. An opposite terminal of contactor 720 is coupled to the PCS container 154 through power lines 172 as discussed above. External disconnect unit 168 further includes volt meters 722 and 724. Volt meter 722 is coupled to a supply line for HVAC unit 230 located within container 152. Volt meter 724 is coupled to a 24 VDC supply 726 located within container 152. Volt meters 722 and 724 may also be located inside the container 152 of the energy module 110.

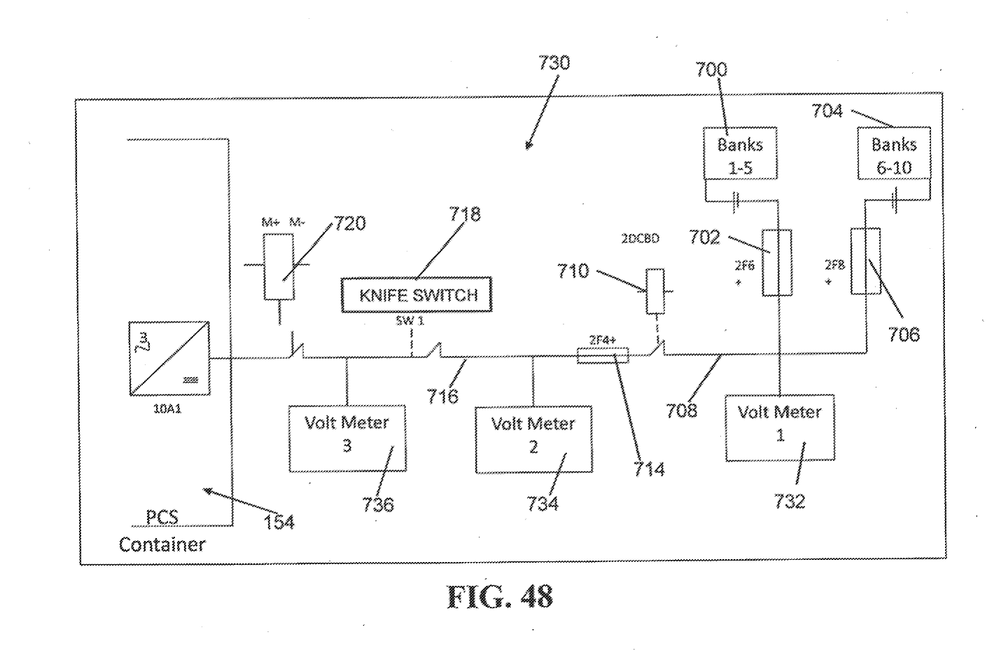

Each container 152 for holding the energy module 110 is provided with an access opening or access door 270, typically at one end of the container 152 adjacent the DC distribution box 170. A display panel 730 is visible either inside the container 152 or outside the container 152 adjacent the access door 270. An exemplary display panel 730 is shown in FIG. 48. Reference numbers from FIG. 47 show components of the electrical connection within DC distribution box 170 and external disconnect 168 discussed above. As shown in FIG. 48, a first volt meter 732 is coupled to the first terminal 708 of contactor 710 to provide an indication of the voltage at the common terminal 708 between contactor 710 and fuses 702 and 706. The operator can read the output display from volt meter 732 before entering the container 152 for servicing, maintenance or any other reason.

A second volt meter 734 is coupled to the common terminal 716 of fuse 714 and knife switch 718. Volt meter 734 provides an indication of a second voltage taken at this location of the circuit. The output voltage from volt meter 734 is also displayed on display panel 730 for the operator to see before entering the container 152.

A third volt meter 736 is coupled to the common terminal of knife switch 718 and contactor 720. Again, the output voltage from volt meter 736 is visible to the operator on display panel 730. Therefore, the operator can review three voltage levels taken by the volt meters 732, 734, and 736 which are displayed on display panel 730 prior to entering the container 152. Preferably, the voltages should all read zero volts before the operator enters the container 152.

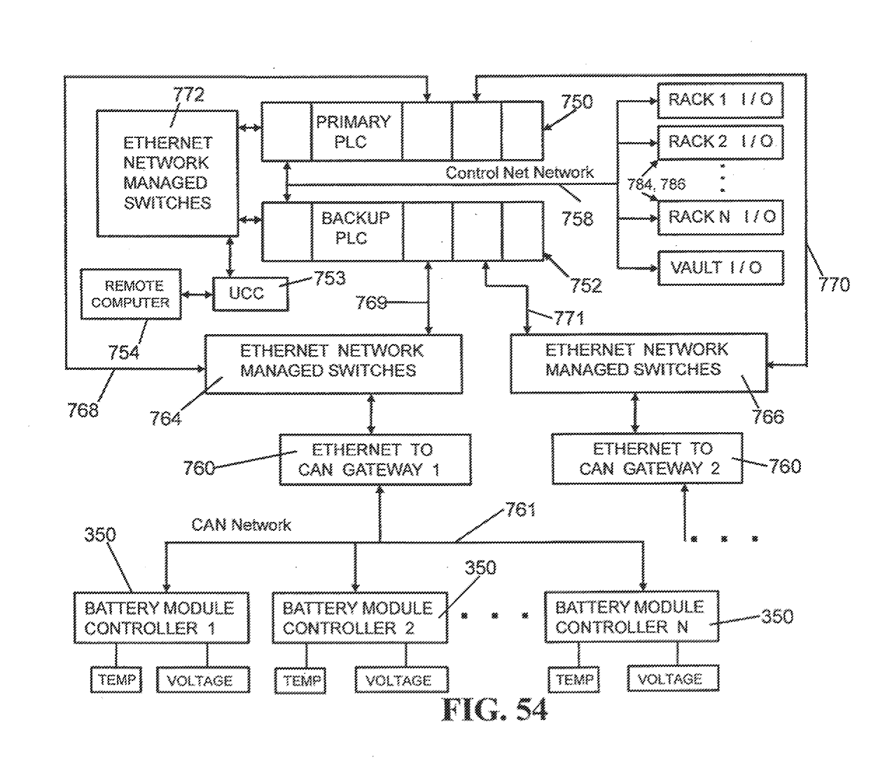

The control system for the energy modules 110 is illustrated in FIG. 54. Each battery module 300 contains a plurality of batteries 112 and has its own battery module controller 350. Each controller 350 monitors the temperature and voltage of its associated battery module 300. Each battery module controller 350 throughout the plurality of drawers 310 are connected to a communication network 761 via suitable cables. The communication network 761 is illustratively a CAN network. In the illustrated embodiment, ten racks 290 include 72 battery controllers 350 each which communicate over the CAN network 761.

The control system includes a redundant programmable logic controller (PLC) control system including a primary PLC 750 and a secondary or backup PLC 752 located in container 152. Both the primary and backup PLCs 750 and 752, respectively, receive all data from the racks 290 and battery module controllers 350. The primary PLC 750 controls the energy model 110 unless a problem occurs, at which point the backup PLC 752 takes over control of the system. The primary and backup PLCs 750 and 752 illustratively communicate with the rack components through a ControlNet network 758 or other suitable communication system. The ControlNet network is a serial communication system for communication between devices with time sensitive applications controlled in a predictable manner. Data and controls from components of racks 290 as well as an overall vault I/O 756 for the container 152 communicate with the primary and backup PLCs 750 and 752 via the ControlNet network 758. Other suitable protocols may also be used in accordance with the present disclosure.

The battery module controllers 350 are coupled to an Ethernet to CAN gateway device 760. In an illustrated embodiment, each gateway device 760 is connected to an Ethernet managed switch 764 or 766, respectively. In the illustrated embodiment, each of the managed switches 764, 766 is connected to 360 battery module controllers 350 through gateway devices 760. However, as discussed herein, it is understood that greater or fewer number of battery modules 300 may be provided depending upon the particular applications for the energy module 110. Ethernet network managed switches 764 are coupled to both the primary PLC 750 and backup PLC 752 by connectors 768 and 769, respectively. Managed switches 766 are connected to both the primary PLC 750 and backup PLC 752 by connectors 770 and 771, respectively.

Primary and back up PLC's 750 and 752 are connected to additional Ethernet managed switches 772 for handling communication with a unit central controller (UCC) 753 located outside the container 152. UCC 753 communicates with separate PLCs 750, 752 located in all the energy module containers 152. UCC 753 also communicates with controllers located in the PCS container 154. Preferably, UCC 753 is coupled to the PLCs of containers 152 and 154 by fiber optic cable.

The UCC 753 is also coupled to a remote computer 754 through another communication network, such as a satellite network, the Internet or other wide area network, to provide remote access to UCC 753 and PLCs 750, 752 for diagnostic purposes, control, data analysis, and review or maintenance of all of the components of the energy module 110.

The control system of the present disclosure is a modular system that permits any number of battery module controllers 350 to be coupled together into any number of strings 320. Any number of racks 290 may also be used in the energy module 110. By changing variables within the PLCs 750 and 752, one of the PLCs 750 or 752 is capable of controlling any number of racks 290, strings 320, or battery modules 300. The PLCs 750 and 752 also monitor voltages, temperatures or other parameters of the battery module 300, strings 320, drawers 310, or racks 290 in order to control operation of the system as discussed herein. The control software discussed herein permits the PLCs 750 and 752 to monitor a large volume of data related to voltage and temperature of every battery module 300. Due to the prismatic structure and alignment of cells and battery packs within the battery modules 300, every battery cell within the battery module 300 may be monitored, if desired. Network 758 supports high volumes of data and real time or time critical applications such as opening and closing the various contactors within the energy module 110.

Details of the components within the low voltage drawer 314 of each rack 290 are shown in FIG. 55. Each low voltage drawer 314 includes two of the gateway modules 760 coupled to the battery controllers 350. In addition, the low voltage drawer 314 includes a plurality of relays 780 for controlling the plurality of contactors in the high voltage drawer 312. In the illustrated embodiment, a relay 780 is provided for each of the three string contactors 652, 656 and 660 in high voltage drawer 312. In addition, relays 780 are provided for the rack positive contactor 630, the rack negative contactor 626, and the pre-charge contactor 668. Primary PLC 750 or secondary PLC 752 provides control signals to the relays 780, thereby opening and closing the string contactors 652, 656, 660, the positive and negative rack contactors 630 and 626, and the pre-charge contactor 668 based on control signals received from the PLC 750, 752.

Low voltage drawer 314 further includes a 24 V power supply 782 to provide power for the communication network 761 and gateway module 760. Low voltage drawer 314 further includes a first set of analog Flex I/O blocks 784 and a set of digital Flex I/O blocks 786. Blocks 784 and 786 are coupled to PLCs 750 and 752 through network 758. I/O blocks 784 permit the PLCs 750, 752 to receive and monitor currents and voltages from the plurality of battery modules 300 which make up strings 320A, 320B and 320C of each rack 290. I/O blocks 786 permit the PLCs 750, 752 to receive signals to monitor contactors, relays, switches, fuses or other components within the rack 290. Low voltage drawer 314 includes additional connectors 788 and 789. Connector 788 receives incoming power. Connector 789 monitors pump controls for the cooling system and receives emergency stop functions. A test connector 790 is provided for testing operation of the low voltage drawer 314 prior to installation of the drawer 314 into a rack 290.

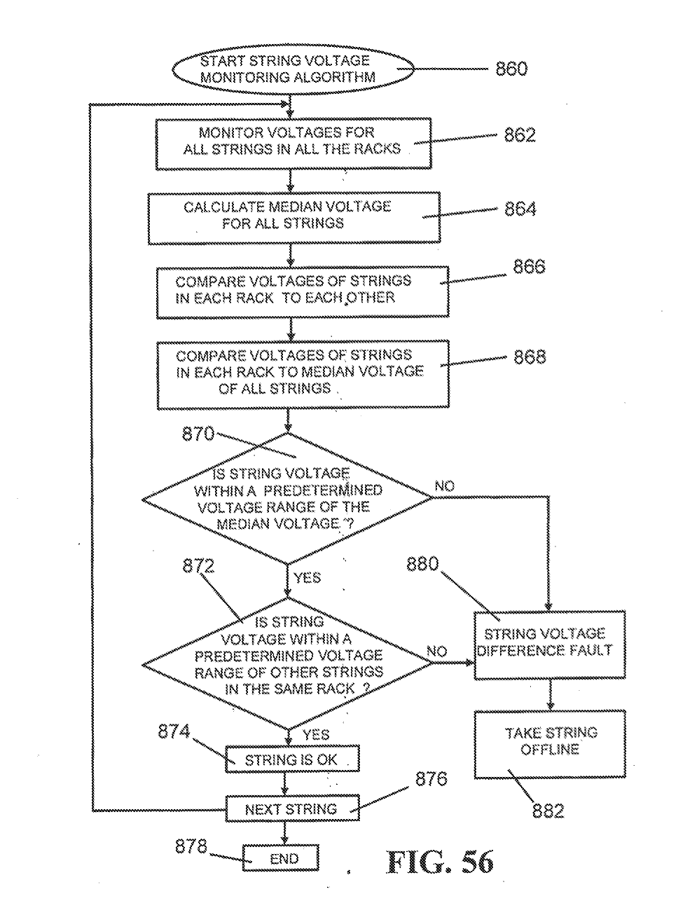

The PLCs 750, 752 monitor voltages and temperatures of the battery modules 300 and strings 320 within each of the plurality of banks 290. By selectively using relays 780 within low voltage drawer 314, the PLC 750, 752 can selectively open or close the string contactors 652, 656 and 660, thereby removing a particular string 320A, 320B or 320C from the energy module 110. In other words, if string contactors 652, 656 or 660 are opened, the particular string 620A, 620B or 620C, respectively, is taken off line. PLCs 750 and 752 monitor a plurality of different diagnostic conditions or parameters of the strings 320 to decide whether or not to take a string 320 offline. In illustrated embodiments, the PLCs 750, 752 monitor for fault conditions and take a particular string 320 offline if the fault occurs. Exemplary fault conditions which are monitored include:
1. String contactor open/close fault;
2. Blown fuse fault;
3. String over current fault;
4. String voltage difference fault determined using a string voltage monitoring algorithm discussed below with reference to FIG. 56;
5. Cell temperature out of range fault;
6. Cell voltage difference fault which monitors particular battery modules 300 or battery cells within the battery modules;
7. Cell over voltage fault;
8. Cell under voltage fault;
9. Cell over temperature fault;
10. Cell under temperature fault;
11. Remote lithium energy controller (RLEC) malfunction code; and
12. RLEC Communication fault which occurs when the battery controller 350 stops communicating.

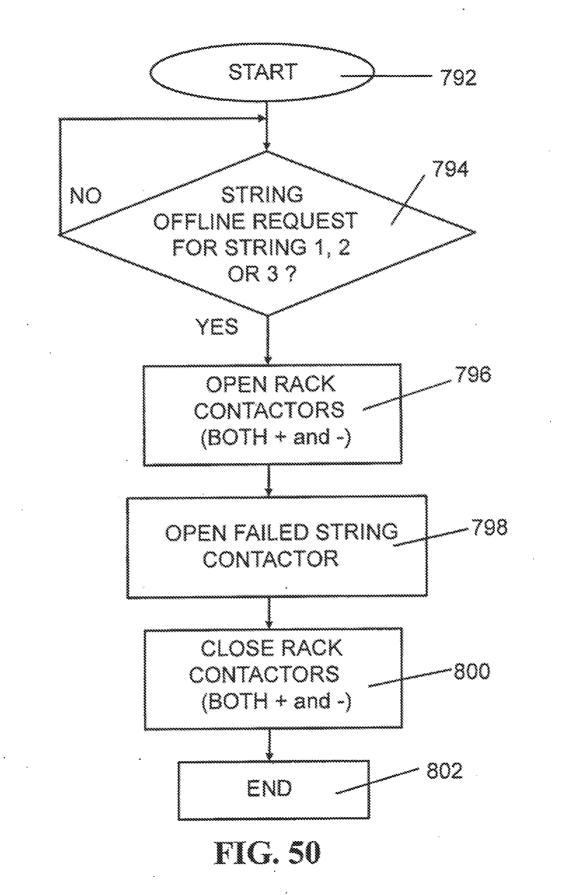

FIG. 50 is a flow chart illustrating the steps performed by the PLC 750, 752 when it is determined that a particular string 320 should be removed or taken off line. The process starts at block 792. The PLC 750 or 752 continuously monitors the diagnostics discussed above to determine whether a diagnostic fault has occurred necessitating taking one of the strings 320A, 320B or 320C for a particular rack 290 offline as illustrated at block 794. If no such string offline request has occurred at block 794, PLC 750, 752 waits for such a request. If a string offline request has occurred at block 794, PLC 750, 752 sends instructions to open both the positive and negative contactors 630 and 626 for a particular rack 290, as illustrated at block 796. The instructions are received at low voltage drawer 314 for the rack 290 and a particular relay 780 is controlled to open the positive and negative rack contactors 630, 626. The rack contractors 630, 626 are opened first to break current flow. PLC 750, 752 then sends a control signal to open the string contactors 652, 656 or 660 the failed string as illustrated at block 798. In other words, if the first string 328A has a fault, the PLC 750 sends a signal to control a relay 780 and open string 1 contactor 652 in the high voltage drawer 312.

After the string contactor 652, 656 or 660 has been opened at block 798, the PLC 750, 752 sends a control signal to close the positive and negative rack contactors 630 and 626 as illustrated at block 800. Again, the control signal from PLC 750, 752 is received by low voltage drawer 314 and the particular relay 780 is controlled to close positive and negative contactors 630 and 626 of rack 290. The process then ends at block 802.

Once the rack contactors 630, 626 are closed at block 800, the rack 290 is back online within the energy module 110 with the particular string 320 off line. If string 320A was taken off line, for example, strings 320B and 320C remain coupled in parallel to the positive and negative rack contactors 630 and 626 as discussed above.

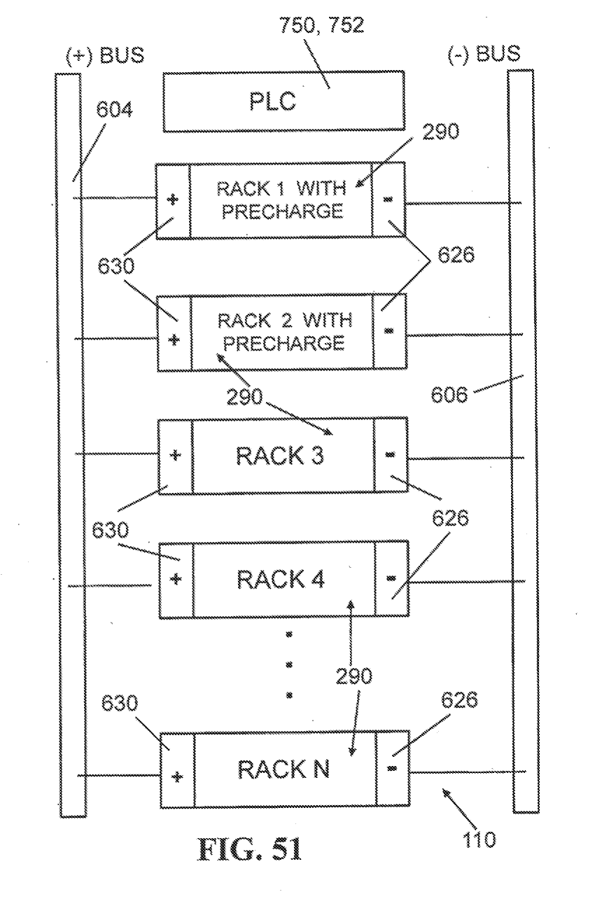

FIG. 51 illustrates the plurality of racks 290 of an energy module 110 and the positive and negative rack contactors 630 and 626 coupled to the positive and negative buses 604, 606, respectively. As discussed above, the primary PLC 750 or backup PLC 752 provides control signals for selectively opening and closing the positive and negative contactors 630 and 626 of each rack 290 of the energy module 110. When it is desired to bring an entire energy module 110 on line, PLC 750, 752 brings the module 110. In an illustrated embodiment, energy module 110 has redundant pre-charge capability. In the illustrated embodiment, two of the racks 290, such as racks 1 and 2, are provided with pre-charge capabilities. Rather than opening all the positive and negative contactors 630, 626 within all the racks 290 at the same time, PLC 750, 752 controls opening of the contactors 630, 626 in a sequential, orderly fashion.

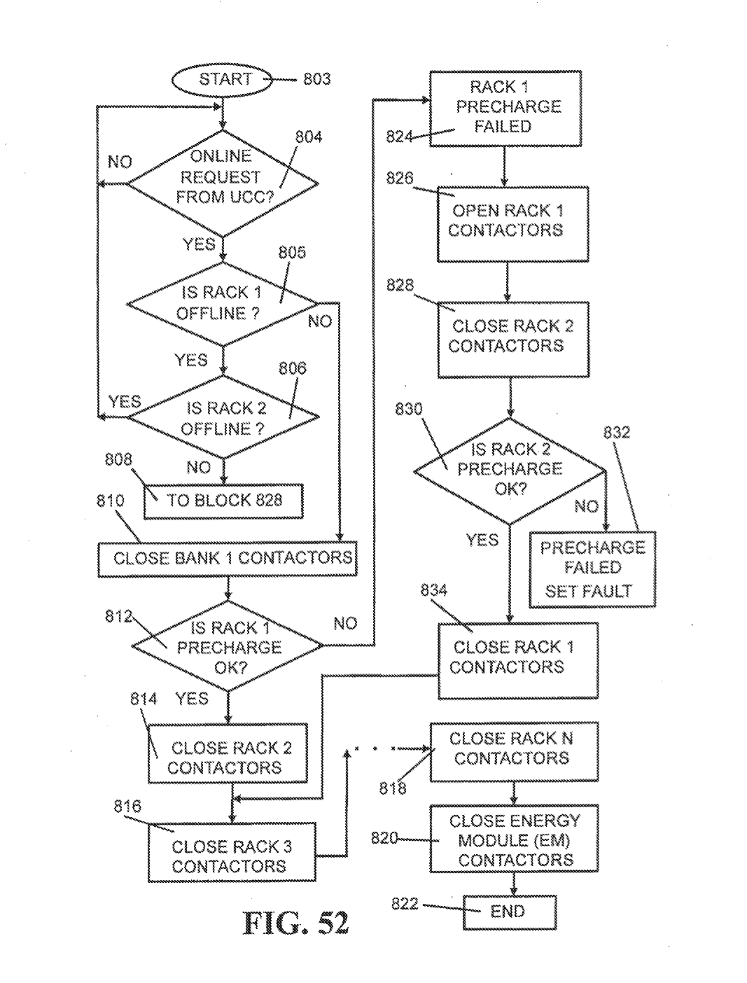

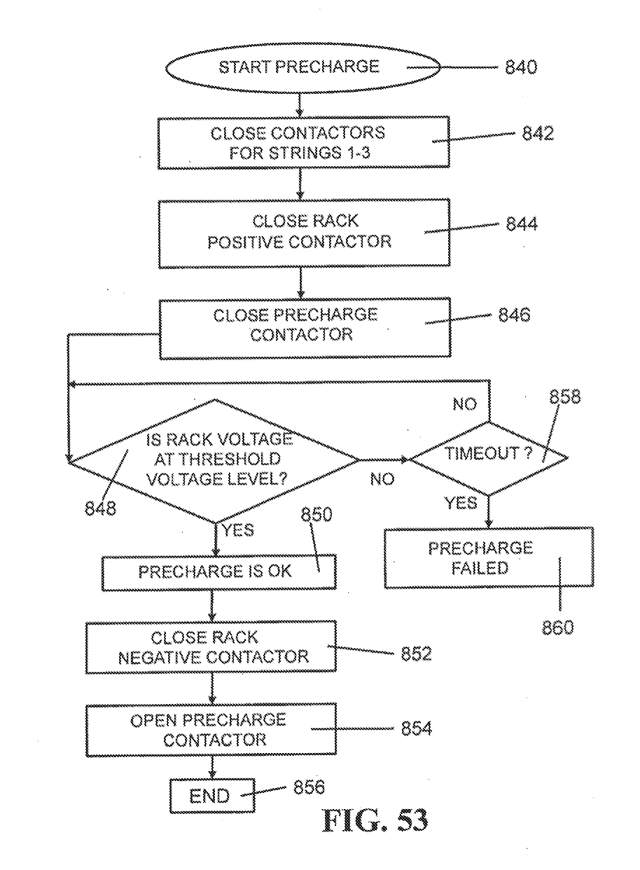

The steps performed to bring the energy module online are illustrated in FIGS. 52 and 53. The process starts at block 803 of FIG. 53. PLC 750, 752 determines whether an online request is received from the unit central controller (UCC) 753 as illustrated at block 804.

If not, the PLC 750, 752 continues to monitor for such online request from the UCC 753. If an online request is received at block 804, PLC 750, 752 determines whether rack 1 is offline at block 805. If rack 1 is offline, PLC 750, 752 next determines if rack 2 is offline as illustrated at block 806. If rack 2 is offline, then both racks of the racks with pre-charge capabilities are offline and PLC 750, 752 returns to block 804 to wait for another online request. PLC 750, 752 may send an indication that both racks 1 and 2 are offline back to the UCC 753.

If rack 1 is not offline at block 805, PLC 750, 752 closes the rack 1 contactors 630 and 626 as illustrated at block 810. Next, PLC 750, 752 monitors rack 1 to determine whether the pre-charge for rack 1 is ok as illustrated at block 812. Pre-charge testing steps are shown in FIG. 53. If the rack 1 pre-charge is ok at block 812, PLC 750, 752 proceeds to sequentially close the positive and negative contactors 630 and 626 for rack 2 as illustrated at block 814, rack 3 is illustrated at block 618 and so on through rack N as illustrated at block 818. In the illustrated embodiment, PLC 750, 752 sequentially closes the contractors 630, 626 for racks 2-10 to systematically bring the energy module 110 online. A predetermined time delay occurs between the contactor closing steps 814, 816, 818.

Once all the rack contactors 630 and 626 are closed at block 818, PLC 750, 752 closes the energy module contactors 710, 720 shown in FIGS. 47 and 48, for example, to bring the energy module 110 online as illustrated at block 820. The process ends at block 822 once the energy module contactors 710, 720 are closed at block 820.

If the rack 1 pre-charge is not ok at block 812, PLC 750, 752 determines that the rack 1 pre-charge has failed as illustrated at block 824. PLC 750, 752 then opens the contactors 630, 626 for rack 1 as illustrated at block 826. Since both rack 1 and rack 2 have pre-charge capabilities, PLC 750, 752 then closes the contactors 630, 626 for rack 2 as illustrated at block 828. PLC 750, 752 then determines whether the rack 2 pre-charge is ok as illustrated at block 830. Again, the pre-charge testing is shown in more detail in FIG. 53. If the rack 2 pre-charge fails at block 730, a fault is set as illustrated at block 832. PLC 750, 752 then sends an appropriate message to UCC 753 and returns to block 804 to monitor for the next online request from the UCC 753.

If the rack 2 pre-charge is okay at block 830, PLC 750, 752 closes contactors 630 and 626 of rack 1 as illustrated at block 834. Rack 2 which has been now pre-charged is then used to charge rack 1 at block 734. Since rack 2 is already open, PLC 750, 752 next closes the rack 3 contactors at block 816. PLC 750, 752 then orderly and sequentially opens the remaining rack contactors 630, 626 until the last rack (rack N) contactors are closed at block 818. Once all the rack contactors 630, 626 are closed to bring all the racks 290 online, the PLC 750, 752 closes the energy module contactors 710 and 720 at block 820 and ends the process at block 822.

FIG. 53 illustrates the steps performed by the control system during pre-charge of one of the racks 290 of energy module 110. The pre-charge process starts at block 840. PLC 750, 752 sends instructions to close contactors 652, 656, 660 for strings 320A, 320B and 320C of rack 290 as illustrated at block 842. Next, PLC 750, 752 sends instructions to close the rack 290 positive contactor 630 as illustrated at block 844. Next, a pre-charge contactor 668 within the pre-charge circuit is closed as illustrated at block 846. Therefore, current passes pre-charge resistor 670 instead of directly through rack negative contactor 626 which remains open. When initially connecting a rack 290 to a load, there is an inrush of current as the batteries 112 within the rack 290 are charged. With large batteries such as battery modules 300, the inrush current can exceed desired levels. Therefore, pre-charge resistor 670 limits the inrush current used to charge batteries 112 of the battery modules 300.

PLC 750, 752 monitors the rack voltage to determine whether the rack voltage reaches a predetermined threshold level as illustrated at block 848. For instance, the voltage of rack 290 is monitored to determine whether the rack voltage reaches a certain percentage of the desired rack voltage. In an illustrated embodiment, the desired threshold level for a successful pre-charge is about 90% of the rack voltage. For embodiments where the rack voltage is 1200 volts, the pre-charge threshold is about 1,080 volts, for example. If the rack voltage is not at the desired threshold level at block 848, PLC 750, 752 determines whether a timeout has occurred as illustrated at block 858. If not, the PLC 750, 752 continues to monitor the rack voltage at block 848. If the timeout occurs at block 858, PLC 750, 752 determines that the pre-charge has failed at block 860.

If the rack voltage reaches the threshold level before the timeout occurs at block 848, then PLC 750, 752 determines that the pre-charge for the rack 290 is ok at block 850. PLC 750, 752 then closes the rack negative contactor 626 as illustrated at block 852. PLC 750, 752 then opens the pre-charge contactor 668 as illustrated at block 854. Therefore, the current passes directly through negative contactor 626 without passing through pre-charge resistor 670 once the pre-charge contractor is opened at block 854. The pre-charge process ends at block 856.

The control system of the present disclosure includes a string voltage monitoring system and algorithm for detecting when a particular battery string 320 has a voltage difference fault when compared to other strings within the energy module. Each string 320 is controlled individually which allows for taking individual strings 320 offline without taking the entire energy module 110 offline. As discussed above, each rack 290 in the illustrated embodiment of the present disclosure includes three separate strings 320A, 320B, and 320C. Therefore, in the illustrated embodiment the ten racks 290 include a total of thirty strings 320. The control system system of the present disclosure can take any of the strings 320 offline for maintenance purposes or to cycle the strings 320 to lengthen their service lives. The power rating of the overall energy module 110 drops by 1/30^{th} of the maximum rating for each string 320 that is taken off line.

The voltage difference monitoring algorithm of the present disclosure monitors the voltage of strings 320 and removes the strings 320 from service if they are out of voltage tolerance compared to other strings 320 within the energy module 110. As discussed above, the modularity of the present disclosure allows the cycling of the various strings online and offline due to malfunction or to increase battery life.

The voltage difference monitoring algorithm is illustrated in FIG. 56. The string voltage monitoring algorithm begins at block 860. The PLC 750, 752 monitors voltages for all strings 320 in all racks 290 of the energy module 110 as illustrated at block 682. PLC 750, 752 calculates a median voltage for all strings 320 of the energy module 110 as illustrated at block 864. PLC 750, 752 then compares to voltages of a particular string 320 in each rack to other strings of the same rack as illustrated at block 866. PLC 750, 752 also compares voltages of the strings 320 in each rack to the median voltage of all strings 320 in all the racks 290 of the energy module 110 as illustrated at block 868.

Next, PLC 750, 752 determines if a string voltage for a particular string 320 is within a predetermined voltage range of the median voltage for all strings as illustrated at block 870. If not, PLC 750, 752 sets a string voltage difference fault for the particular string at block 880 and the string is then taken offline as discussed above and illustrated at block 882. If the string voltage for the particular string 320 is within the predetermined voltage range of the median voltage at block 870, PLC 750, 752 determines whether the string voltage is within a pre-determined voltage range of other strings in the same rack at block 872. If so, PLC 750, 752 determines that the string is ok at block 874. The PLC 750, 752 then determines whether the next string has a voltage difference fault as illustrated at block 876 using the steps discussed above. The process ends at block 878. If the string voltage difference exceeds a permitted level at block 872, PLC 750,752 sets a string voltage fault at block 880.

For a 1200V string of an illustrated embodiment, each string voltage should be within 50V of the median string voltage in order to be within the acceptable voltage range at block 870. The voltage difference between strings 320 in the same rack 290 should also be less than 50V for a 1200 V system. These voltage ranges may be changed to other suitable levels, and vary depending on the voltages of the strings 320.

In an illustrated embodiment of the present disclosure, a voltage imbalance of any of the strings 320 above a predetermined difference threshold is detected. The illustrated embodiment of the present disclosure disconnects the strings 320 that are not voltage balanced compared to the other strings 320 in order to minimize the voltage imbalance between the strings 320. The energy module 110 continues to operate with the remaining online strings 320 at a reduced power rating based on the total number of removed strings 320.

In one illustrated embodiment of the String Voltage Monitoring Algorithm, the PLC 750, 752 monitors voltages of all the strings 320A, 320B, and 320C for all the racks 290 of the energy module 110 at block 862. For each energy module there are 30 strings 320 in the illustrated embodiment. For each rack 290, PLC determines the string voltage for each string 320, where:

String 1 Voltage=S1V;

String 2 Voltage=S2V; and

String 3 Voltage=S3V

The PLC 750, 752 then calculates the differences between the voltages of the first, second and third strings 320A, 320B and 320C in each rack 290, respectively, compared to the other string voltages within the same rack 290 as follows:

Strings 1 and 2 Difference=S1−2Δ=|S1V−S2V|;

Strings 1 and 3 Difference=S1−3Δ=|S1V−S3V|; and

Strings 2 and 3 Difference=S2−3Δ=|S2V−S3V|

PLC 750, 752 also determines a median string voltage based on the voltages of all the strings 320 in the energy module 110. Therefore, the value SMedianV=the median voltage voltage of all strings 320 in all racks 290 of the energy module 110. The PLC 750, 752 then calculates the differences between the voltages of the first, second and third strings 320A, 320B and 320C in each rack 290, respectively, and the median string voltage (SMedianV) based on all the strings 320 in the energy module 110 as follows:

String 1 Median Difference=S1MedianΔ=SMedianV−S1V;

String 2 Median Difference=S2MedianΔ=SMedianV−S2V; and

String 3 Median Difference=S3MedianΔ=SMedianV−S3V

The PLC 750, 752 then determines for each string 320A, 320B and 320C in each rack 290, whether the string voltage difference is acceptable using the following algorithm:

String 1 is OK if:

((S1V≦(SMedian+50V)) AND (S1V≧(SMedian−50V)) AND [(S1−2Δ<50V) OR (S1−3Δ<50V) OR (S1MedianΔ<50V)]

String 2 is OK if:

((S2V≦(SMedian+50V)) AND (S2V≧(SMedian−50V)) AND [(S1−2Δ<50V) OR (S2−3Δ<50V) OR (S2MedianΔ<50V)]

String 3 is OK if:

((S3V≦(SMedian+50V)) AND (S3V≧(SMedian−50V)) AND [(S1−3Δ<50V) OR (S2−3Δ<50V) OR (S1MedianΔ<50V)]

As discussed above, if a particular string 320A, 320B or 320C is not OK, meaning that the voltage difference of the string 320A, 320B or 320C exceeds the desired voltage variation compared to other strings, then the particular out-of-range string 320A, 320B or 320C is taken offline as discussed above.

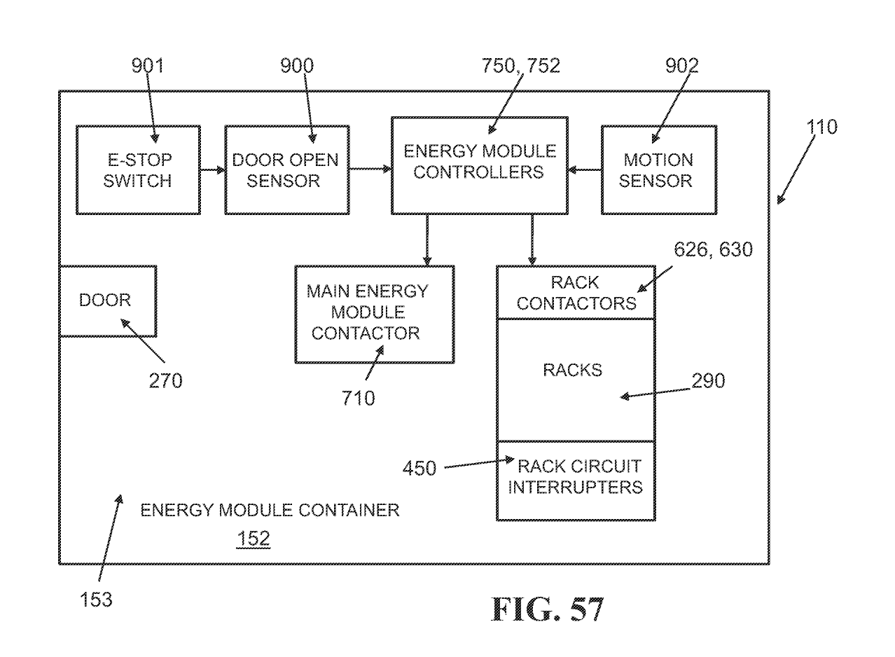

Another embodiment of the present disclosure is illustrated in FIG. 57. Each energy module container 152 illustratively includes an emergency stop control function which detects a person entering the interior region 153 of the energy module container 152. As discussed above, an entry door 270 is provided into an interior region 153 of container 152 which contains the plurality of racks 290 storing the battery modules 300. When the energy module 110 is online with the main energy module contactor 710 closed and all the rack negative and positive contactors 626, 630 closed, the energy module container 152 presents an arc flash risk if a person enters the interior region 153. Such arc flash risks are often categorized by a category number based on the energy generated during an electrical arc event. The category numbers range from 0-4, where category 4 signifies the greatest risk. Different types of personal personal protective equipment and other precautions are required to enter an area for each of the different arc flash risk categories. When the main module contactor 710 and the negative and positive rack contactors 626 and 630, respectively, are all closed, the arc flash risk category for the energy module container 152 is a category 4 or above.

As discussed above, a person should not enter the interior region 153 of container 152 unless all voltages from the three voltmeters 732, 734, 736 displayed on a display panel 730 shown in FIG. 48 read zero volts. Display panel 730 is visible either inside the container 152 or outside the container 152 adjacent the access door 270. The system and method illustrated in FIG. 57 reduces an arc flash risk and category level if a person is detected entering the interior region 153 of energy module container 152 when the energy module 110 is online.

A door open sensor 900 coupled to energy module controllers 750, 752 detects when the entry door 270 is opened. A door opening indicates that a person is likely to enter the interior region 153. Upon detecting the door 270 opening, sensor 900 sends a signal to energy module controllers 750, 752 indicating that the door 270 has been opened. At least one emergency stop switch 901 is also coupled to the energy module controllers 750, 752. Illustratively, the least one emergency stop switch 901 is coupled in series with the door open sensor 900. Also illustratively, first and second emergency stop switches 901 are red push button switches located in front and rear portions of the interior region 153 of each energy module container 152, respectively.

In addition, a motion sensor 902 is located within the interior region 153 of energy module container 152. Motion sensor 902 detects movement within the interior region 153 such as when a person enters the interior region 153. Motion sensor 902 is also coupled to energy module controllers 750, 752 and provides an output signal when motion is detected.

When energy module controllers 750, 752 receive a signal from either door open sensor 900 indicating the presence of a person within the interior region 153 or a signal from an emergency stop switch 901, or both, energy module controllers 750, 752 send control signals to automatically open main energy module contactor 710 and all the negative and positive rack contactors 626, 630, respectively, of each rack 290 to reduce the arc flash risk within the energy module container 152. String contactors 652, 656, 660 of each rack 290 may also be automatically opened by the energy module controllers 750, 752. Any opened emergency stop switch 901 must be closed before the energy module controllers 750, 752 can close the opened contactors.

In another embodiment, when energy module controllers 750, 752 receive a signal from motion sensor 902 indicating the presence of a person within the interior region 153, energy module controllers 750, 752 send signals to automatically open main energy module contactor 710 and all the negative and positive rack contactors 626, 630, respectively, of each rack 290. Again, string contactors 652, 656, 660 of each rack 290 may also be automatically opened by the energy module controllers 750, 752 upon receipt of the signal from motion sensor 902.

A person entering the interior region 153 may open the rack circuit interrupters 450 on each of the racks 290 (as discussed above) to further reduce the arc flash risk of the energy module container 152. In an illustrated embodiment, the arc flash risk category may be reduced from a category 4 or above to category 2 by opening the contactors 710, 626, 630 and the circuit interrupters 450. Therefore, an operator can enter the interior region 153 of container 152 with less protective gear once the arc flash risk has been reduced.

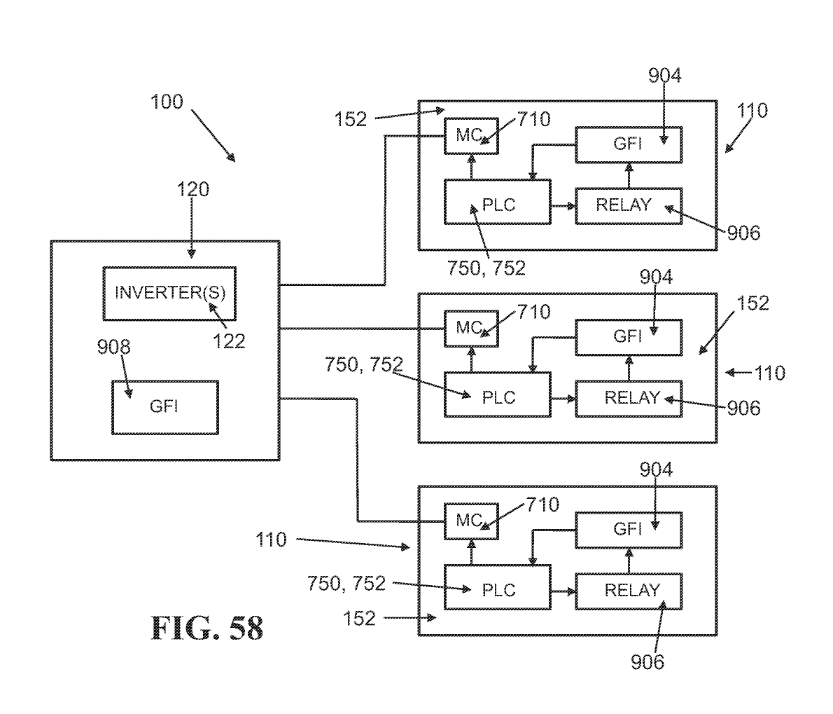

As discussed above, each of the energy modules 110 of an energy system 100 are coupled to a power control module 120 as shown, for example, in FIGS. 1-3. FIG. 58 illustrates further details of the energy modules 110 and the power control module 120. During power-up of each energy module 110, the controller 750, 752 within the container 152 enables a ground fault detection and interrupt (GFI) circuit 904 within the container 152. In an illustrated embodiment, controller 750, 752 closes a relay 906 to enable GFI circuit 904 within the container 152. Each of the separate energy module containers 152 includes its own GFI circuit 904 and relay 906 as illustrated in FIG. 58. The GFI circuits 904 monitor the high voltage DC bus within the containers 152 by testing an impedance between the high voltage DC bus and the container chassis or earth ground. The GFI circuit 904 continuously monitors the container 152 to ensure that no high voltage DC is present on metal of the container 152.

Before the controller 750, 752 of energy module 110 closes its main contactor 710 to couple the energy module 110 to the power control module 120, the energy module controller 750, 752 disables the GFI circuit 904, illustratively by opening relay 906. While the illustrated embodiment shows closing and opening relays 906 to enable and disable the GFI circuitry 904, in another embodiment a communication network link is provided between the controllers 750, 752 and the GFI circuit 904 to selectively enable and disable the GFI circuit 904. In one illustrated embodiment, the communication link is a RS 485 link, but any suitable communication link may be used.

Once the main contactor 710 is closed, the power control module 120 provides ground fault detection through a GFI circuit 908 of the inverter 122. Only one ground fault detection circuit monitors the high voltage DC bus at a single time. The GFI circuits 904 of the energy modules 110 therefore provide an indication of a ground fault in one of the energy modules 110 before the energy module 110 is connected to the main power control module 120 of energy system 110. Once all of the energy modules 110 are on line and coupled to power control module 120, the ground fault detection is done by CFI circuitry 908 associated with the inverter 122.

If a ground fault condition is detected by GFI circuits 904, 908, energy module controllers 750, 752 send signals to automatically open certain closed contactors associated with the energy module 110 having the ground fault condition. For example, energy module controllers 750, 752 send signals to automatically open main energy module contactor 710 and all the negative and positive rack contactors 626, 630, respectively, of each rack 290 associated with the energy module 110 having the ground fault condition. String contactors 652, 656, 660 of each rack 290 may also be automatically opened by the energy module controllers 750, 752.

Although an illustrated embodiment of the present disclosure includes drawers 310, 312, 314 as exemplary types of containers, it is understood that other types of containers may be used in accordance with the present disclosure to hold batteries or other exemplary components. Exemplary containers include trays, stackable containers, and other suitable types of containers. One or more containers may be arranged in a vertical column. Unless specifically specifically claimed, features of the containers of this disclosure are not limited to drawers 310, 312, 314.

Although an illustrated embodiment of the present disclosure includes racks 290 as an exemplary type of battery support, other battery supports may be used in accordance with the present disclosure. Exemplary battery supports position some types of containers, such as drawers 310, 312, 314, relative to each other, such as in one or more vertical columns. Unless specifically claimed, features of the supports of this disclosure are not limited to racks 290 having vertically arranged drawers 310, 312, 314.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An energy module comprising:
a plurality of electrically conductive buses coupled to an output of the energy module, the plurality of electrically conductive buses including a positive bus, a negative bus and a ground bus;
a plurality of supports coupled to the electrically conductive buses in parallel, each support including a positive contactor coupled to the positive bus, a negative contactor coupled to the negative bus, and a ground coupled to the ground bus, the positive and negative contactors each having a closed position to couple the support to the positive and negative buses, respectively, and an open position to disconnect the support from the positive and negative buses;
a plurality of battery strings supported by each support, the plurality of battery strings each having a plurality of batteries coupled together in series to provide a string output voltage;
at least one string contactor coupled to each battery string, each string contactor having a closed position to couple its associated battery string to the positive and negative contactors of the support in parallel with other battery strings of the support, each string contactor also having an open position to disconnect the associated battery string from the positive and negative contactors of the support independently from the other battery strings of the support; and
an energy module controller configured to selectively and independently open and close each of the positive contactors, the negative contactors, and the string contactors of the energy module to control the combination of supports and battery strings coupled to the output of the energy module through the plurality of electrically conductive buses.

2. The energy module of claim 1, wherein each support includes at least three battery strings coupled in parallel to the positive and negative contactors of the support.

3. The energy module of claim 1, wherein each battery string includes a plurality of separate battery modules together coupled in series, each battery module having a battery module controller in communication with the energy module controller.

4. The energy module of claim 3, wherein each battery string has a voltage of about 1200 V and each battery module has a voltage of about 50 V.

5. The energy module of claim 3, wherein each battery module includes a plurality of battery cells having a prismatic structure, each battery cell being monitored by the energy module controller.

6. The energy module of claim 1, wherein each support includes a plurality of vertically arranged battery containers, each battery container supports a plurality of battery modules coupled together in series, and wherein a plurality of the battery containers of the support are electrically coupled together in series to form each battery string.

7. The energy module of claim 6, wherein a maximum voltage of each battery container is 200V.

8. The energy module of claim 6, wherein each support also includes a high voltage container housing the positive contactor, the negative contactor, and the string contactors of each support.

9. The energy module of claim 8, wherein the plurality of battery containers and the high voltage container of each support are electrically coupled together by a plurality of cables, the plurality of cables associated each battery string having substantially equal cumulative lengths to provide a generally equal cable resistance associated with each battery string.

10. The energy module of claim 8, wherein the high voltage container further includes a separate fuse coupled to each battery string, a first terminal of each string contactor being coupled to one of the fuses, a second terminal of each string contactor being coupled to a current sensor for the battery string, and each current sensor being coupled in parallel to the positive contactor of the support.

11. The energy module of claim 8, wherein each support also includes a low voltage container, each low voltage container including a plurality of relays for controlling the positive and negative support contactors and the string contactors located in the high voltage container.

12. The energy module of claim 1, wherein the plurality of electrically conductive buses, the plurality of supports, and the energy module controller are located in a single container.

13. The energy module of claim 12, further comprising a DC distribution box located within the container, the plurality of supports being coupled in parallel to the DC distribution box by the positive, negative and ground buses.

14. The energy module of claim 1, wherein the energy module controller monitors a plurality of parameters related to each of the plurality of battery strings, the energy module controller selectively opening a string contactor of a faulty battery string in which a fault is detected to disconnect the faulty battery string from its support without shutting down the entire energy module.

15. The energy module of claim 1, wherein one of the positive and negative contactors of each support is installed in a forward direction, and the other of the positive and negative contactors is installed in a backward direction so that the combination of the positive and negative contactors breaks current flow in either direction when the positive and negative contactors are opened.

16. The energy module of claim 15, wherein the energy module controller senses a current flow direction and opens an appropriate one of the positive or negative contactor first depending on the direction of the current flow.

17. The energy module of claim 1, wherein the positive and negative buses are coupled through at least one fuse to a first terminal a first energy module contactor, the first energy module contactor having a closed position and an open position to connect and disconnect the energy module, respectively.

18. The energy module of claim 17, wherein a second terminal of the first energy module contactor is coupled through a second fuse to a first terminal of a manually operated knife switch, a second terminal of the knife switch being coupled to a first terminal of a second energy module contactor, a second terminal of the second contactor providing the output for the energy module.

19. The energy module of claim 18, further comprising a first volt meter coupled to the first terminal first of the energy module contactor to provide a first voltage reading; a second second volt meter coupled to the first terminal of the knife switch to provide a second voltage reading; and a third volt meter coupled between the second terminal of the knife switch and the first terminal of second energy module contactor to provide a third voltage reading.

20. The energy module of claim 19, further comprising a display panel located adjacent an access door of a container housing the energy module, the display panel displaying voltage readings from the first, second and third volt meters so that an operator can review the three voltage readings displayed on the display panel before entering the container.

21. The energy module of claim 1, wherein the energy module controller includes a primary programmable logic controller (PLC) and a secondary, backup PLC, both the primary and backup PLCs receiving data from the plurality of supports and the plurality of battery strings, the primary PLC being configured to normally control operation of the energy module, and the backup PLC being configured to control operation of the energy module upon failure of the primary PLC.

22. The energy module of claim 21, wherein the primary and backup PLCs are both coupled to a unit central controller (UCC).

23. The energy module of claim 22, wherein the UCC is also coupled to a remote computer through a communication network to provide remote access to the UCC and the primary and backup PLCs for at least one of diagnostic purposes, control, data analysis, review and maintenance of the energy module.

24. The energy module of claim 1, wherein the energy module controller monitors voltages and temperatures of the plurality of battery strings within each of the plurality of supports, the energy module controller selectively opening and closing string contactors to selectively remove certain battery strings from the energy module based on the monitored voltages and temperatures.

25. The energy module of claim 24, wherein a battery string is disconnected from the energy module when a voltage of the particular battery string differs from voltages of other battery strings by more than a predetermined amount.

26. The energy module of claim 1, wherein the controller monitors each of the battery strings for a fault condition, and upon detecting a fault conditions for a particular string the controller:
opens both the positive and negative contactors a particular support in which the battery string having the fault condition is located to break current flow;
opens the at least one string contactor for the battery string having the fault condition; and
closes the positive and negative support contactors of the particular support to reconnect the support to the positive and negative buses.

27. The energy module of claim 1, wherein at least two of the plurality of supports further include a pre-charge contactor and a pre-charge resistor coupled in series across terminals the support negative contactor, the energy module controller being programmed to selectively open the pre-charge contactor so that current flows through the pre-charge resistor in order to pre-charge a selected one of the at least two supports as the energy module is brought online before other supports are coupled to the positive and negative buses.

28. The energy module of claim 1, wherein the energy module controller monitors voltages of the plurality of battery strings to detect when a particular battery string has a voltage difference fault when compared to other battery strings within the energy module.

29. The energy module of claim 29, wherein each support of the energy module includes at least three parallel battery strings.

30. The energy module of claim 1, wherein the energy module controller:
monitors voltages for the plurality of battery strings in the plurality of supports;
calculates a median voltage for the plurality of battery strings;
compares the median battery string voltage to individual battery string voltages;
determines if a battery string voltage for a particular battery string is outside a predetermined acceptable voltage range from the median battery string voltage;
sets a string voltage difference fault for the particular string that is outside the predetermined acceptable voltage range; and
opens the string contactor for the string having the string voltage difference fault.

31. The energy module of claim 30, wherein the energy module controller:
compares each battery string voltage to voltages of other battery strings within the same support;
determines whether the battery string voltage for the particular battery string is within a predetermined voltage range of the other battery strings within the same support; and
sets a string voltage difference fault for the particular string if the battery string voltage for the particular battery string is not within the predetermined voltage range of the other battery strings within the same support.

32. The energy module of claim 31, wherein each battery string has a voltage of about 1200V, and wherein the predetermined voltage difference range is within 50V of the median string voltage in order to be within the acceptable voltage range.

33. The energy module of claim 1, further comprising determining whether a voltage imbalance exists between the plurality of battery strings, and selectively disconnecting out of balance battery strings to minimize the voltage imbalance between the battery strings of the energy module.

34. The energy module of claim 1, wherein the plurality of electrically conductive buses, the plurality of supports, and the energy module controller are located in a single container having an interior region, and further comprising an entry door to provide access the interior region of the container, a sensor to detect entry of a person into the interior region of the container, and a main energy module contactor coupled to the plurality of electrically conductive buses to provide an output for the energy module, and wherein the energy module controller is coupled to the sensor and programmed to open the main energy module contactor and the positive and negative contactors of each support automatically when the sensor detects a person entering the interior region of the container.

35. The energy module of claim 1, wherein the plurality of electrically conductive buses, the plurality of supports, and the energy module controller are located in a single container, and further comprising a main energy module contactor coupled to the plurality of electrically conductive buses to provide an output for the energy module and a ground fault detection circuit located within the energy module container, and wherein the energy module controller is programmed to enable the ground fault detection circuit to monitor at least one of the electrically conductive buses for a ground fault condition when the main energy module contactor is open, the energy module controller disabling the ground fault detection circuit of the energy module before closing the main energy module contactor.

36. The energy module of claim 1, wherein each support includes a plurality of vertically arranged battery containers, a first battery container including a front and a rear and a bottom positioned between the front and the rear; a plurality of batteries supported by the container and positioned between the front and the rear, the plurality of batteries being electrically connected together; and a circuit interrupter accessible from an exterior of the front of the battery support, the circuit interrupter having a closed state wherein a first battery supported by the container is electrically coupled to a second battery supported by the container and an open state wherein the first battery is electrically uncoupled from the second battery.

37. The energy module of claim 1, wherein each support includes a plurality of vertically arranged battery containers in a vertical column, each battery container supports a plurality of battery modules coupled together in series, and wherein a plurality of the battery containers of the support are electrically coupled together in series to form each battery string, wherein a first group of the plurality of batteries comprise a first string and are provided in a first group of the plurality of containers and a second group of the plurality of batteries comprise a second string and are provided in a second group of the plurality of containers, the first group of batteries being electrically coupled in series to a first string contactor and the second group of batteries being electrically coupled in series to a second string contactor, the first string contactor and the second string contactor being electrically coupled in parallel.

38. An energy system configured to be operatively connected to a power grid through a switch gear, the energy system comprising:
a power control module including at least one inverter to convert DC power to AC power for communication to the power grid through the switch gear and a ground fault detection circuit; and
a plurality of energy modules, each energy module including a container housing a plurality of batteries therein, a high voltage DC bus coupled to the plurality of batteries, a main contactor coupled to the high voltage DC bus and configured to couple the energy module to the power control module, a ground fault detection circuit, and a controller programmed to enable the ground fault detection circuit to monitor the high voltage DC bus for a ground fault condition when the main energy module contactor is open, the energy module controller disabling the ground fault detection circuit of the energy module before closing the main energy module contactor to connect the energy module to the power control module, and wherein ground fault detection for each of the plurality of energy modules is provided by the ground fault detection circuit of the power control module after the associated main contactor of each energy module is closed.

39. A method of electrically coupling a plurality of batteries to an output of an energy storage system, the method comprising the steps of:
providing a positive bus and a negative bus electrically coupled to the output of the energy storage system;
arranging the plurality of batteries into a plurality of strings electrically coupled to the positive bus and the negative bus through a plurality of electrically paralleled string contactors;
for a first string of the plurality of strings,
positioning a first portion of the plurality of batteries in a first container;
positioning a second portion of the plurality of batteries in a second container;
electrically coupling the first portion of the plurality of batteries, the second portion of the plurality of batteries, and a first string contactor together in series; and
arranging the first container and the second container in a first vertical column;
for a second string of the plurality of strings,
positioning a third portion of the plurality of batteries in a third container;
positioning a fourth portion of the plurality of batteries in a fourth container;
electrically coupling the third portion of the plurality of batteries, the fourth portion of the plurality of batteries, and a second string contactor together in series; and
arranging the third container and the fourth container in a second vertical column
arranging the second vertical column above the first vertical column;
arranging the first string contactor and the second string contactor above the first vertical column; and
controlling a first connection of the first string to the positive and negative bus with the first string contactor and a second connection of the second string to the positive and negative bus with a second string contactor, the second connection being controlled independent of the first connection.

40. A method of electrically coupling a plurality of batteries to an output of an energy storage system, the method comprising the steps of:
providing a battery support having a first battery support interface and a second battery support interface electrically connected to the first battery support interface;
supporting a first battery in a first container having a first container interface, the first container being moveably coupled to the battery support;
supporting a second battery in a second container having a second container interface, the second container being moveably coupled to the battery support;
engaging the first container interface with the first battery support interface by moving the first container relative to the battery support; and
engaging the second container interface with the second battery support interface by moving the second container relative to the battery support.

41. An energy storage system, comprising:
a plurality of containers including a first energy module container including a first plurality of batteries electrically coupled together, a second energy module container including a second plurality of batteries electrically coupled together, and a power control container including at least one inverter;
a first set of power lines electrically coupling the first plurality of batteries of the first energy module container to the at least one inverter of the power control container, the first set of power lines carrying DC power between the first energy module container and the power control container; and
a second set of power lines electrically coupling the second plurality of batteries of the second energy module container to the at least one inverter of the power control container, the second set of power lines carrying DC power between the second energy module container and the power control container, wherein the first set of power lines and the second set of power lines have generally equal resistance.
